(19) United States
(12) Patent Application Publication
(10) Pub. No.: US 2018/0364522 A1
(43) Pub. Date: Dec. 20, 2018

(54) METHOD OF PRODUCING DISPLAY PANEL AND METHOD OF PRODUCING DISPLAY DEVICE

(71) Applicant: SHARP KABUSHIKI KAISHA, Sakai City, Osaka (JP)

(72) Inventors: KATSUHIRO YAMAGUCHI, Sakai City (JP); YUHJI TANIGUCHI, Sakai City (JP); MASATAKA OHYAMA, Sakai City (JP)

(21) Appl. No.: 16/062,200

(22) PCT Filed: Dec. 9, 2016
(86) PCT No.: PCT/JP2016/086716

§ 371 Date: Jun. 14, 2018

(30) Foreign Application Priority Data
Dec. 17, 2015 (JP) 2015-246085

(51) Int. Cl. G02F 1/1335; G02F 1/1333; G09G 3/36; G02F 1/1345

(52) U.S. Cl. CPC G02F 1/133528; G02F 1/133351; G02F 1/133514; G02F 2001/1316; G02F 1/13452; G02F 2001/133541; G02F 2001/133354; G09G 3/3607

(57) ABSTRACT

A method of producing a liquid crystal panel 11 includes a first separating process, a second separating process, a cleaning process, a polarizing plate component preparing process, and a polarizing plate bonding process. The first separating process is for preparing a liquid crystal panel body component 11BM including liquid crystal panel bodies 11B coupled to one another. The second separating process is for separating the liquid crystal panel body component 11BM into the liquid crystal panel bodies 11B. The cleaning process is for cleaning the liquid crystal panel bodies 11B. The polarizing plate component preparing process is for preparing a polarizing plate component 19 including polarizing plates 18 coupled to one another. The polarizing plate bonding process is for collectively bonding the polarizing plates 18 includes in the polarizing plate component 19 to the liquid crystal bodies 11B.

### TECHNICAL FIELD

The present invention relates to a method of producing a display panel and method of producing a display device.

### BACKGROUND ART

A method of producing a liquid crystal display device disclosed in Patent Document 1 has been known as an example of conventional methods of producing liquid crystal display devices. The method of producing a liquid crystal display device disclosed in Patent Document 1 includes processes of bonding two mother boards together to prepare a bonded mother board, filling areas to form liquid crystal layers with liquid crystals, cutting the bonded mother board into bonded board segments after the liquid crystal filling process, bonding polarizing plates to surfaces of the bonded board segments, scraping off sections of the polarizing plates on the surfaces of the bonded board segments in areas at boundaries between liquid crystal display panels with a blade to remove the sections, which is referred to as a polarizing plate partially removing process, and inspecting the liquid crystal display panels included in the bonded board segments whether they are turned on in the state of the bonded board segments after the polarizing plate partially removing process, which is referred to as an inspection process.

### RELATED ART DOCUMENT

### Patent Document

Patent Document 1: Unexamined Japanese Patent Application Publication No. 2007-140283

### PROBLEM TO BE SOLVED BY THE INVENTION

In the method of producing the liquid crystal display device disclosed in Patent Document 1, the areas of the polarizing plates at the boundaries between the liquid crystal display panels are removed with the blade after the polarizing plates having a rectangular plate shape are bonded to the bonded board segments, and then the bonded board segments with the polarizing plates bonded thereto are cut to prepare the liquid crystal display panels that are separated from one another. Particles may be produced during the separating process and are more likely to adhere to the separated liquid crystal display panels. Therefore, cleaning is required. However, a cleaning solution used for the cleaning may cause degradation in performance of the polarizing plates.

### DISCLOSURE OF THE PRESENT INVENTION

The present invention was made in view of the above circumstances. An object is to restrict degradation in performance of polarizing plates.

### MEANS FOR SOLVING THE PROBLEM

A method of producing a display panel includes a display panel body component preparing process, a separating process, a cleaning process, a polarizing plate component preparing process, and a polarizing plate bonding process. The display panel body component preparing process is for preparing a display panel body component including display panel bodies that are coupled to one another. The separating process is for separating the display panel body component into the display panel bodies. The cleaning process is for cleaning the display panel bodies. The polarizing plate component preparing process is for preparing a polarizing plate component including polarizing plates that are coupled to one another. The polarizing plate bonding process is for collectively bonding the polarizing plate included in the polarizing plate component to the display panel bodies.

The display panel body component prepared through the display panel body component preparing process is separated into the display panel bodies in the separating process. The display panel bodies prepared through the separating process are cleaned in the cleaning process to remove particles produced in the separating process. Because the separating process and the cleaning process are performed prior to the polarizing plate bonding process, the polarizing plates are not cleaned in the cleaning process. Therefore, in comparison to the conventional method in which the separating process and the cleaning process are performed after the polarizing plate bonding process, degradation in performance of the polarizing plates is less likely to occur. Furthermore, in the polarizing plate bonding process, the polarizing plates are collectively bonded to the display panel bodies using the polarizing plate component including the polarizing plates that are coupled to one another. According to the method, polarizing plates that are reduced in size can be easily handled and thus easily bonded to the display panel bodies. Therefore, the bonding can be easily automated. The method is preferable for producing display panels in smaller sizes.

Preferable embodiments of the first invention may include the following features.

(1) The polarizing plate component preparing process may include preparing the polarizing plate component including the polarizing plate held by a polarizing plate carrier to be removable from the polarizing plate carrier and detachable from one another. In the polarizing plate component prepared through the polarizing plate component preparing process, the polarizing plates are held by the polarizing plate carrier to be removable from the polarizing plate carrier and detachable from one another. Therefore, the polarizing plate bonding process performed afterward does not require cutting of the polarizing plates with a blade required in the conventional method. According to the method, higher production efficiency can be achieved and the display panel bodies are less likely to be scratched.

(2) The polarizing plate component preparing process may include at least a base attaching step and a polarizing plate separating step. The base attaching step is for attaching a polarizing plate base to the polarizing pate carrier. The polarizing plate separating step is for cutting the polarizing plate base attached to the polarizing plate carrier to set the polarizing plates detachable from, one another. In comparison to a method in which the polarizing plates are separated prepared and attached to the polarizing plate carrier, higher production efficiency can be achieved. Furthermore, outlines of the polarizing plates can be freely defined depending on how to cut the polarizing plate base in the polarizing plate separating step.

(3) The polarizing plate component preparing process may include preparing the polarizing plate component including the polarizing plates linearly arranged an two positioning portions disposed to sandwich the polarizing plates from ends with respect to an arrangement direction of the polarizing plates. The polarizing plate bonding process may include positioning the polarizing plates relative to the display panel bodies using the positioning portions. Because the polarizing plates are positioned relative to the display panel bodies using the positioning portions that are disposed to sandwich the polarizing plates from the ends with respect to the arrangement direction of the polarizing plates in the polarizing plate bonding process, the polarizing plates can be collectively bonded to the display panel bodies with high position accuracy.

(4) The polarizing plate component preparing process may include preparing the polarizing plate component including intermediate positioning portion disposed between the polarizing plates that are adjacent to each other. The polarizing plate bonding process may include positioning the polarizing plates relative to the display panel bodies using the positioning portions and the intermediate positioning portions. Because the polarizing plates are positioned relative to the display panel bodies using the positioning portions and the intermediate positioning portion that is disposed between the adjacent polarizing plates in the polarizing plate component preparing process, the polarizing plates can be collectively bonded to the display panel bodies with higher position accuracy.

(5) The polarizing plate component preparing process may include preparing the polarizing plate component including the polarizing plates that are directly next to one another and coupled to one another. The method is preferable for reducing a material cost related to the polarizing plate component.

(6) The polarizing plate component preparing process may include preparing the polarizing plate component including an intermediate portion between the polarizing plates adjacent to each other. According to the method, when placing the display panel bodies in the polarizing plate bonding process, a space corresponding to the intermediate portion is provided between the adjacent display panel bodies. Therefore, the placement of the display panel bodies can be easily performed.

(7) The polarizing plate component preparing process may include preparing the polarizing plate component that are linearly arranged and an end surface protecting portion that covers at least sections of end surfaces of the polarizing plates along an arrangement direction of the polarizing plates. With the end surface protecting portion that covers at least sections of the end surfaces along the arrangement direction of the polarizing plates, the end surfaces are protected.

(8) The polarizing plate component preparing process may include preparing the polarizing plate component including the end surface protecting portion that covers entire areas of the end surfaces of the polarizing plates along the arrangement direction. With the end surface protecting portion that covers the entire areas of the end surfaces along the arrangement direction of the polarizing plates, the end surfaces are further properly protected.

(9) The polarizing plate component preparing process may include preparing the polarizing plate component including an intermediate portion between the polarizing plate that are adjacent to each other and end surface protecting portion that is coupled to the intermediate portion. The end surface protecting portion and the intermediate portion can be collectively removed in the polarizing plate bonding process. This method provides higher workability.

(10) The polarizing plate bonding process may include transmitting light through each of the polarizing plates and detecting a polarization axis of the each of the polarizing plates based on an amount of transmitted light or a waveform related to the transmitted light. By detecting the polarization axis of each light guide plate based on the amount or the waveform of the transmitted light transmitted through each polarizing plate, each polarizing plate can be positioned relative to a direction around an axis that extends in a normal direction to a plate surface of the polarizing plate.

To solve the problem describe earlier, a method of producing a display device according to the present invention includes a lighting device preparing process and an assembly process. The lighting device preparing process is for preparing a lighting device for supplying light to the display panel produced by the method of producing a display panel described above. The assembly process is for assembling the display panel and the lighting device together.

According the method of producing a display device, the degradation in the performance of the polarizing plate is less likely to occur in the production of display panel and the production of the display panel in the smaller size can be easily performed. Therefore, higher display performances can be achieved and this method is preferable for reducing the size of the display device.

### ADVANTAGEOUS EFFECT OF THE INVENTION

According to the present invention, the degradation in performance of the polarizing plate is less likely to occur.

### BRIEF DESCRIPTION OF THE DRAWINGS

FIG. 1 is a schematic plan view illustrating connection among a liquid crystal panel with a driver mounted thereon, a flexible circuit board, and a control circuit board according to a first embodiment of the present invention.

FIG. 2 is a schematic cross-sectional view illustrating a cross section along a long direction of a liquid crystal display device.

FIG. 3 is a schematic cross-sectional view illustrating a cross section of a liquid crystal panel.

FIG. 4 is a magnified plan view illustrating a two-dimensional configuration of an array board in a display area in the liquid crystal panel in a display area.

FIG. 5 is a magnified plan view illustrating a two-dimensional configuration of a CF board in the display area in the liquid crystal panel.

FIG. 6 is a plan view of a bonded board base prepared through a board base bonding process.

FIG. 7 is a plan view of a liquid crystal panel body component prepared through a first separating process.

FIG. 8 is a plan view of liquid crystal panel bodies prepared through a second separating process.

FIG. 9 is a plan view of a polarizing plate base attached to a separator layer through a base attaching process.

FIG. 10 is a cross-sectional view of the separator layer and the polarizing plate base.

FIG. 11 is a plan view of the polarizing plate component prepared through a polarizing plate separating process.

FIG. 12 is a cross-sectional view of the polarizing plate component.

FIG. 13 is a plan view of liquid crystal panel bodies placed on a liquid crystal panel vacuum stage in a polarizing plate bonding process.

FIG. 14 is a cross-sectional view illustrating a condition in the polarizing plate bonding process in which the polarizing plate component is positioned relative to the liquid crystal panel bodies.

FIG. 15 is a cross-sectional view illustrating a condition in the polarizing plate bonding process in which the separator layer is removed.

FIG. 16 is a cross-sectional view illustrating a condition in the polarizing plate bonding process in which a polarizing plate is being bonded to the liquid crystal panel body.

FIG. 17 is a cross-sectional view illustrating a condition of the polarizing plate bonding process in which the polarizing plates are bonded to the liquid crystal panel bodies in the polarizing plate bonding process.

FIG. 18 is a cross-sectional view illustrating a removing step of removing the liquid crystal panel body to which the polarizing plate is attached in the polarizing plate bonding process.

FIG. 19 is a cross-sectional view of a polarizing plate component according to a second embodiment of the present invention.

FIG. 20 is a plan view of a polarizing plate component according to a third embodiment of the present invention.

FIG. 21 is a plan view of a polarizing plate component according to a fourth embodiment of the present invention.

FIG. 22 is a cross-sectional view of the polarizing plate component.

FIG. 23 is a plan view of liquid crystal panel bodies placed on a liquid crystal panel vacuum stage in a polarizing plate bonding process.

FIG. 24 is a cross-sectional view illustrating a condition in the polarizing plate bonding process in which the polarizing plate component is positioned relative to the liquid crystal panels in the polarizing plate bonding process.

FIG. 25 is a cross-sectional view illustrating a condition in the polarizing plate bonding process in which a separator layer is removed.

FIG. 26 is a cross-sectional view illustrating a condition in the polarizing plate bonding process in which the polarizing plates are bonded to the liquid crystal panel bodies.

FIG. 27 is a cross-sectional view illustrating a step of removing the liquid crystal panel body to which the polarizing plate is bonded in the polarizing plate bonding process.

FIG. 28 is a cross-sectional view illustrating a condition in a polarizing plate bonding process in which a polarizing plate component is positioned relative to liquid crystal panel bodies according to a fifth embodiment of the present invention.

FIG. 29 is a cross-sectional view illustrating a condition in the polarizing plate bonding process in which polarizing plates are bonded to the liquid crystal panel bodies.

FIG. 30 is a cross-sectional view illustrating a step of removing the liquid crystal panel body to which the polarizing plate is bonded.

FIG. 31 is a plan view of a polarizing plate component according to a sixth embodiment of the present invention.

FIG. 32 is a plan view of a polarizing plate component according to a seventh embodiment of the present invention.

FIG. 33 is a plan view of a polarizing plate component according to an eighth embodiment of the present invention.

FIG. 34 is a plan view of a polarizing plate component according to a ninth embodiment of the present invention.

FIG. 35 is a cross-sectional view along line xxxv-xxxv in FIG. 34.

FIG. 36 is a cross-sectional view along line xxxvi-xxxvi in FIG. 34.

FIG. 37 is a cross-sectional view illustrating a condition in a polarizing plate bonding process before end surface protectors and middle sections are removed in an end surface protector and middle section removing step.

FIG. 38 is a cross-sectional view illustrating a condition in the end surface protector and middle section removing step of the polarizing plate bonding process in which the end surface protectors and the middle sections are being removed.

FIG. 39 is a cross-sectional view illustrating a condition in the polarizing plate bonding process in which a polarizing plate component is positioned relative to liquid crystal panel bodies in the polarizing plate bonding process.

FIG. 40 is a cross-sectional view illustrating a condition in the polarizing plate bonding process in which a separator layer is removed.

FIG. 41 is a cross-sectional view illustrating a condition in the polarizing plate bonding process in which polarizing plates are bonded to the liquid crystal panel bodies.

FIG. 42 is a plan view of a polarizing plate component according a tenth embodiment of the present invention.

FIG. 43 is a cross sectional view along line xxxxiii-xxxxiii in FIG. 42.

FIG. 44 is a plan view of a polarizing plate component according an eleventh embodiment of the present invention.

FIG. 45 is a cross-sectional view illustrating a condition in a polarizing plate bonding process in which the polarizing plate component is positioned relative to liquid crystal panels.

FIG. 46 is a plan view of a polarizing plate component according a twelfth embodiment of the present invention.

FIG. 47 is a plan view of a polarizing plate component according a thirteenth embodiment of the present invention.

FIG. 48 is a plan view of a liquid crystal panel to which a polarizing plate is bonded.

FIG. 49 is a front view of a polarizing plate bonding device according to a fourteenth embodiment of the present invention.

FIG. 50 is a plan view of the polarizing plate bonding device.

FIG. 51 is a side view of the polarizing plate bonding device.

FIG. 52 is a plan view illustrating transfer of a polarizing plate component onto a transfer sheet in the polarizing plate bonding process.

FIG. 53 is a plan view illustrating removal of a separator layer in the polarizing plate bonding process.

FIG. 54 is a side view illustrating bonding of a polarizing plate to a liquid crystal panel body in the polarizing plate bonding process.

FIG. 55 is a side view illustrating a condition in the polarizing plate bonding process in which the polarizing plate is bonded to the liquid crystal panel body.

FIG. 56 is a plan view of a polarizing plate bonding device according to a fifteenth embodiment of the present invention.

FIG. 57 is a side view of the polarizing plate bonding device.

FIG. 58 is a plan view illustrating transfer of a polarizing plate component onto a transfer sheet in the polarizing plate bonding process.

FIG. 59 is a side view illustrating transfer of the polarizing plate component onto the transfer sheet in the polarizing plate bonding process.

FIG. 60 is a side view illustrating the polarizing plate component is transferred onto the transfer sheet in the polarizing plate bonding process.

FIG. 61 is a side view illustrating removal of a separator sheet in the polarizing plate bonding process.

FIG. 62 is a plan view illustrating transfer of a liquid crystal panel vacuum stage to an overlapping position in the polarizing plate bonding process.

FIG. 63 is a side view illustrating bonding of a polarizing plate to a liquid crystal panel body in the polarizing plate bonding process.

FIG. 64 is a side view illustrating a condition in the polarizing plate bonding process in which the polarizing plate is bonded to the liquid crystal panel body.

FIG. 65 is a plan view of a polarizing plate component according to another embodiment (1) of the present invention.

FIG. 66 is a perspective view schematically illustrating a relation between the polarizing plate component and a polarization axis detection device.

FIG. 67 is a plan view of a polarizing plate component according to another embodiment (2) of the present invention.

FIG. 68 is a plan view of a polarizing plate component according to another embodiment (3) of the present invention.

FIG. 69 is a plan view of a polarizing plate component according to another embodiment (4) of the present invention.

FIG. 70 is a plan view of a polarizing plate component according to another embodiment (5) of the present invention.

FIG. 71 is a plan view of a polarizing plate component according to another embodiment (6) of the present invention.

FIG. 72 is a plan view of a polarizing plate component according to another embodiment (7) of the present invention.

### MODE FOR CARRYING OUT THE INVENTION

### First Embodiments

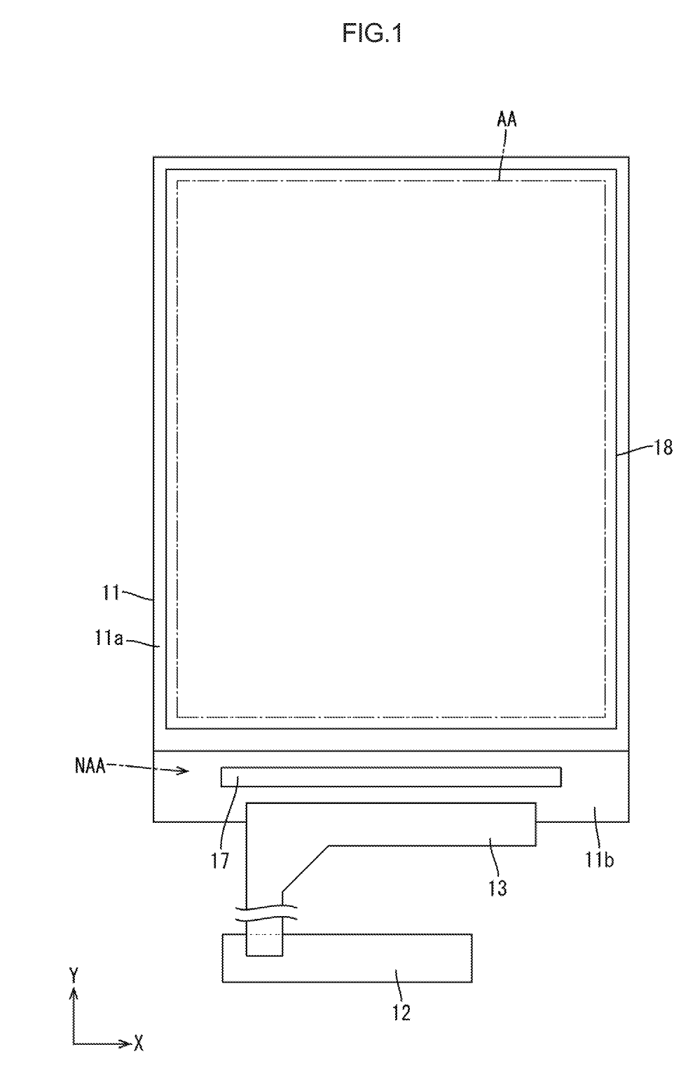

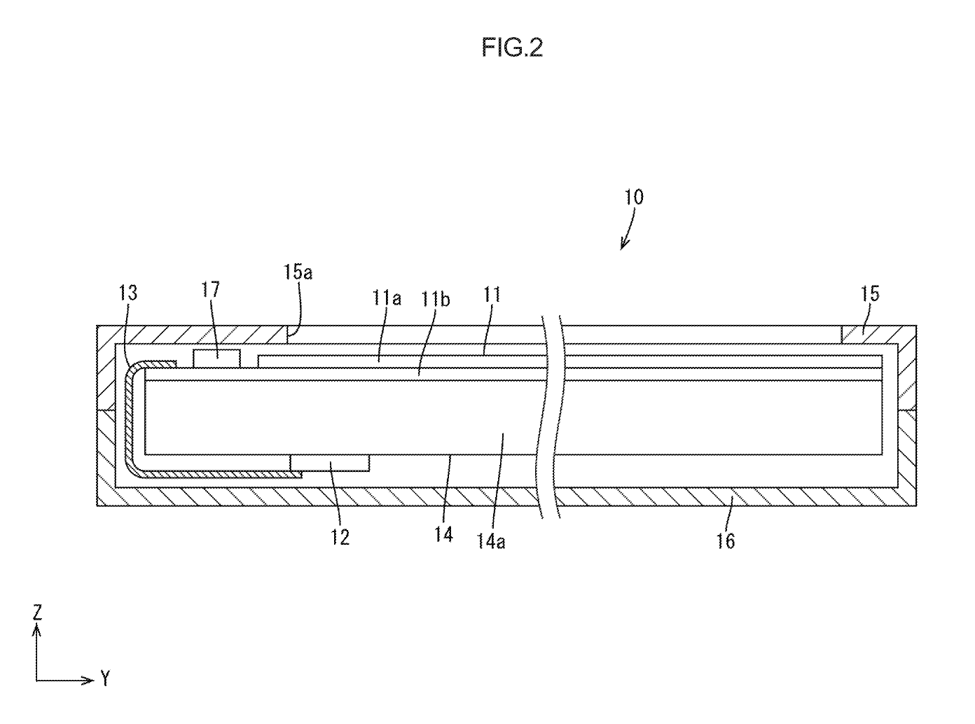

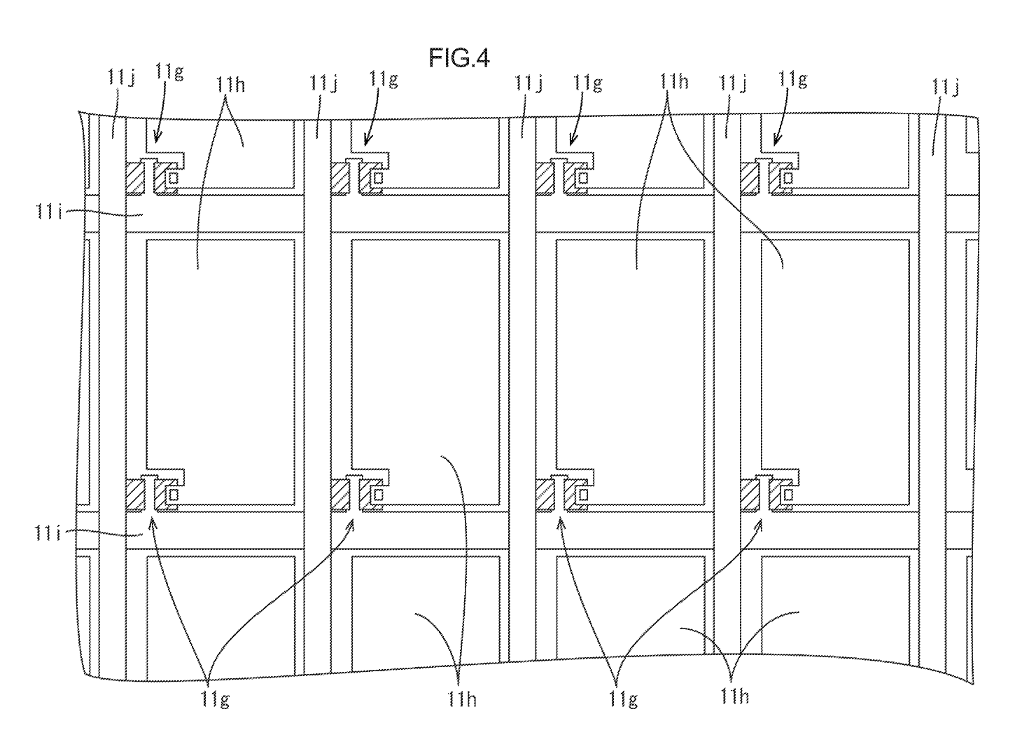

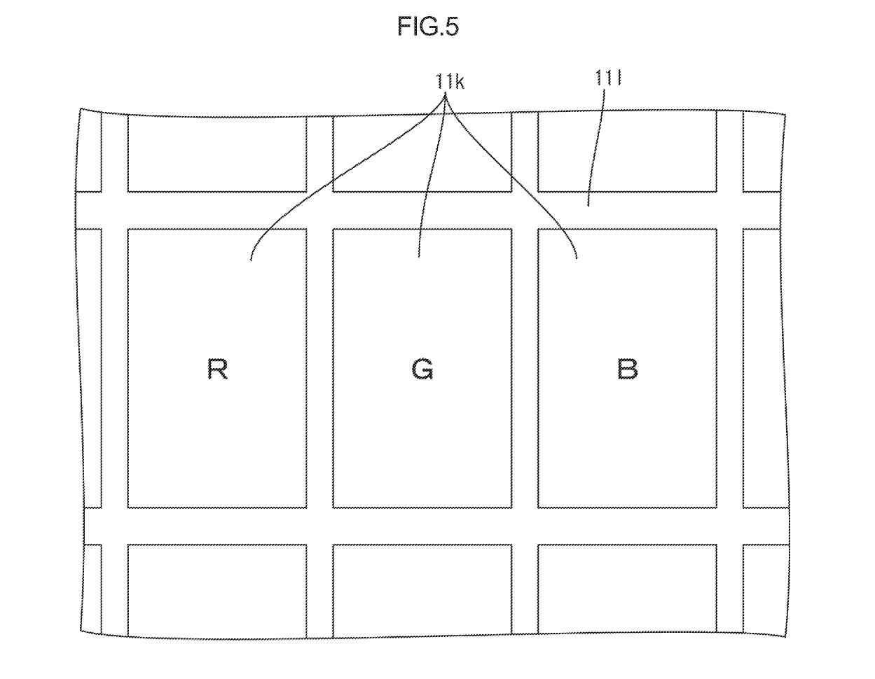

A first embodiment of the present invention will be described with reference to FIGS. 1 to 18. In this section, a method of a liquid crystal display device 10 (a display device) and a method of producing a liquid crystal panel 11 (a display panel) included in the liquid crystal display device 10 will be described. X-axes, Y-axes, and Z-axes may be present in the drawings. The axes in each drawing correspond to the respective axes in other drawings to indicate the respective directions. An upper side and a lower side in FIGS. 2 and 4 correspond to a front side and a rear side of the liquid crystal display device 10, respectively.

As illustrated in FIGS. 1 and 2, the liquid crystal display device 10 includes the liquid crystal panel 11 (a display panel), a driver 17 (a panel driver), a control circuit board 12 (an external signal source), a flexible circuit board 13 (an eternal connecting component), and a backlight unit 14 (a lighting device). The liquid crystal panel 11 is for displaying images. The driver 17 is for driving the liquid crystal panel 11. The control circuit board 12 is for supplying various signals from the outside to the driver 17. The flexible circuit board 13 electrically connects the liquid crystal panel 11 to the control circuit board 12 that is provided outside. The backlight unit 14 is an external light source for supplying light to the liquid crystal panel 11 for image display. The liquid crystal display device 10 includes exterior components 15 and 16 disposed on a front side and a rear side to hold the liquid crystal panel 11 and the backlight unit 14 that are attached to each other. The exterior component 15 on the front side includes an opening 15a through which images displayed on the liquid crystal panel 11 can be viewed from the outside.

Preferable applications of the liquid crystal display device 10 according to this embodiment may include wearable electronic terminals (not illustrated) such as smartwatches and head-mounted displays. A screen size of the liquid crystal panel 11 included in the liquid crystal display device 10 may be categorized into an ultracompact size, that is, one inch or smaller. The liquid crystal panel 11 having the screen size of one inch or smaller may have sides in length of 20 mm or smaller. The sides may be about 8 mm. The applications of the liquid crystal display device 10 are not limited to the wearable terminals, that is, the liquid crystal display device 10 may be used for a wide variety of electronic devices.

The backlight unit 14 will be briefly described. As illustrated in FIG. 2, the backlight unit 14 includes a chassis 14a, a light source (e.g., cold cathode fluorescent tubes, LEDs, and organic ELs), and an optical member. The chassis 14a has a box-like shape with an opening on the front side (a liquid crystal panel 11 side). The light source, which is not illustrated, is disposed inside the chassis 14a. The optical member, which is not illustrated, is disposed to cover the opening of the chassis 14a. The optical member has a function of converting light emitted by the light source into planar light.

Next, the liquid crystal panel 11 will be described. As illustrated in FIG. 1, the liquid crystal panel 11 has a vertically-long quadrilateral (rectangular) shape as a whole. The liquid crystal panel 11 includes a display area AA (an active area) with a middle of the long dimension thereof positioned closer to a first end of the long dimension thereof (the upper side in FIG. 1). The driver 17 and the flexible circuit board 13 are mounted to a section of the liquid crystal panel 11 closer to a second end of the long dimension (the lower side in FIG. 1). An area of the liquid crystal panel 11 outside the display area AA is a non-display area (a non-active area) NAA in which images are not displayed. The short direction of the liquid crystal panel 11 corresponds with the X-axis direction in each drawing and the long direction corresponds with the Y-axis direction in each drawing. In FIG. 1, a chain line in a rectangular form slightly smaller than A CF board 11a indicates an outline of the display area AA and the area outside the chain line is the non-display area NAA.

As illustrated in FIG. 2, the liquid crystal panel 11 includes at least glass boards 11a and 11b that are substantially transparent and have light transmissivity and a liquid crystal layer 11e that contains liquid crystal molecules (a liquid crystal material) which are substances having optical characteristics that vary according to application of electric field. One of the boards 11a and 11b included in the liquid crystal panel 11 on the front side is the CF board 11a and the other one of the boards 11a and 11b on the rear side (the back side) is an array board 11b (a display board). Polarizing plates 18 are bonded to outer surfaces of the boards 11a and 11b. As illustrated in FIG. 1, the polarizing plates 18 have substantially the same size in a plan view. The size is slightly larger than the display area AA but slightly smaller than the outline of the CF board 11a. Specifically, each polarizing plate 18 in this embodiment has a long dimension of about 15.02 mm and a short dimension of about 12.1 mm. However, the dimensions can be altered as appropriate.

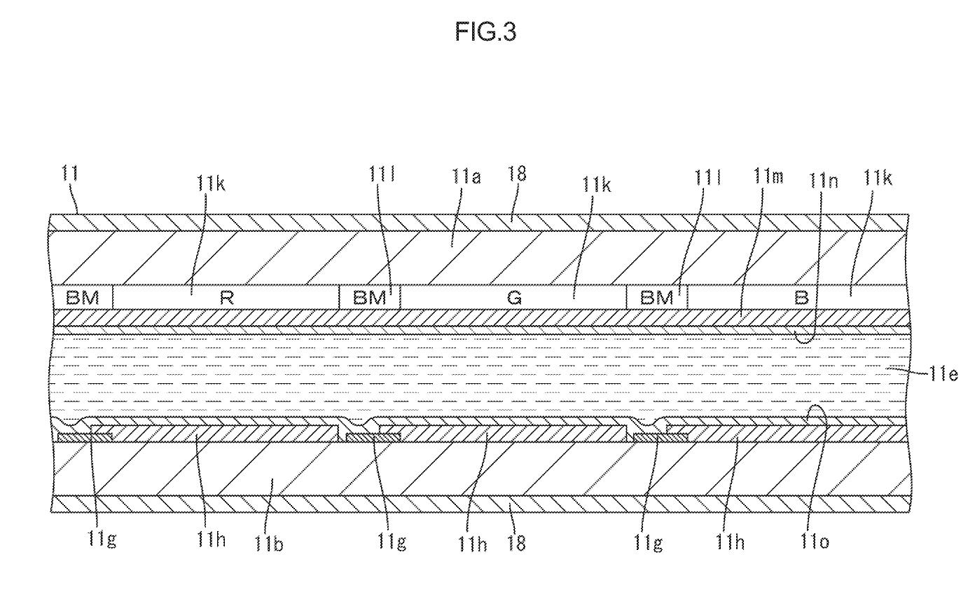

As illustrated in FIGS. 2 and 3, on an inner surface of the array board 11b in the display area AA (on a liquid crystal layer 11e side, a surface opposed to the CF board 11a), thin film transistors (TFTs, display components) 11g, which are switching components, and pixel electrodes 11h are arranged in a matrix. Furthermore, gate lines 11i (component connecting lines, scanning lines) and source lines 11j (data lines) are disposed in grid to surround the TFTs 11g and the pixel electrodes 11h. The gate lines 11i are connected to gate electrodes of the TFTs 11g and the source lines 11j are connected to source electrodes of the TFTs 11g. The pixel electrodes 11h are connected to drain electrodes of the TFTs 11g. The TFTs 11g are driven based on various signals supplied to the gate lines 11i and the source lines 11j. According to the driving of the TFTs 11g, application of voltages to the pixel electrodes 11h is controlled. Each pixel electrode 11h is a transparent electrode made of indium tin oxide (ITO) or zinc oxide (ZnO) and disposed in a quadrilateral area defined by the gate lines 11i and the source lines 11j.

As illustrated in FIGS. 2 and 4, color filters 11k are disposed on the inner surface of the CF board 11a in the display area AA at positions opposed to the pixel electrodes 11h on the array board 11b to form a matrix. Three colors of red (R), green (G), and blue (B) of the color filters 11k are repeatedly arranged in predefined sequence. A light blocking layer 11l (a black matrix) is formed among the color filters 11k in a grid form for reducing color mixture. The light blocking layer 11l is disposed to overlap the gate lines 11i and the source lines 11j in the plan view. On surfaces of the color filters 11k and the light blocking layer 11l, a common electrode 11m is formed in a solid pattern to be opposed to the pixel electrodes 11h on the array board 11b. On the inner surface side of the boards 11a and 11b, alignment films 11n and 11o are formed, respectively, for orienting the liquid crystal molecules in the liquid crystal layer 11e. In the liquid crystal panel 11, the colors of R, G, and B of three color filters 11k and three pixel electrodes 11h opposed to the respective color filters 11k form a display pixel that is a display unit. The display pixel includes a red pixel including the R color filter 11k, a green pixel including the G color filter 11k, and a blue pixel including the B color filter 11k. The color pixels are repeatedly arranged along a row direction (the X-axis direction) on the plate surface of the liquid crystal panel 11 to form lines of pixels. The lines of pixels are arranged along a column direction (the Y-axis direction).

As illustrated in FIG. 1, the second end of the long dimension of the array board 11b projects outward from a second end of the CF board 11a. The projecting section of the array board 11b includes a mounting area in which the driver 17 and the flexible circuit board 13 are mounted. The flexible circuit board 13 includes a base made of synthetic resin having insulating properties and flexibility (e.g., polyimide based resin) and traces (not illustrated) formed on the base. A first end and a second end of the flexible circuit board 13 are connected to the array board 11b and the control circuit board 12, respectively. The driver 17 is an IC chip including a driver circuit therein. The driver 17 is configured to operate based on signals supplied by the control circuit board 12, which is a signal source. The driver 17 is configured to process input signals supplied by the control circuit board 12 via the flexible circuit board 13, to generate output signals, and to feed the output signals to the display area AA.

The method of producing the liquid crystal display device 10 having the configuration described above will be described. The method of producing the liquid crystal display device 10 includes at least a liquid crystal panel preparing process (a display panel preparing process), a backlight preparing process (a lighting device preparing process), and a fixing process. The liquid crystal panel preparing process is for preparing the liquid crystal panel 11. The backlight preparing process is for preparing the backlight unit 14. The assembly process is for fixing the liquid crystal panel 11 and the backlight unit 14 together. The liquid crystal panel preparing process, that is, the method of producing the liquid crystal panel 11 will be described in detail below,

The method of producing the liquid crystal panel 11 includes at least an array board base preparing process (a first board base preparing process), a CF board base preparing process (a second board base preparing process), a board base bonding process, a first separating process (a display panel body component preparing process), a second separating process (a separating process), and a cleaning process. The array board base preparing process is for preparing a large array board base (not illustrated) including array boards 11b arranged in a matrix within a plate surface of the array board base. The CF board base preparing process is for preparing a large CF board base (not illustrated) including CF boards 11a arranged in a matrix within a plate surface of the CF board base. The board base bonding process is for bonding the board bases to prepare a bonded board base BM. The first separating process is for cutting the bonded board base BM along the X-axis direction to prepare liquid crystal panel body components 11BM (display panel body components, rectangular bases). The second separating process is for cutting the liquid crystal panel body components 11BM along the Y-axis direction to prepare liquid crystal panel bodies 11B (display panel bodies). The cleaning process is for cleaning the liquid crystal panel bodies 11B. The method of producing the liquid crystal panel 11 further includes at least a polarizing plate component preparing process and a polarizing plate bonding process. The polarizing plate component preparing process is for preparing polarizing plate components 19 each including polarizing plates 18 that are linearly connected. The polarizing plate bonding process is for collectively bonding the polarizing plates 18 in each polarizing plate component 19 to the liquid crystal panel bodies 11B that have undergone the cleaning process. The processes will be described in detail in sequence.

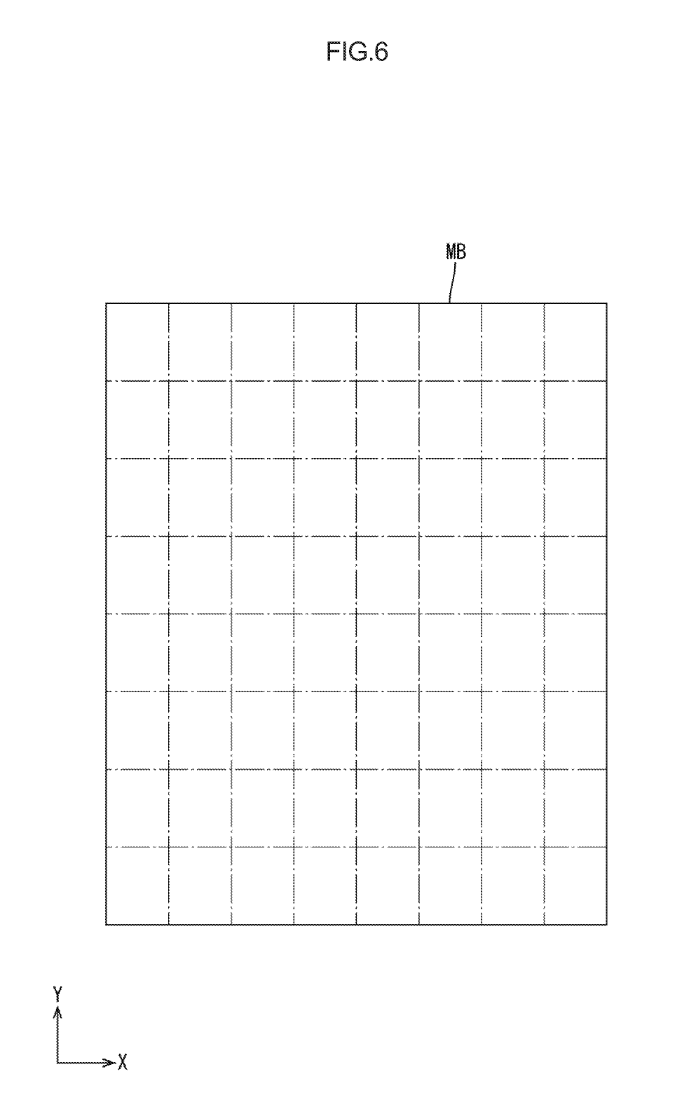

In the array board base preparing process and the CF board base preparing process, various films are formed on surfaces of glass substrates of the array board base and the CF board base through a known photolithography processing and patterned. In the board base bonding process, a sealing member, which is not illustrated, is formed on any one of the board bases through drawing, the liquid crystal material to form the liquid crystal layer 11e is dropped between the board bases, the board bases are bonded together, and the sealing member is cured to seal the liquid crystal layer 11e. Through the board base bonding process, the bonded board base MB illustrated in FIG. 6 is obtained. The bonded board base MB obtained through the board base bonding process includes the liquid crystal panel body components 11BM, which will be described later, are linearly arranged along the Y-axis direction and connected to one another.

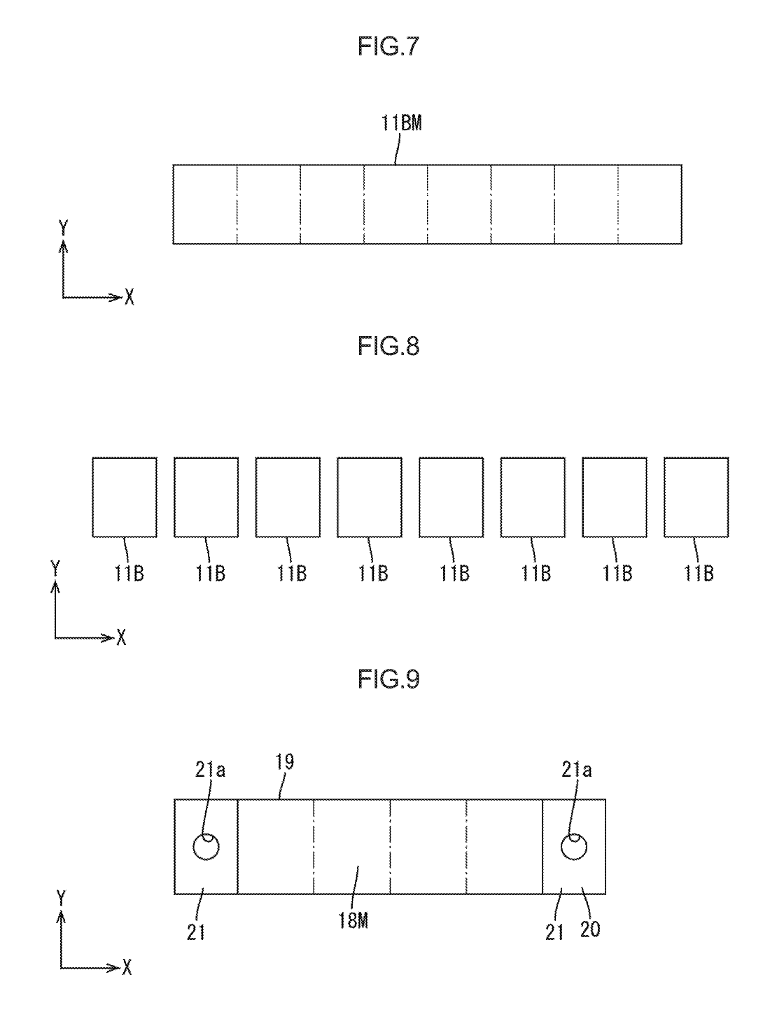

In the first separating process, separations (scribe lines) are formed in the bonded board base MB along the X-axis direction with a blade or a laser beam to cut the bonded board base MB. As a result, the liquid crystal panel body components 11BM are prepared. As illustrated in FIG. 7, each liquid crystal panel body component 11BM prepared through the first separating process includes the liquid crystal panel bodies 11B that are linearly arranged along the X-axis direction and connected to one another. In the second separating process, separations are formed in the liquid crystal panel body components 11BM along the Y-axis direction with a blade or a laser beam to cut the liquid crystal panel body components 11BM. As a result, the liquid crystal panel bodies 11B are prepared. As illustrated in FIG. 8, the liquid crystal panel bodies 11B prepared through the second separating process are segments of each liquid crystal panel body component 11BM. Each liquid crystal panel body 11B has a configuration similar to the liquid crystal panel 11 included in the liquid crystal display device 10 without the polarizing plates 18. In the cleaning process, a cleaning solution is sprayed onto the liquid crystal panel bodies 11B prepared through the second separating process to clean the liquid crystal panel bodies 11B. Because the polarizing plates 18 are not bonded to the liquid crystal panel bodies 11B in this stage, performances of the polarizing plates 18 are not reduced by the cleaning solution. Between the first separating process and the second separating process, steps may be performed. For example, a terminal exposing step of collectively cutting sections of CF board 11a of the liquid crystal panel bodies 11B to expose mounting areas (terminal areas) of array boards 11b on which flexible circuit boards 13 and drivers 17 are mounted may be performed. However, it is not necessary to perform the steps.

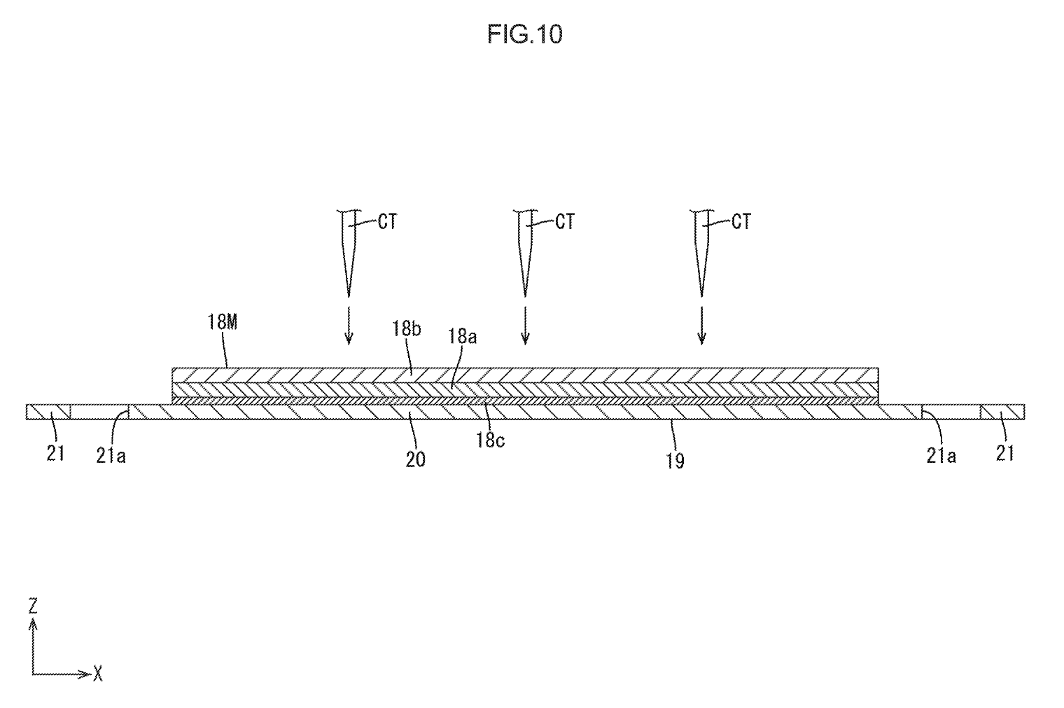

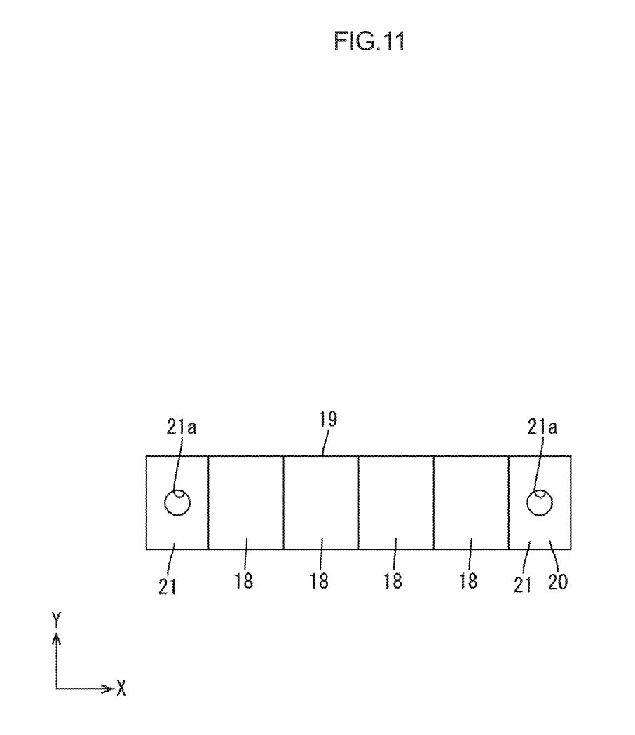

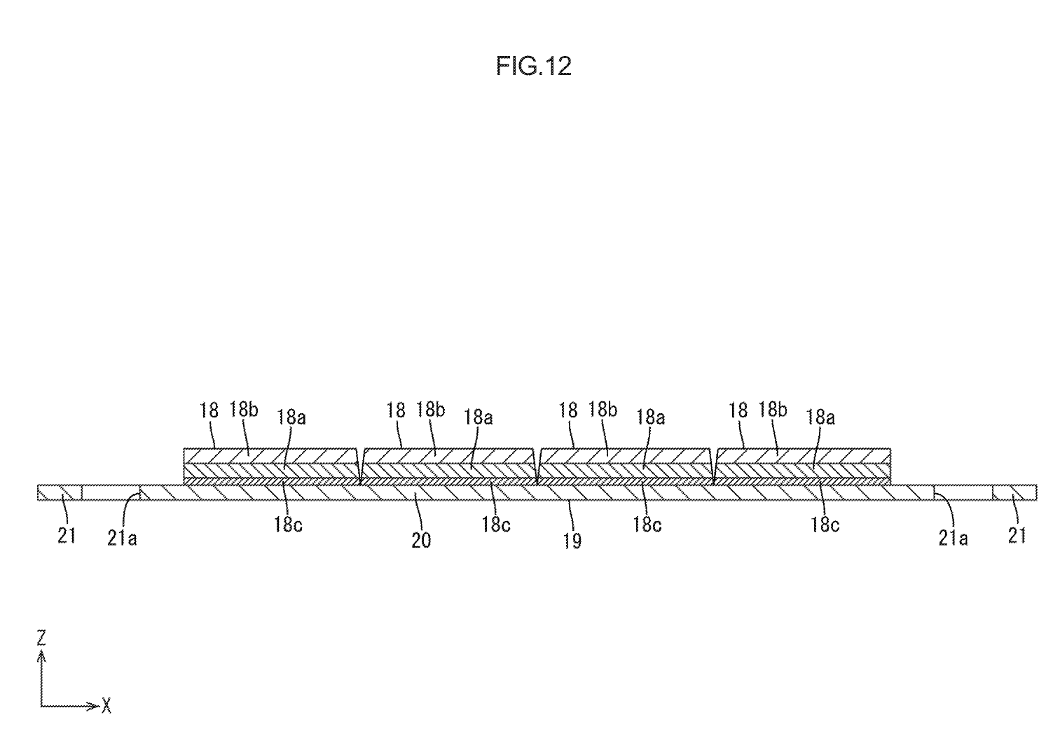

While the processes for preparing the liquid crystal panel bodies 11B are performed as described above, the polarizing plate component preparing process that is for preparing the polarizing plates 18 is separately performed. The polarizing plate component preparing process will be described in detail. In the polarizing plate component preparing process, the polarizing plate component 19 is prepared. The polarizing plate component 19 includes four polarizing plates 18 that are held by a separator layer 20 (a polarizing plate carrier) to be removable from the separator layer 20 and detachable from one another. In the polarizing plate bonding process that is performed afterward, cutting of the polarizing plates with a blade is not required unlike the conventional method. Therefore, this method has an advantage in production efficiency and the liquid crystal panel bodies 11B are protected from being scratched. Specifically, as illustrated in FIGS. 9 and 10, the polarizing plate component preparing process includes a base attaching step and a polarizing plate separating step. The base attaching step is for attaching a polarizing plate base 18M to the separator layer 20. The polarizing plate separating step is for cutting the polarizing plate base 18M attached to the separator layer 20 to set four (multiple) polarizing plates 18 detachable from one another as illustrated in FIGS. 11 and 12. In the base attaching step, the polarizing plate base 18M is attached to the separator layer 20 through a roll-to-roll processing. The separator layer 20 is prepared separately from the polarizing plate base 18M. As illustrated in FIG. 9, the polarizing plate base 18M attached to the separator layer 20 in the base attaching step has a horizontally-long rectangular shape in a plan view with a long dimension about four times larger than a short dimension of the polarizing plate 18 and a short dimension about equal to a long dimension of the polarizing plate 18. In FIG. 9, boundaries between the adjacent polarizing plates 18 (cut lines at which the polarizing plates 18 separate in the polarizing plate separating process) are indicated with two-dot chain lines. As illustrated in FIG. 10, the polarizing plate base 18M has the same lamination structure as that of the polarizing plate 18, which will be described later. A fixing layer 18c is fixed to the separator layer 20 such that the separator layer 20 is removable. In the polarizing plate separating step, the polarizing plate base 18M is cut at positions that are at equal intervals with respect to the long direction of the polarizing plate base 18M (to cut into quarters) with a cutter CT. A depth of cut is controlled so as not reach the separator layer 20. Through the processes, the polarizing plate component 19 is prepared. As illustrated in FIGS. 11 and 12, the polarizing plate component 19 includes four polarizing plates 18 that are linearly arranged along the X-axis direction and collectively held by a single separator layer 20 to be detachable from one another. In comparison to a method in which polarizing plates are separately prepared and attached to a separator layer, higher production efficiency can be achieved. Furthermore, outlines of the polarizing plates 18 can be freely defined depending on how to cut the polarizing plate base 18M in the polarizing plate separating step.

As illustrated in FIG. 11, the polarizing plate component 19 prepared through the polarizing plate component preparing process includes four polarizing plates 18 linearly arranged along the X-axis direction and directly next to one another. In comparison to a method in which intermediate portions are provided at predefined intervals between polarizing plates, a length of the polarizing plate component 19 can be defined at minimum. Therefore, it is preferable for reducing a material cost related to the polarizing plate component 19. Each polarizing plate 18 in the polarizing plate component 19 has a vertically-long rectangular shape in a plan view which is slightly smaller than the CF board 11a. The separator layer 20 In the polarizing plate component 19 prepared through the polarizing plate component preparing process includes two positioning portions 21 that sandwich linearly arranged four polarizing plates 18 from ends with respect to the X-axis direction, which corresponds with an arrangement direction of the polarizing plates 18. The positioning portions 21 are extending portions of the separator layer 20 extending outward relative to the polarizing plates 18 at ends in the arrangement direction of the polarizing plates 18 in the polarizing plate component 19. Each positioning portion 21 has a vertically-long rectangular shape in a plan view similar to each polarizing plate 18. A size of the positioning portion 21 in the plan view is slightly smaller than that of the polarizing plate 18. Specifically, each positioning portion 21 has a long dimension about equal to the long dimension of the polarizing plate 18 and a short dimension smaller than the short dimension of the polarizing plate 18, for example, about 10 mm. The positioning portions 21 include positioning holes 21a, respectively. Each positioning hole 21a is a through hole formed in about the middle of the positioning portion 21. The positioning hole 21a is a round shape in a plan view with a diameter of about 2 mm.

As illustrated in FIG. 12, the polarizing plates 18 in the polarizing plate component 19 include polarizing layers 18a, laminator layers 18b (protective layers), and fixing layers 18c. Each polarizing layer 18a is for converting circularly polarized light into linearly polarized light. Each laminator layer 18b is disposed on an opposite side of the polarizing layer 18a from the separator layer 20 to protect the polarizing layer 18a. Each fixing layer 18c is disposed on a separator layer 20 side (an opposite side from the laminator layer 18b) of the polarizing layer 18a. Each polarizing layer 18a includes a polarizer and two protective films that sandwich the polarizer. The polarizer includes a polymer resin film such as a polyvinyl alcohol (PVA) film and absorbers that are mixed in the polymer resin film and extended such that the absorbers are oriented. Examples of the absorbers include iodine and dichroic dye. The protective films may be triacetylcellulose (TAC) films. The configuration of each polarizing layer 18a is not limited to the configuration described above and can be altered as appropriate. Each laminator layer 18b forms an outer surface of the corresponding polarizing plate 18 on an opposite side from an attachment surface attached to the corresponding CF board 11a or the corresponding array board 11b, which is either the front plate surface or the back plate surface of the polarizing plate 18. The laminator layer 18b protects the polarizing layer 18a from being scratched. Each fixing layer 18c is made of adhesive material and disposed on the attachment surface, which is either the front plate surface or the back plate surface of the polarizing plate 18. The fixing layers 18c have functions of attaching the polarizing plates 18 to the outer surfaces of the boards 11a and 11b. In the polarizing plate components 19, the separator layer 20 is attached to the fixing layers 18c to be removable. According to the configuration, the polarizing plates 18 are held by the separator layer 20.

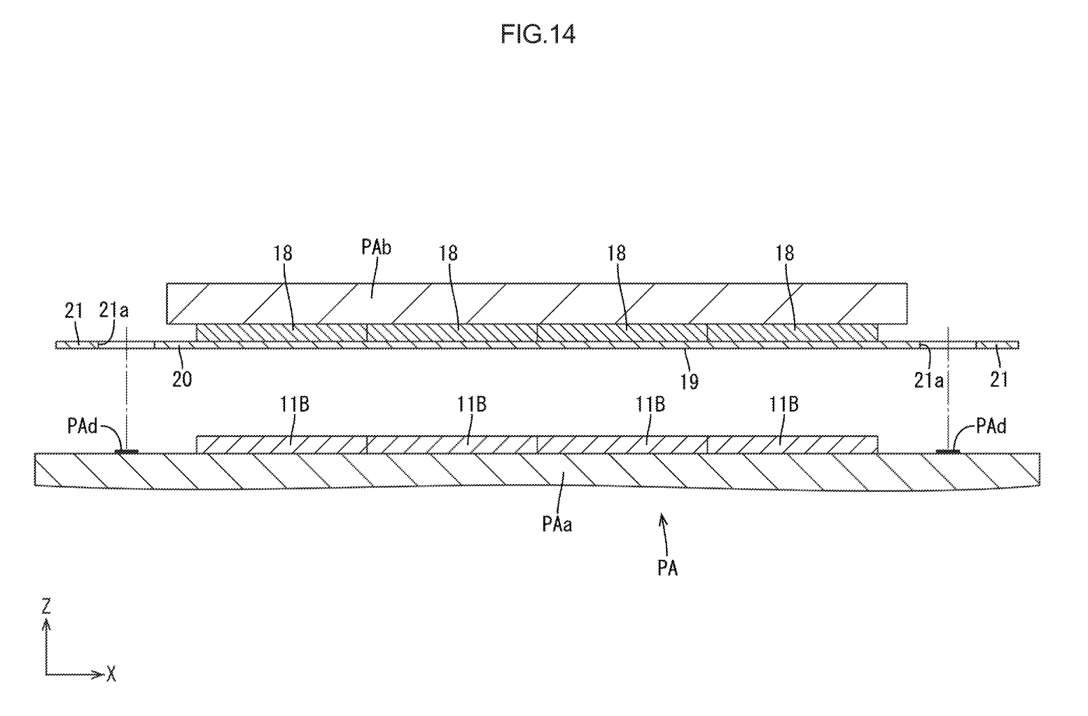

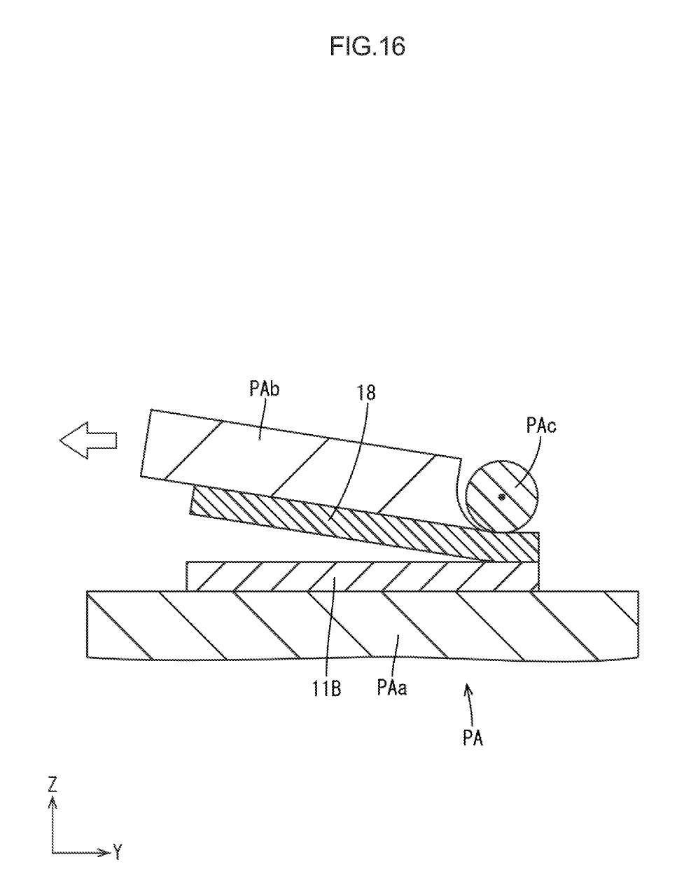

The polarizing plate bonding process will be described in detail. The polarizing plate bonding process is performed using a polarizing plate bonding device PA. As illustrated in FIGS. 14 and 16, the polarizing plate bonding device PA includes at least a liquid crystal panel vacuum stage PAa, a polarizing plate vacuum stage PAb, and a pressure roller Pac. The liquid crystal panel vacuum stage PAa is for holding the liquid crystal panel bodies 11B with vacuum. The polarizing plate vacuum stage PAb is for holding the polarizing plate components 19 with vacuum. The pressure roller Pac is for pressing the polarizing plates 18 onto the liquid crystal panel bodies 11B. On the liquid crystal panel vacuum stage PAa, liquid crystal panel alignment marks (not illustrated) for positioning the liquid crystal panel bodies 11B and two polarizing plate alignment marks PAd for positioning the polarizing plate component 19 are provided. The pressure roller PAc has a dimension in the X-axis direction defined such that four polarizing plates 18 in the polarizing plate component 19 are collectively pressed. The polarizing plate bonding process includes at least a liquid crystal panel body placing step, a polarizing plate placing step, a positioning step, a separator removing step, and a pressure bonding step. The liquid crystal panel body placing step is for vacuuming four liquid crystal panel bodies 11B with the liquid crystal panel vacuum stage PAa. The polarizing plate placing step is for vacuuming the polarizing plate component 19 with the polarizing plate vacuum stage PAb. The positioning step is for positioning the polarizing plate component 19 relative to the liquid crystal panel bodies 11B. The separator removing step is for removing the separator layer 20 of the polarizing plate component 19. The pressure bonding step is for bonding the polarizing plates 18 to the liquid crystal panel bodies 11B using the pressure roller PAc.

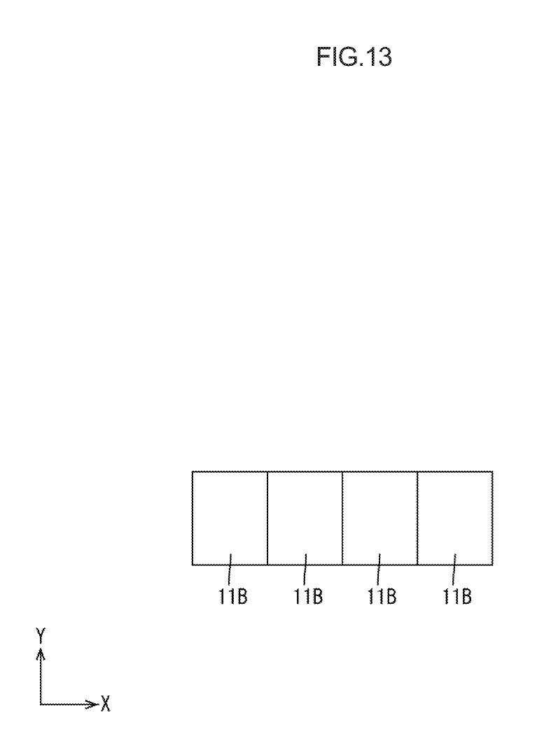

As illustrated in FIGS. 13 and 14, in the liquid crystal panel body placing step, four liquid crystal panel bodies 11B are placed to be directly next to one another, that is, with almost no gaps among them along the X-axis direction on the liquid crystal panel vacuum stage PAa and the liquid crystal panel bodies 11B placed as described above are vacuumed and held with the liquid crystal panel vacuum stage PAa. Placement positions of the liquid crystal panel bodies 11B are defined with the liquid crystal panel alignment marks. As illustrated in FIG. 14, in the polarizing plate placing step, the polarizing plate component 19 is vacuumed and held with the polarizing plate vacuum stage PAb. As illustrated in FIG. 14, in the positioning step, the polarizing plate component 19 held with the polarizing plate vacuum stage PAb is disposed opposite the liquid crystal panel bodies 11B held with the liquid crystal panel vacuum stage PAa with a predefined space between the polarizing plate component 19 and the liquid crystal panel bodies 11B while positioning of the polarizing plate component 19 relative to the liquid crystal panel bodies 11B is performed using the positioning portions 21 of the polarizing plate component 19 and the polarizing plate alignment marks PAd on the polarizing plate vacuum stage PAb. Specifically, the liquid crystal panel vacuum stage PAa and the polarizing plate vacuum stage PAb are moved relative to each other in the X-axis direction and the Y-axis direction until the polarizing plate alignment marks PAd are set in the respective positioning holes 21a of the positioning portions 21. Then, the position of the polarizing plate component 19 is further adjusted until the polarizing plate alignment marks PAd are set at the centers of the respective positioning holes 21a based on positional relations between hole edges of the positioning holes 21a and the polarizing plate alignment marks PAd. When the polarizing plate component 19 is at the predefined position, four polarizing plates 18 in the polarizing plate component 19 are positioned relative to four liquid crystal panel bodies 11B with high accuracy to be opposed to each other.

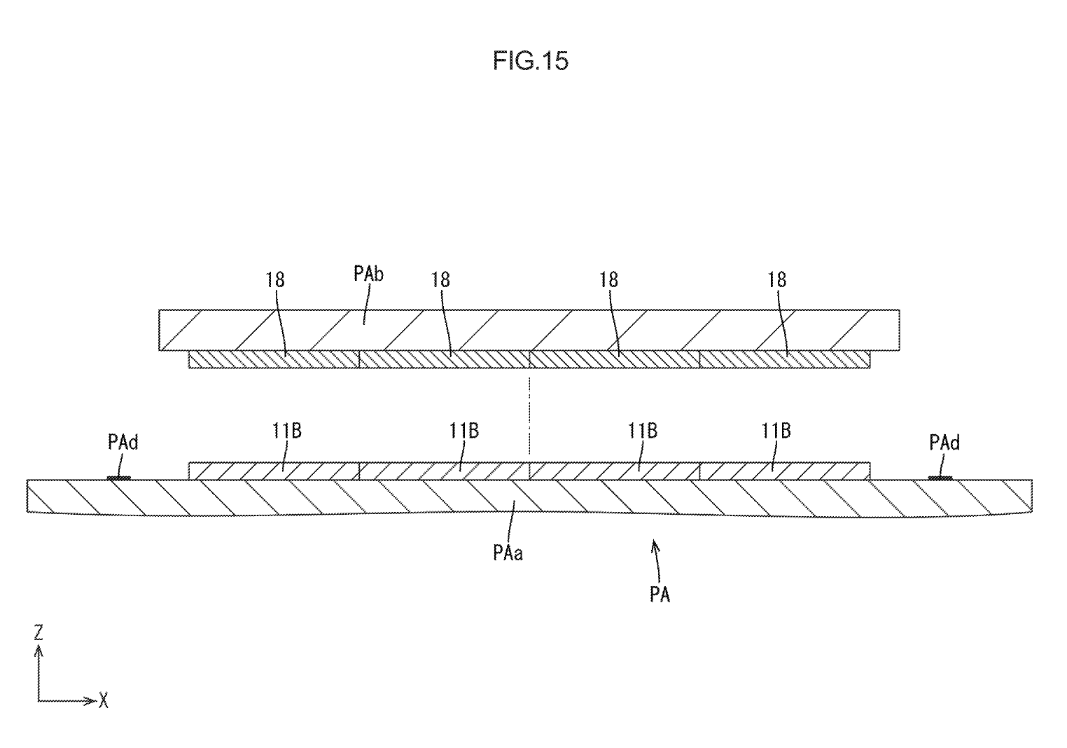

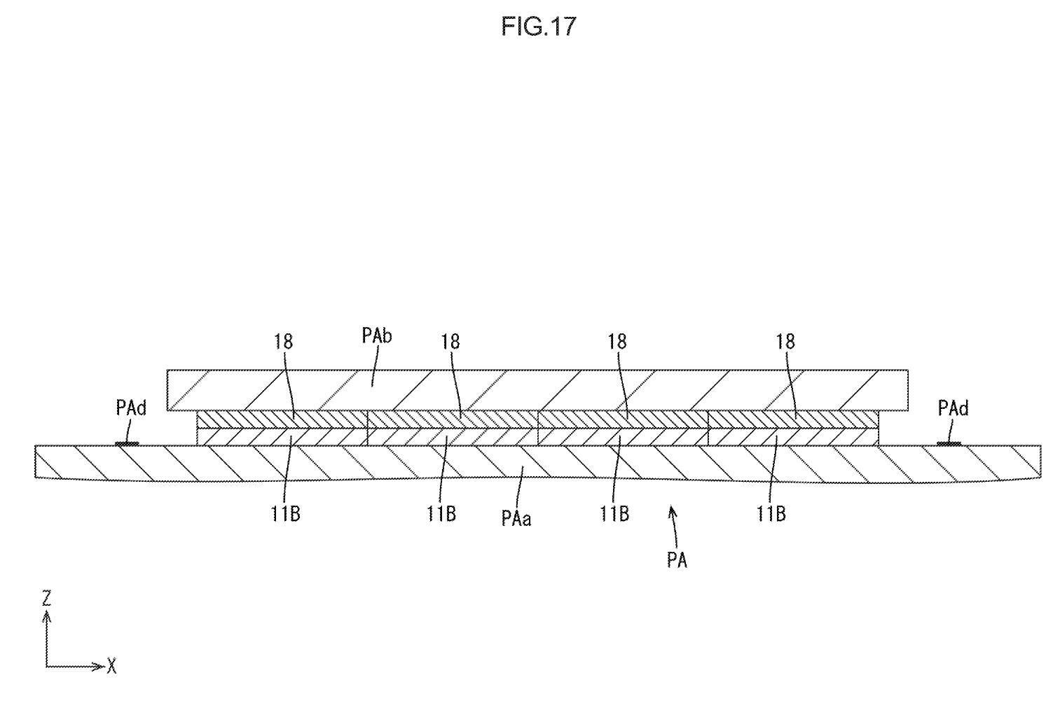

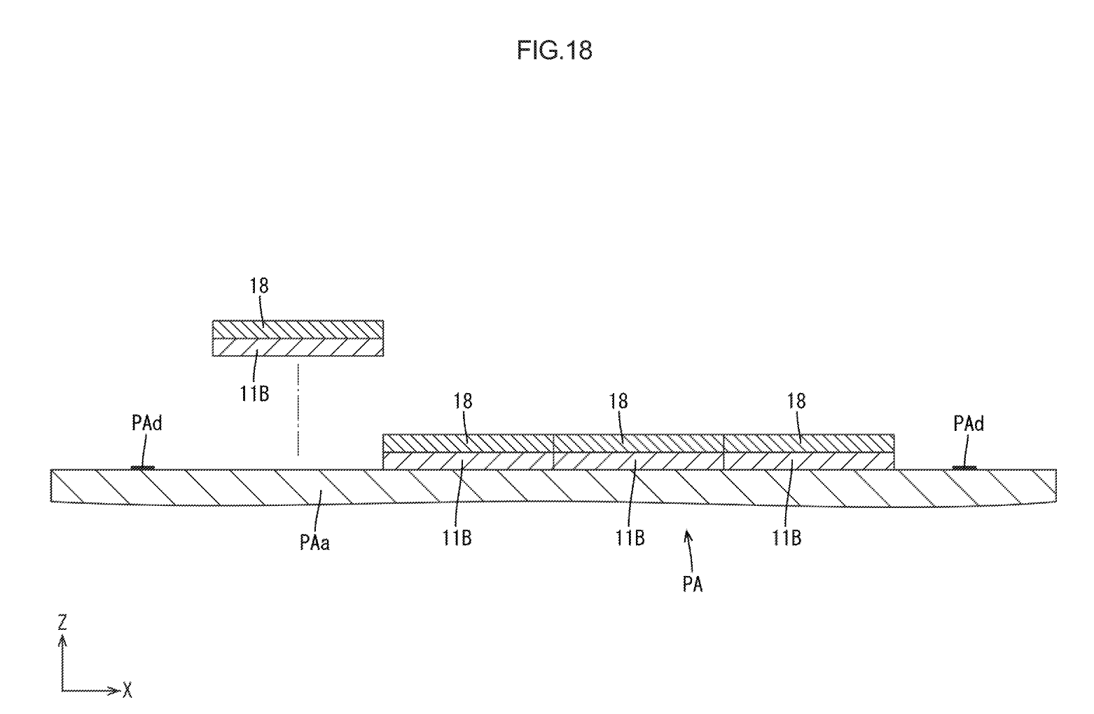

As illustrated in FIG. 15, in the separator removing step, the separator layer 20 of the polarizing plate component 19 is removed. When the separator layer 20 is removed, the fixing layers 18c of four polarizing plates 18 in the polarizing plate component 19 are exposed. Four polarizing plates 18 are vacuumed and held with the polarizing plate vacuum stage PAb and maintained at predefined positions relative to four liquid crystal panel bodies 11B. In the pressure bonding step performed next, the polarizing plate vacuum stage PAb that has been held in a horizontal position is tilted such that a first end with respect to the Y-axis direction approaches the liquid crystal panel vacuum stage PAa as illustrated in FIG. 16 and the pressure roller PAc is brought into contact with first ends of the polarizing plates 18 with respect to the Y-axis direction. A predefine load is applied to the first ends of the polarizing plates 18 by the pressure roller PAc and collective bonding of the polarizing plates 18 to the liquid crystal panel bodies 11B starts. The polarizing plate vacuum stage PAb and the pressure roller PAc in states described above are moved relative to the liquid crystal panel vacuum stage PAa along the Y-axis direction to second ends (the left in FIG. 16). The polarizing plates 18 are collectively bonded to the respective liquid crystal panel bodies 11B for an entire length in the Y-axis direction through application of pressure by the pressure roller PAc. The fixing layers 18c of the polarizing plates 18 are fixed to the outer surfaces of the respective liquid crystal panel bodies 11B. When the polarizing plates 18 are bonded to the respective liquid crystal panel bodies 11B as illustrated in FIG. 17, the liquid crystal panel bodies 11B with the polarizing plates 18 bonded to the outer surfaces on one of the sides are removed from the liquid crystal panel vacuum stage PAa as illustrated in FIG. 18. Four polarizing plates 18 are formed in the preparation of the polarizing plate component 19 to be removable from one another. Therefore, a step of cutting the polarizing plates bonded to the liquid crystal pane bodies with a blade, which is required in the conventional method, is not required and thus higher production efficiency can be achieved. Furthermore, the surfaces of the liquid crystal panel bodies 11B are less likely to be scratched. The polarizing plates 18 are bonded to the other outer surfaces of the liquid crystal panel bodies 11B in the polarizing plate bonding step similar to the step described above. Through the steps, the liquid crystal panels 11 with the polarizing plates 18 bonded to the outer surfaces thereof are prepared.

As described above, four polarizing plates 18 in the polarizing plate component 19 are collectively bonded to four liquid crystal panel bodies 11B. Therefore, although the polarizing plates 18 and the liquid crystal panel bodies 11B are reduced in size to prepare the liquid crystal panels 11 having the screen size of one inch or smaller, they can be easily handled and the bonding of the polarizing plates 18 to the liquid crystal panel bodies 11B can be easily performed. Furthermore, the bonding can be automated using the polarizing plate bonding device PA described above. The method is preferable for producing the liquid crystal panels 11 that are reduced in size.

As described above, the method of producing the liquid crystal panel 11 (the display panel) in this embodiment includes the first separating process (the display panel body component preparing process), the second separating process (the separating process), the cleaning process, the polarizing plate component preparing process, and the polarizing plate bonding process. The first separating process is for preparing the liquid crystal panel body component 11BM (the display panel body component) including the liquid crystal panel bodies 11B (the display panel bodies) which are coupled to one another. The second separating process is for separating the liquid crystal panel body component 11BM into the liquid crystal panel bodies 11B. The cleaning process is for cleaning the liquid crystal panel bodies 11B. The polarizing plate component preparing process is for preparing the polarizing plate component 19 that includes the polarizing plates 18 coupled to one another. The polarizing plate bonding process is for collectively bonding the polarizing plates 18 in the polarizing plate component 19 to the liquid crystal panel bodies 11B.

The liquid crystal panel body component 11BM prepared through the liquid crystal panel body component preparing process are separated into the liquid crystal panel bodies 11B in the separating process. The liquid crystal panel bodies 11B prepared through the separating process are cleaned in the cleaning process and particles produced during the separation are removed. The polarizing plates 18 in the polarizing plate component 19 prepared through the polarizing plate component preparing process are collectively bonded to the liquid crystal panel bodies 11B in the polarizing plate bonding process and the liquid crystal panels 11 are prepared. The separating process and the cleaning process are performed prior to the polarizing plate bonding process. In comparison to the conventional method in which the separating process and the cleaning process are performed after the polarizing plate bonding process, reductions in performance of the polarizing plates 18 are less likely to occur because the polarizing plates 18 are not cleaned in the cleaning process. In the polarizing plate bonding process, the polarizing plates 18 that are coupled to one another in the polarizing plate component 19 are collectively bonded to the liquid crystal panel bodies 11B. Although the polarizing plates 18 are reduced in size, they can be easily handled and the bonding can be easily automated. This method is preferable for producing the liquid crystal panels 11 that are reduced in size.

In the polarizing plate component preparing process, the polarizing plate component including the polarizing plates 18 hat are held by the separator layer 20 (the polarizing plate carrier) to be removable from the separator layer 20 and detachable from one another is prepared. In the polarizing plate component 19 prepared through the polarizing plate component preparing process, the polarizing plates 18 held with the separator layer 20 to be removable from the separator layer 20 are removable from one another. Therefore, the polarizing plate bonding process that is performed afterward does not require cutting of the polarizing plates 18 with a blade as in the conventional method. According to this method, higher production efficiency can be achieved and the liquid crystal panel bodies 11B are less likely to be scratched.

The polarizing plate component preparing process includes at least the base attaching step and the polarizing plate separating step. The base attaching step is for attaching the polarizing plate base 18M to the separator layer 20. The polarizing plate separating step is for cutting the polarizing plate base 18M attached to the separator layer 20 to set the polarizing plates 18 detachable from one another. In comparison to a method in which polarizing plates are separately prepared and the polarizing plates are attached to the separator layer 20, higher production efficiency can be achieved. Furthermore, outlines of the polarizing plates 18 can be freely defined depending on how to cut the polarizing plate base 18M in the polarizing plate separating step.

In the polarizing plate component preparing process, the polarizing plate component 19 including the polarizing plates 18 that are linearly arranged and the positioning portions 21 that sandwich the polarizing plates 18 from the ends with respect to the arrangement direction of the polarizing plates 18 is prepared. In the polarizing plate bonding process, the polarizing plates 18 are positioned relative to the liquid crystal panel bodies 11B using the positioning portions 21. In the polarizing plate bonding process, the polarizing plates 18 can be collectively bonded with high accuracy because the polarizing plates 18 are positioned relative to the liquid crystal panel bodies 11B using the positioning portions 21 that are disposed to sandwich the polarizing plates 18 from the ends with respect to the arrangement direction of the polarizing plates 18.

In the polarizing plate component preparing process, the polarizing plate component 19 including the polarizing plates 18 that are directly next to one another is prepared. This method is preferable for reducing a material cost related to the polarizing plate component 19.

The method of producing the liquid crystal display device 10 (the display device) according to this embodiment includes the backlight unit preparing process (the lighting device preparing process) and the fixing process. The backlight unit preparing process is for preparing the backlight unit 14 for supplying light to the liquid crystal panel 11 that is prepared by the method of producing the liquid crystal panel 11 described above. The fixing process is for fixing the backlight unit to the liquid crystal panel 11. According to the method of producing the liquid crystal display device 10, the degradation in performance of the polarizing plate 18 is less likely to occur in the preparation of the liquid crystal panel 11 and the liquid crystal panel 11 in the small size can be easily prepared. Therefore, high display performance can be achieved and the method is preferable for reducing the size of the display device.

### Second Embodiment

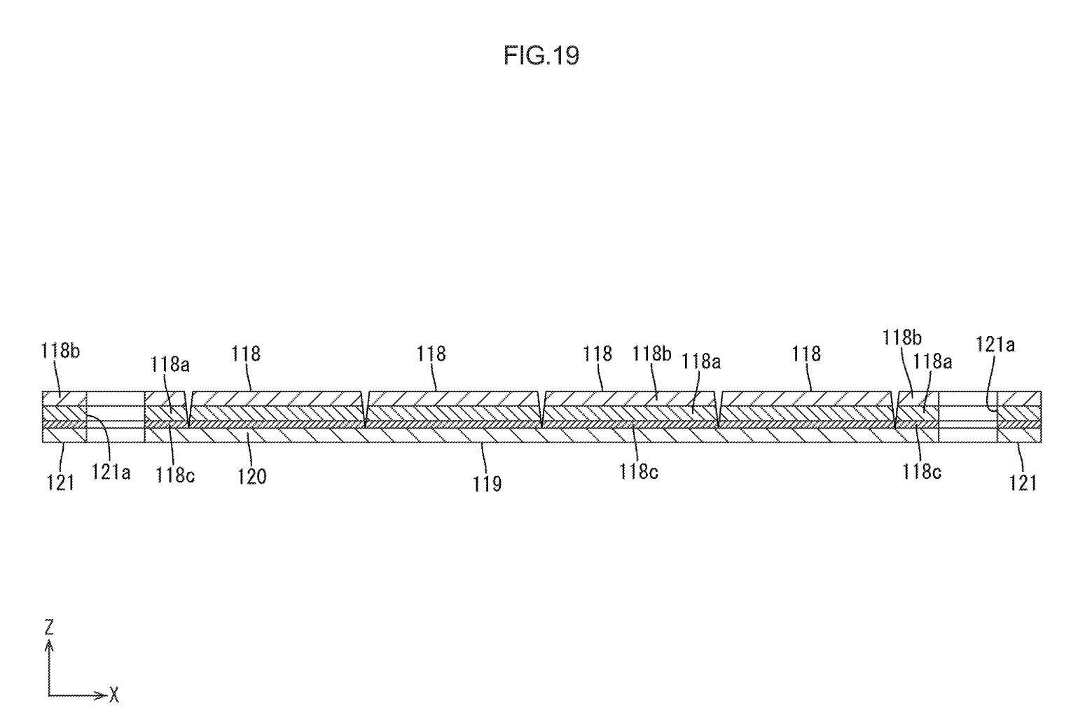

A second embodiment of the present invention will be described with reference to FIG. 19. The second embodiment includes a polarizing plate component 119 having a configuration different from the first embodiment. Configurations, functions, and effects similar to those of the first embodiment will not be described.

As illustrated in FIG. 19, the polarizing plate component 119 according to this embodiment includes positioning portions 121 include separator layers 120, polarizing layers 118a, laminator layers 118b, and fixing layers 118c. Each positioning portion 121 has a stacking structure similar to a stacking structure of a polarizing plate 118. Positioning holes 121a formed in the positioning portions 121 run all the way through the polarizing layers 118a, the laminator layers 118b, the fixing layers 118c, and the separator layers 120.

### Third Embodiment

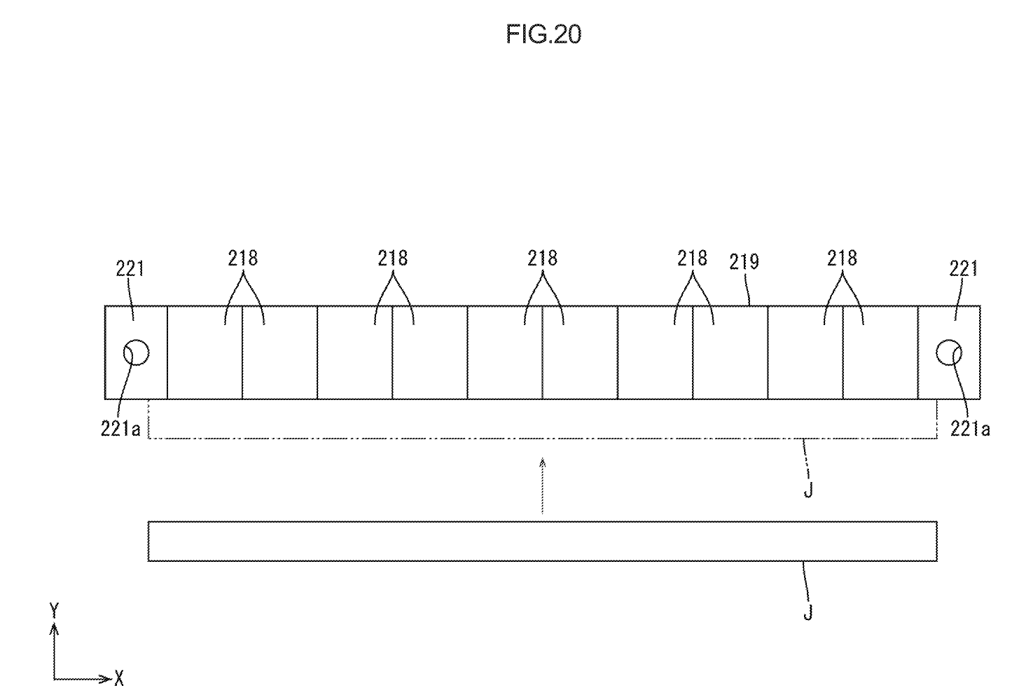

A third embodiment of the present invention will be described with reference to FIG. 20. The third embodiment includes a polarizing plate component 219 including polarizing plates 218, the number of which is different from the first embodiment. Configurations, functions, and effects similar to those of the first embodiment will not be described.

As illustrated in. FIG. 20, the polarizing plate component 219 according to this embodiment includes ten polarizing plates 218 that are arranged directly next to one another along the X-axis direction. Positioning portions 221 are disposed to sandwich ten polarizing plates 218 from ends with respect to an arrangement direction of the polarizing plates 218. In this embodiment, the polarizing plate component 219 has a predefined standard length (e.g., about 150 mm). A first positioning portion 221 has a short dimension, about equal to that of the first embodiment (e.g., about 10 mm). A second positioning portion 221 has a short dimension larger than the short dimension of the first positioning portion 221, specifically, about 19 mm. Because the polarizing plate component 219 according to this embodiment is longer than that of the first embodiment, the polarizing plate component 219 can be maintained straight or corrected by holding a jig J against a long edge of the polarizing plate component 219 for setting the polarizing plate component 219 in a polarizing plate bonding device (not illustrated) or positioning the polarizing plate component 219 relative to liquid crystal panel bodies (not illustrated).

### Fourth Embodiments

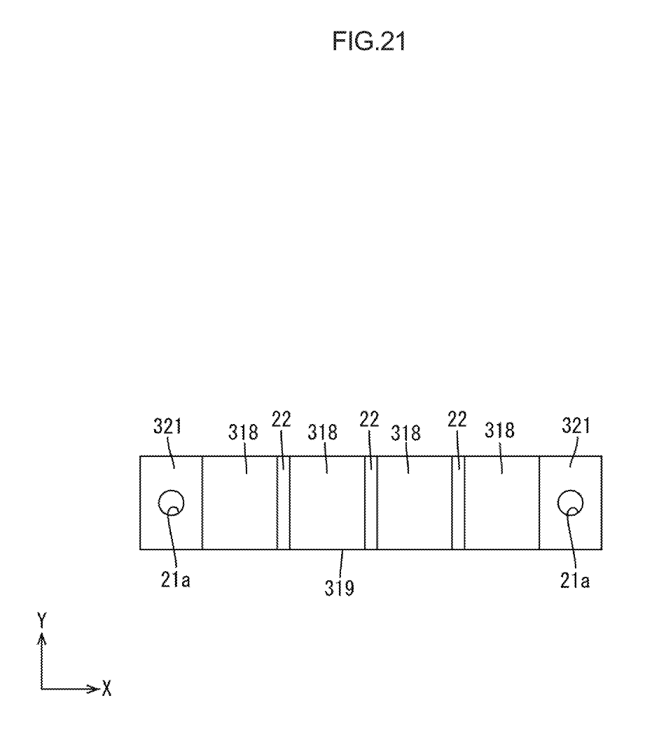

A fourth embodiment of the present invention will be described with reference to FIGS. 21 to 27. The fourth embodiment includes a polarizing plate component 319 having a configuration different from the first embodiment. Configurations, functions, and effects similar to those of the first embodiment will not be described.

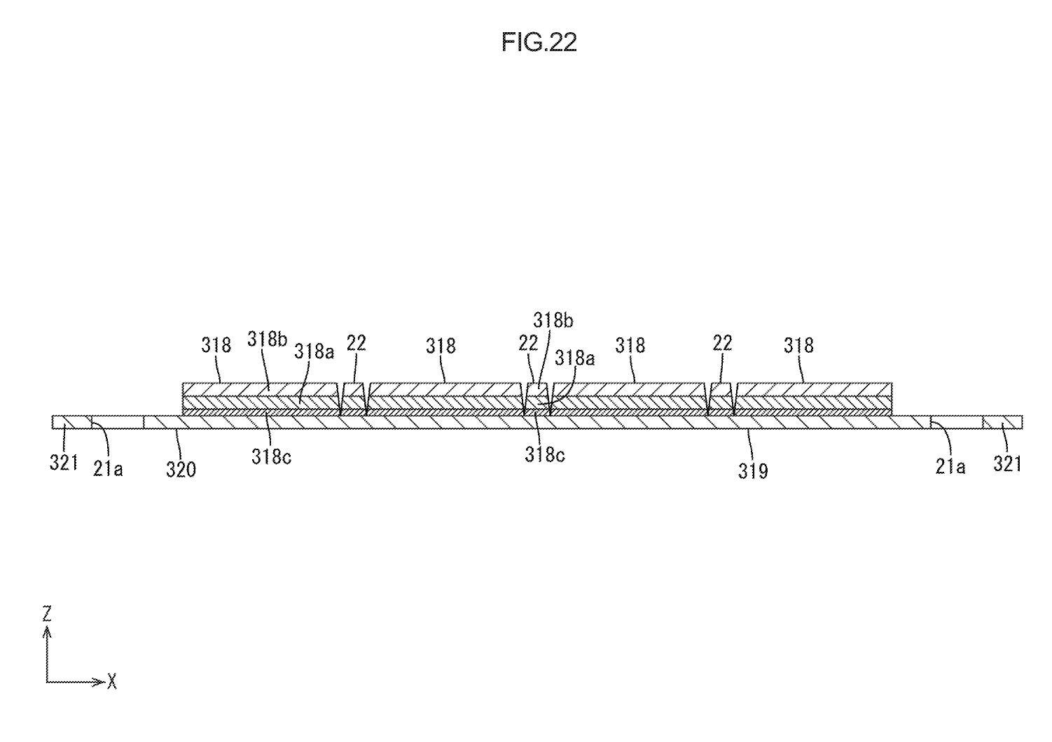

As illustrated in FIGS. 21 and 22, the polarizing plate component 319 according to this embodiment is prepared in a polarizing plate component preparing process to include intermediate portions 22 between adjacent polarizing plates 318. Each intermediate portion 22 has a stacking structure similar to that of each polarizing plate 318. The intermediate portion 22 includes a polarizing layer 318a, a laminator layer 318b, and a fixing layer 318c. The fixing layer 318c is fixed to a separator layer 320. The intermediate portion 22 has a long dimension about equal to the long dimension of the polarizing plate 318 and a short dimension smaller than the short dimension of the polarizing plate 318, specifically, about 2 mm. The polarizing plate component 319 includes the polarizing plates 318 and the intermediate portions 22 that are repeatedly and alternately arranged along the X-axis direction. The polarizing plate component 319 further includes two positioning portions 321 at ends with respect to an arrangement direction of the polarizing plates 318 and the intermediate portions 22. The number of the intermediate portions 22 is equal to the number of the polarizing pates 318 minus one (three in this embodiment).

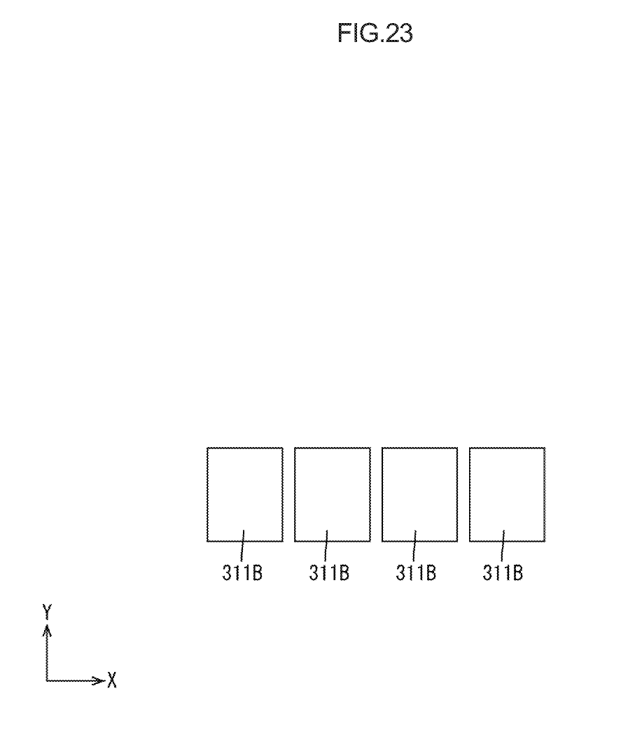

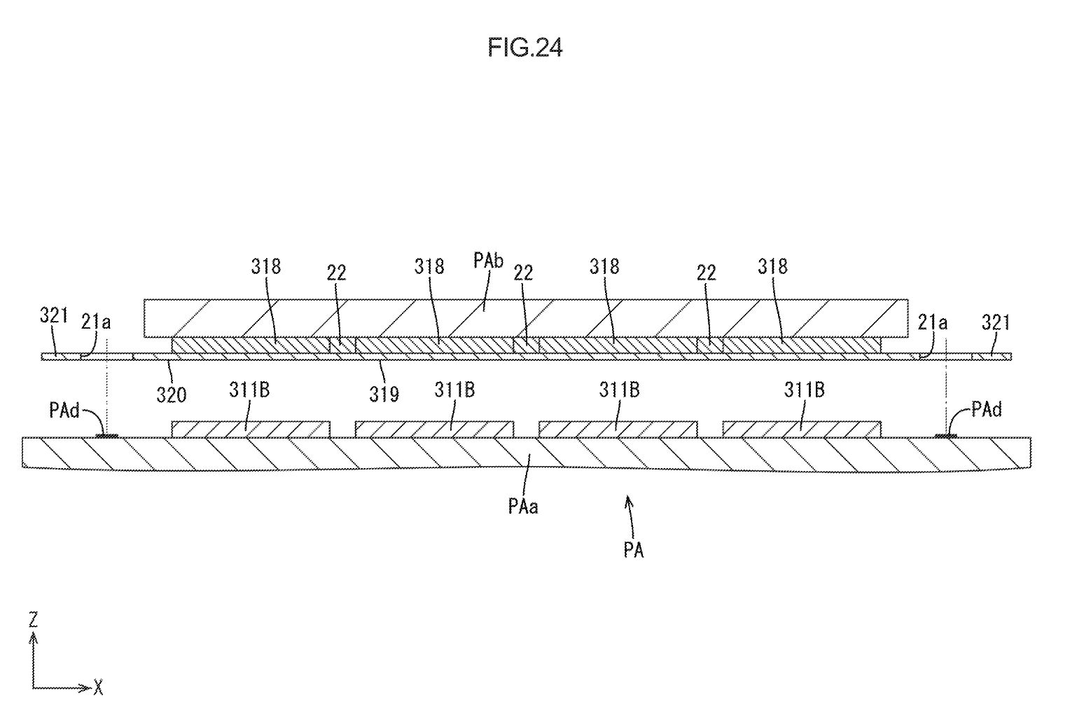

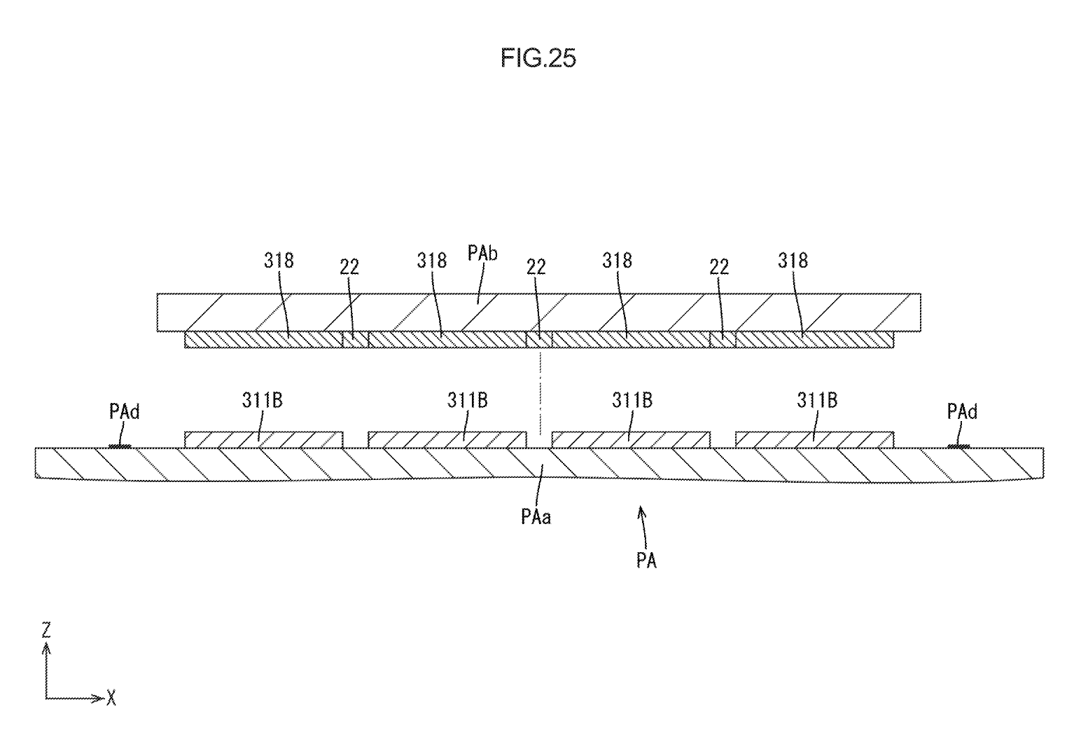

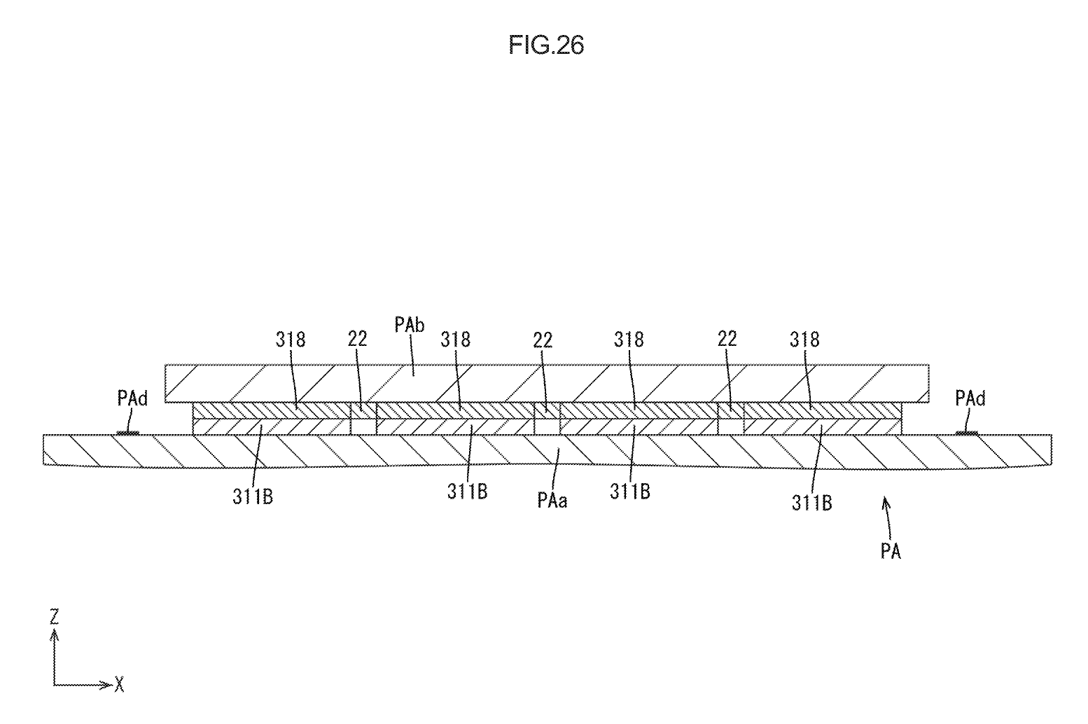

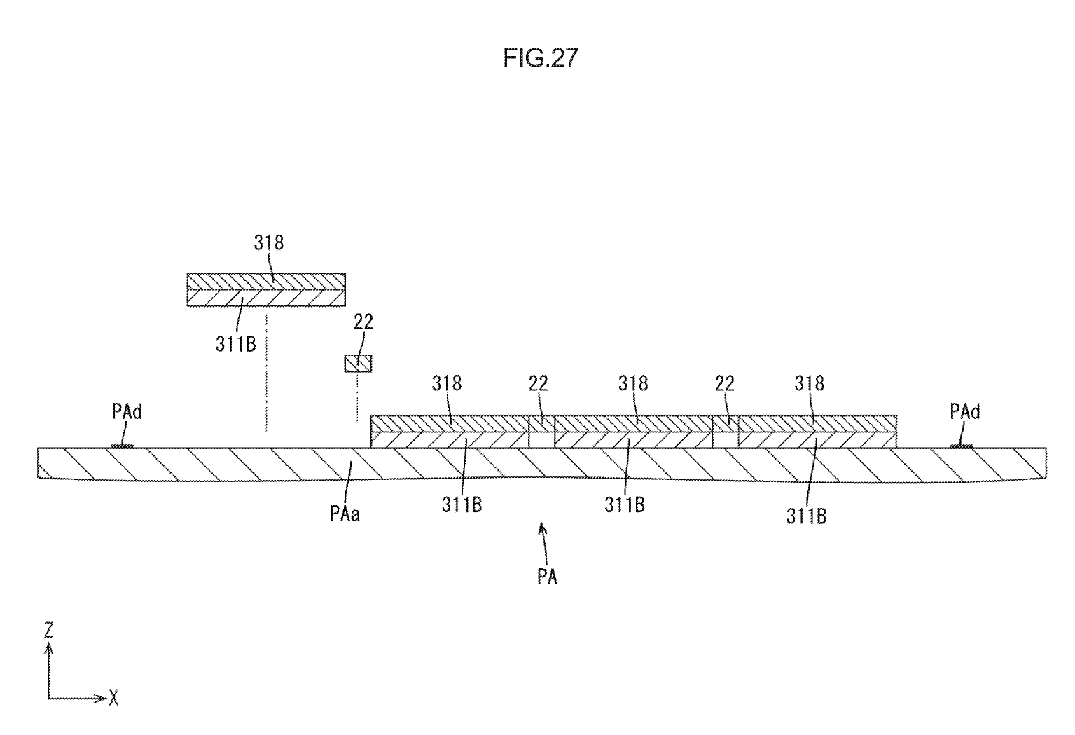

A polarizing plate bonding process for the polarizing plate component 319 that is prepared through the polarizing plate component preparing process described above will be described. As illustrated in FIGS. 23 and 24, in a liquid crystal panel body placing process, four liquid crystal panel bodies 311B are vacuumed with the liquid crystal panel vacuum stage PAa. The liquid crystal panel bodies 311B are placed such that spaces corresponding to the intermediate portions 22 are provided between the adjacent liquid crystal panel bodies 311B. The placement of the liquid crystal panel bodies 311B can be easily performed. As illustrated in FIGS. 24 and 25, a polarizing plate placing process, a positioning process, and a separator removing process are performed in the same manner as the first embodiment. When the separator removing process is complete, as illustrated in FIG. 25, the polarizing plates 318 and the intermediate portions 22 are held with the polarizing plate vacuum stage PAb. Through a pressure bonding process, as illustrated in FIG. 26, four polarizing plates 318 are collectively bonded to four liquid crystal panel bodies 311B. After the polarizing plates 318 are bonded to the liquid crystal panel bodies 311B, as illustrated in FIG. 27, the liquid crystal panel bodies 311B with the polarizing plates 318 bonded to surfaces of the liquid crystal panel bodies 311B on one side are removed from the liquid crystal panel vacuum stage PAa and the intermediate portions 22 are detached from the liquid crystal pane bodies 311B.

According to this embodiment, the polarizing plate component 319 including the polarizing plates 318 and the intermediate portions 22 that are disposed between the adjacent polarizing plates 318 is prepared in the polarizing plate component preparing process. According to the method, the spaces corresponding to the intermediate portions 22 are provided between the adjacent liquid crystal panel bodies 311B during the placement of the liquid crystal panel bodies 311B in the polarizing plate bonding process. The placement of the liquid crystal panel bodies 311B can be easily performed.

### Fifth Embodiment

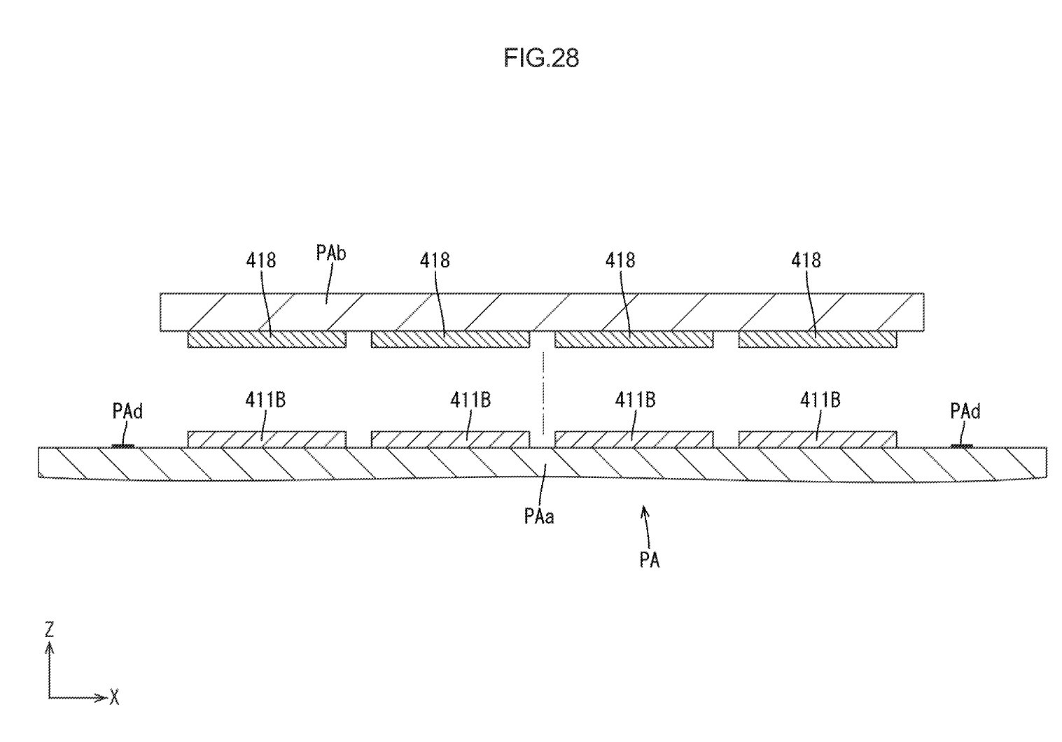

A fifth embodiment of the present invention will be described with reference to FIGS. 28 to 30. The fifth embodiment includes a separator removing process that is different from the fourth embodiment. Configurations, functions, and effects similar to those of the fourth embodiment will not be described.

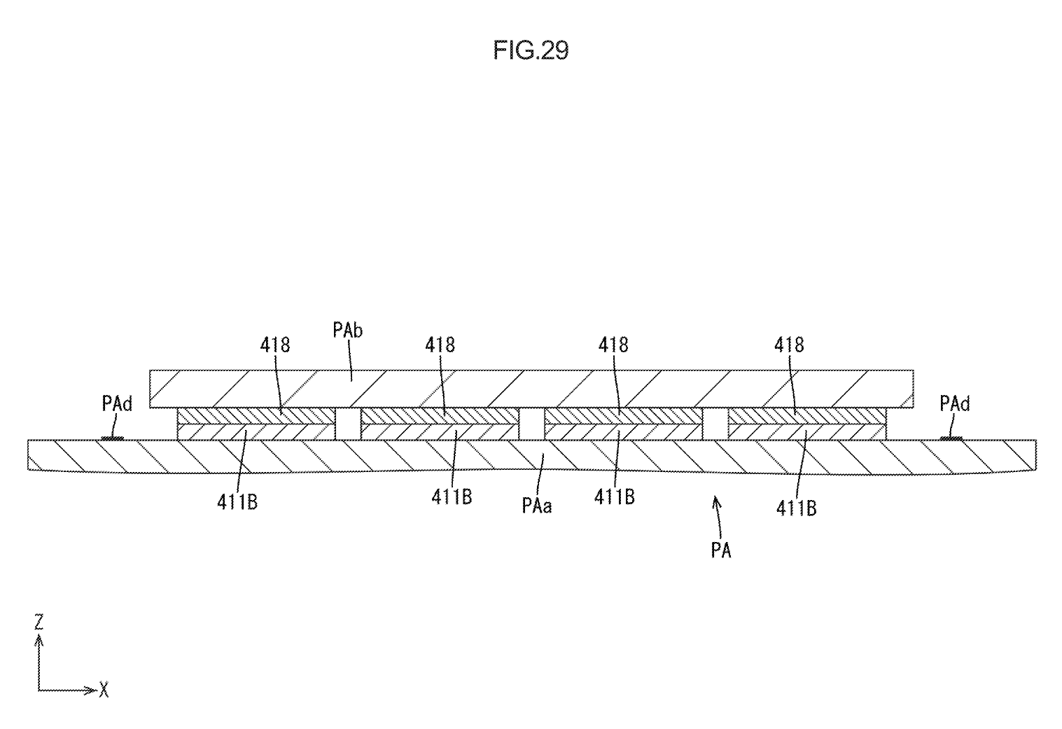

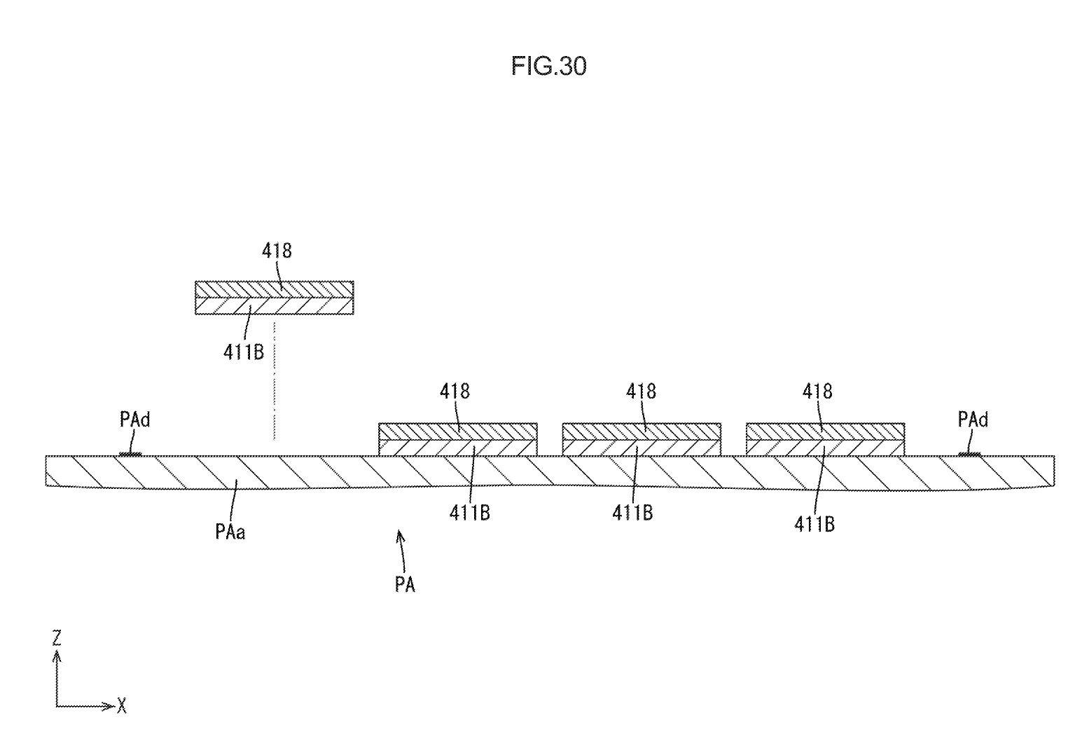

As illustrated in FIG. 28, in the separator removing process according to this embodiment, a separator layer (not illustrated) is removed from a polarizing plate component and intermediate portions (not illustrated) are removed from the polarizing plate vacuum stage PAb. As illustrated in FIG. 29, a pressure bonding process is performed to bonding polarizing plates 418 to liquid crystal panel bodies 411B. As illustrated in FIG. 30, the liquid crystal panel bodies 411B with the polarizing plates 418 bonded to outer surfaces of the liquid crystal panel bodies 411B on one side are removed from the liquid crystal panel vacuum stage PAa. In this embodiment, the removal of the intermediate portions is not required. In this embodiment, the intermediate portions are removed in the separator removing process. However, the intermediate portions may be removed from the separator layer of the polarizing plate component prior to the polarizing plate placing process.

### Sixth Embodiment

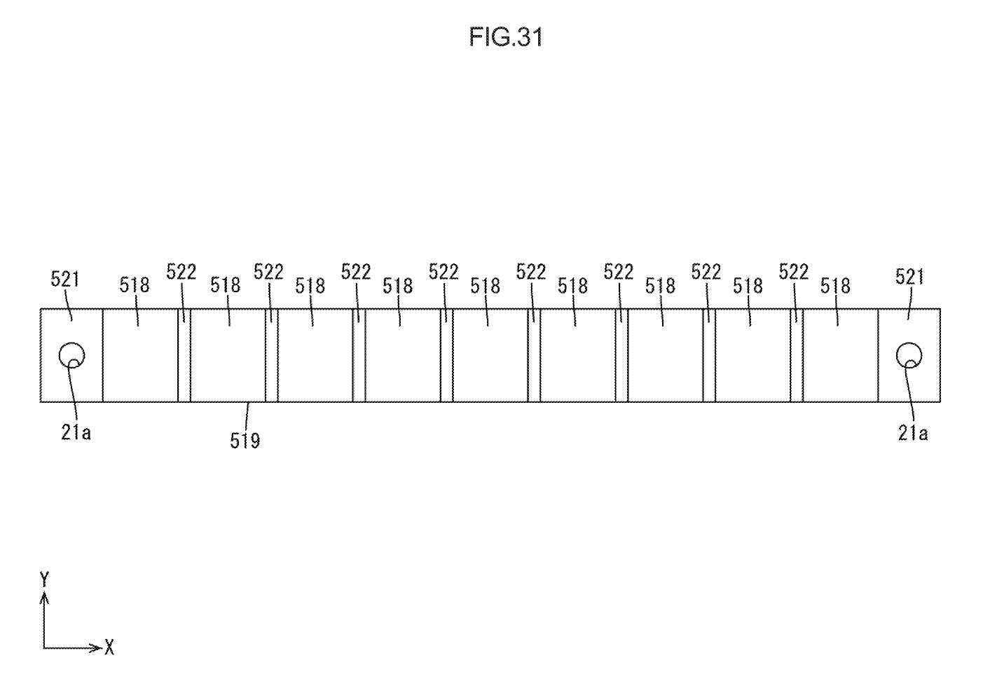

A sixth embodiment of the present invention will be described with reference to FIG. 31. The sixth embodiment includes a polarizing plate component 519 including polarizing plates 518 and intermediate portions 522, the numbers of which are different from those of the fourth embodiment. Configurations, functions, and effects similar to those of the fourth embodiment will not be described.

As illustrated in FIG. 31, the polarizing plate component 519 according to this embodiment includes nine polarizing plates 518 arranged along the X-axis direction and the intermediate portions 522 between the polarizing plates 518. The number of the intermediate portions 522 included in the polarizing plate component 519 is eight. Positioning portions 521 are disposed to sandwich nine polarizing plates 518 and eight intermediate portions 522 from ends with respect to an arrangement direction of the polarizing plates 518 and the intermediate portions 522. In this embodiment, the polarizing plate component 519 has a predefined standard long dimension similar to the third embodiment (e.g., about 150 mm). A first positioning portions 521 has a short dimension similar to the first embodiment (e.g., about 10 mm). A second positioning portions 521 has a short dimension that is larger than the short dimension of the first positioning portion 521, specifically, about 15.1 mm. Because the polarizing plate component 519 has such an elongated shape, the polarizing plate component 519 can be maintained straight or corrected using a jig similar to the third embodiment.

### Seventh Embodiment

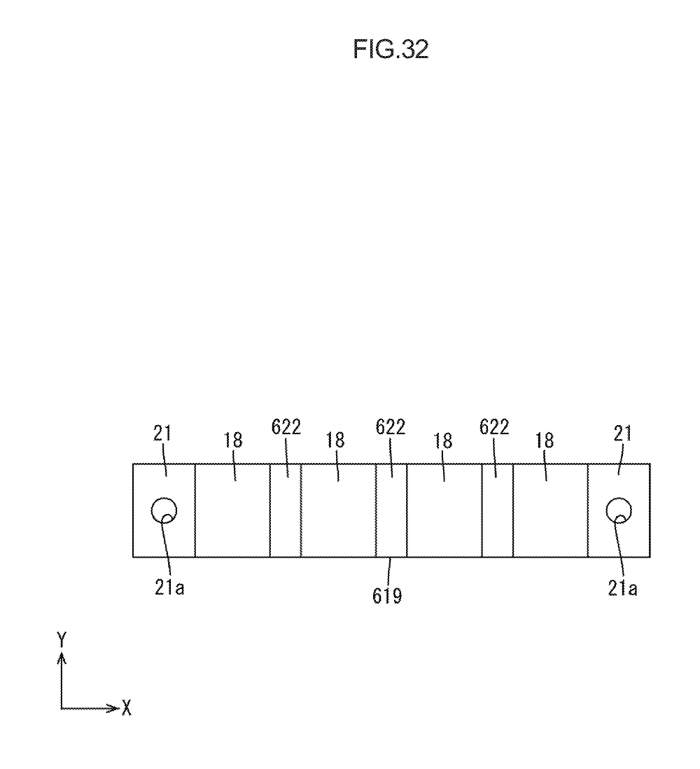

A seventh embodiment of the present invention will be described with reference to FIG. 32. The seventh embodiment includes a polarizing plate component 619 having a configuration different from the fourth embodiment. Configurations, functions, and effects similar to those of the fourth embodiment will not be described.

As illustrated in FIG. 32, the polarizing plate component 619 according to this embodiment includes intermediate portions 622 having a short dimension that is larger than that of the fourth embodiment. Specifically, the short dimension of the intermediate portions 622 is about 5 mm. During placement of four liquid crystal panel bodies, which are not illustrated, on the liquid crystal panel vacuum stage in a liquid crystal panel body placing process, larger spaces are provided between the adjacent liquid crystal panel bodies. Therefore, the placement of the liquid crystal panel bodies can be further easily performed.

### Eighth Embodiment

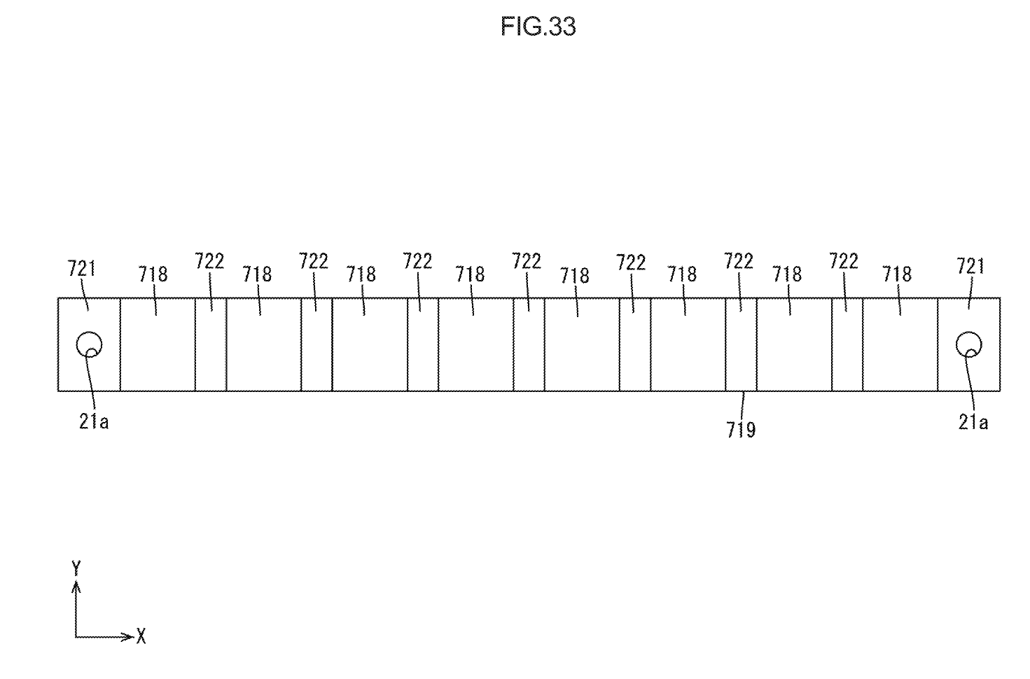

An eighth embodiment of the present invention will be described with reference to FIG. 33. The eighth embodiment includes a polarizing plate component 719 including polarizing plates 718 and intermediate portions 722, the numbers of which are different from the seventh embodiment. Configurations, functions, and effects similar to those of the seventh embodiment will not be described.

As illustrated in FIG. 33, the polarizing plate component 719 according to this embodiment eight polarizing plates 718 arranged along the X-axis direction with intermediate portions 722 disposed between the polarizing plates 718. The number of the intermediate portions 722 included in the polarizing plate component 719 is seven. Positioning portions 721 are disposed at ends with respect to an arrangement direction of eight polarizing plates 718 and seven intermediate portions 722 to sandwich the polarizing plates 718 and the intermediate portions 722. In this embodiment, the polarizing plate component 719 has a predefined standard length similar to the third embodiment (e.g., about 150 mm). A first positioning portion 721 has a short dimension similar to the first embodiment (e.g., about 10 mm). A second positioning portion 721 has a short dimension smaller than the snort dimension of the first positioning portion 721, specifically, about 8.2 mm. The polarizing plate component 719 having such an elongated shape can be maintained straight or corrected using a jig similar to the third embodiment.

### Ninth Embodiment

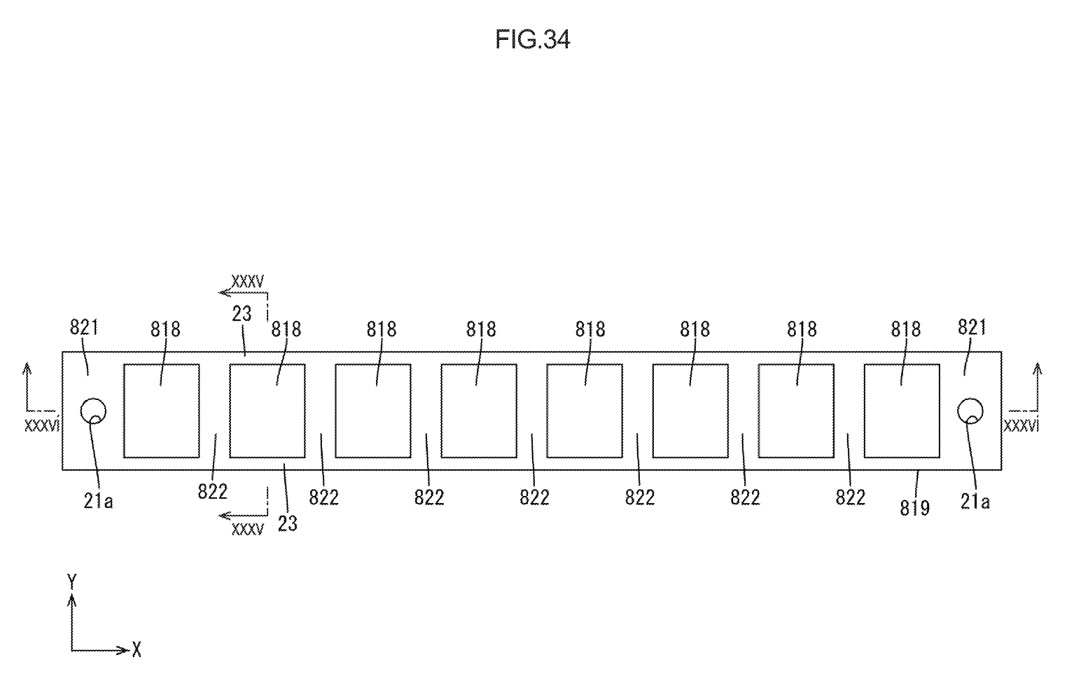

A ninth embodiment of the present invention will be described with reference to FIG. 34. The ninth embodiment includes a polarizing plate component 819 having a configuration different from the eighth embodiment. Configurations, functions, and effects similar to those of the eighth embodiment will not be described.

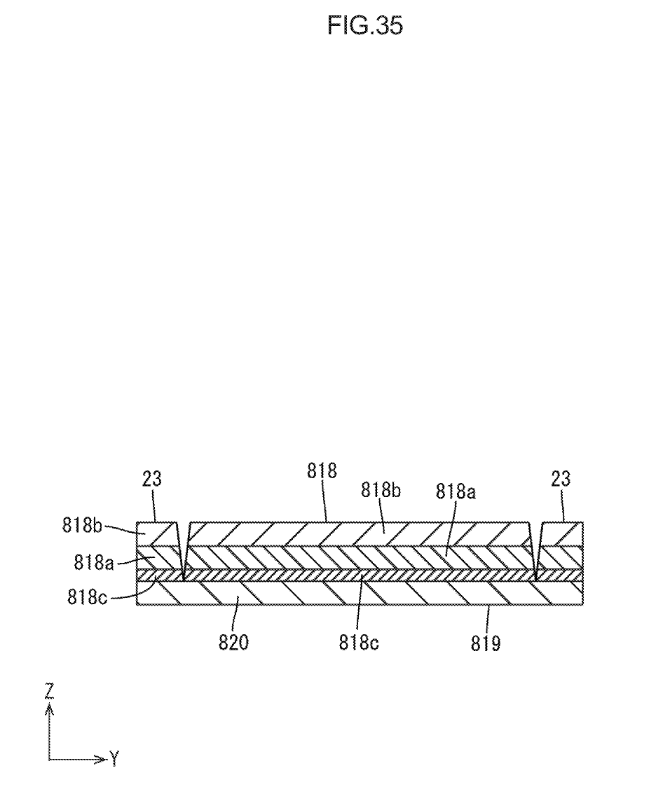

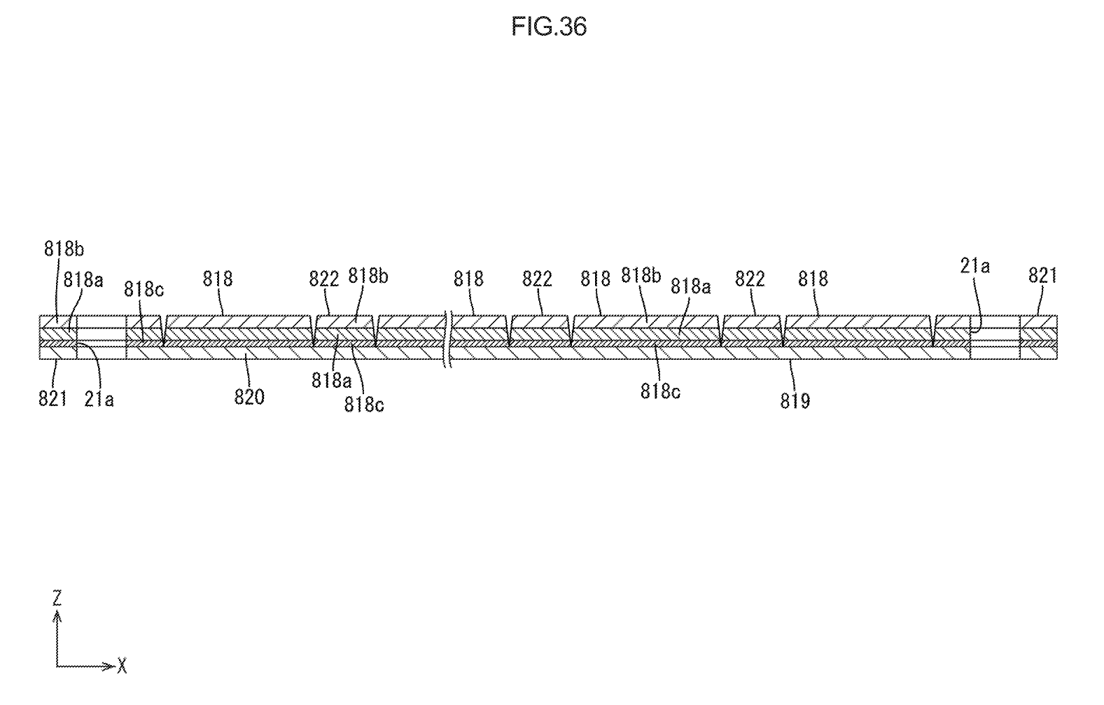

As illustrated in FIGS. 34 and 35, in a polarizing plate component preparing process, the polarizing plate component 819 according to this embodiment is prepared to include end surface protecting portions 23 disposed over end surfaces of polarizing plates 818 along the X-axis direction (an arrangement direction) in which the polarizing plates 818 are arranged. The end surface protecting portions 23 are disposed over short end surfaces of the polarizing plates 818. With the end surface protecting portions 23, the end surfaces of the polarizing plates 818 on the short edge sides are protected. Some of the end surface protecting portions 23 are disposed over (adjacent to) a first short end surfaces of the polarizing plates 818 on an outer side with respect to the Y-axis direction (a direction perpendicular to the arrangement direction). The rest of the end surface protecting portions 23 are disposed over a second short end surfaces of the polarizing plates 818 on an outer side with respect to the Y-axis direction. Namely, the end surface protecting portions 23 sandwich the polarizing plates 818 with respect to a long direction of the polarizing plates 818. In the polarizing plate component 819, the end surface protecting portions 23 are disposed to cover entire areas of the short end surfaces of the polarizing plates 818. Therefore, the short end surfaces of the polarizing plates 818 are properly protected. The end surface protecting portions 23 have a lamination structure similar to the lamination structure of the polarizing plates 818 and intermediate portions 822. The end surface protecting portions 23 include polarizing layers 818a, laminator layers 818b, and fixing layers 818c. The fixing layers 818c are fixed to a separator layer 820. The end surface protecting portions 23 extend along the X-axis direction that corresponds with the arrangement direction of the polarizing plates 818. The end surface protecting portions 23 are coupled to the intermediate portions 822 that are disposed at intervals in the extending direction thereof. The end surface protecting portions 23 and the intermediate portions 822 are coupled together to form a ladder shape as a whole in a plan view. As illustrated in FIG. 36, positioning portions 821 include the separator layer 820, the polarizing layers 818a, the laminator layers 818b, and the fixing layers 818c.

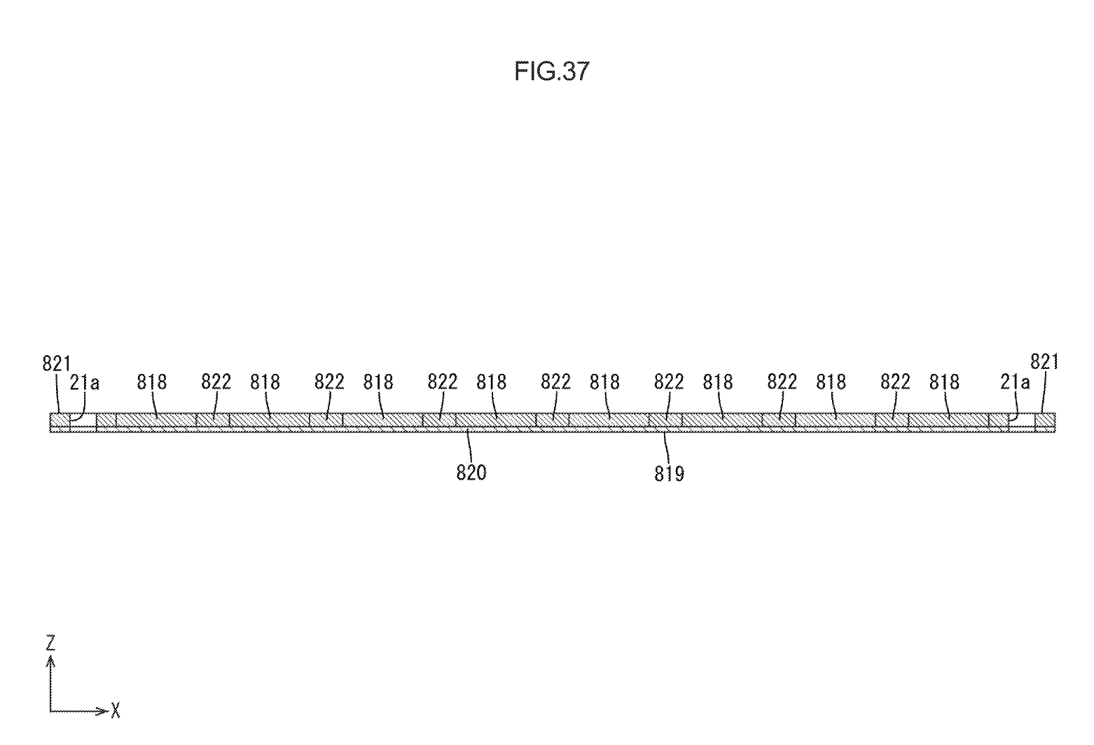

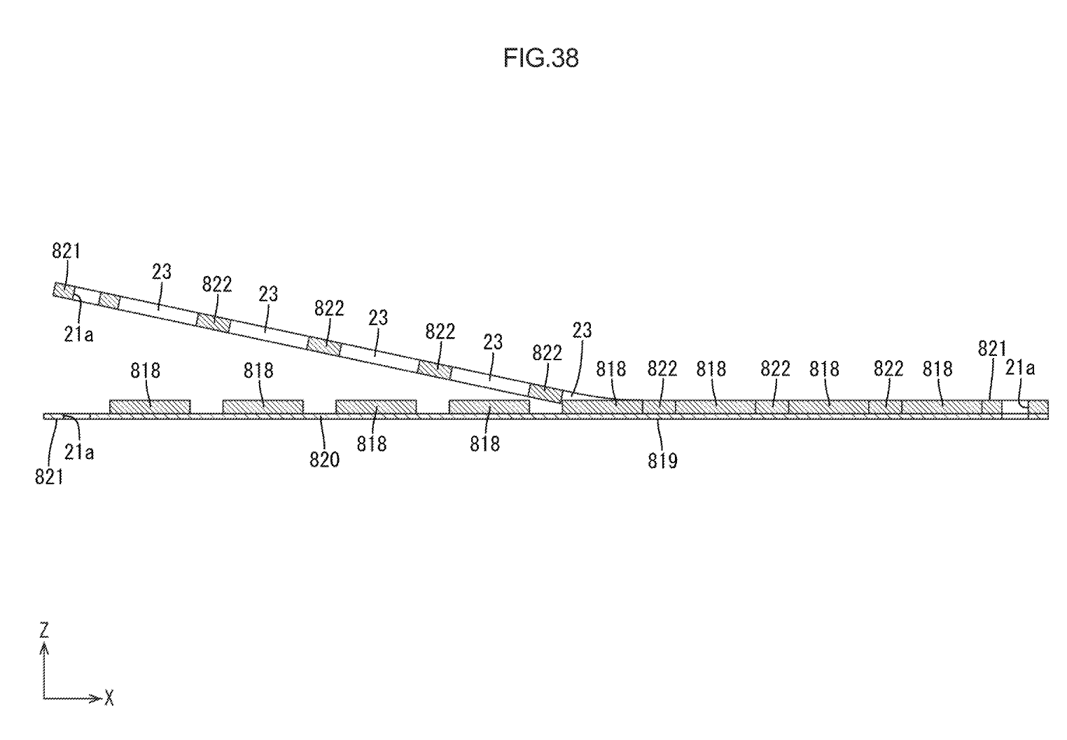

In this embodiment, an end surface protecting portion and intermediate portion removing process is performed prior to a polarizing plate placing process. The polarizing plate placing process is for placing the polarizing plate component 819 prepared through a polarizing plate component preparing process on the polarizing plate vacuum stage PAb. The end surface protecting portion and intermediate portion removing process is for collectively removing the end surface protecting portions 23 and the intermediate portions 822. In the end surface protecting portion and intermediate portion removing process, as illustrated in FIG. 38, sections of the positioning portions 821 (sections except for the separator layer 820) are collectively removed from the separator layer 820 together with the end surface protecting portions 23 and the intermediate portions 822 of the polarizing plate component 819 illustrated in FIG. 37 which are coupled together. Because the end surface protecting portions 23 and the intermediate portions 822 are coupled together, they can be collectively removed and thus higher workability can be achieved.

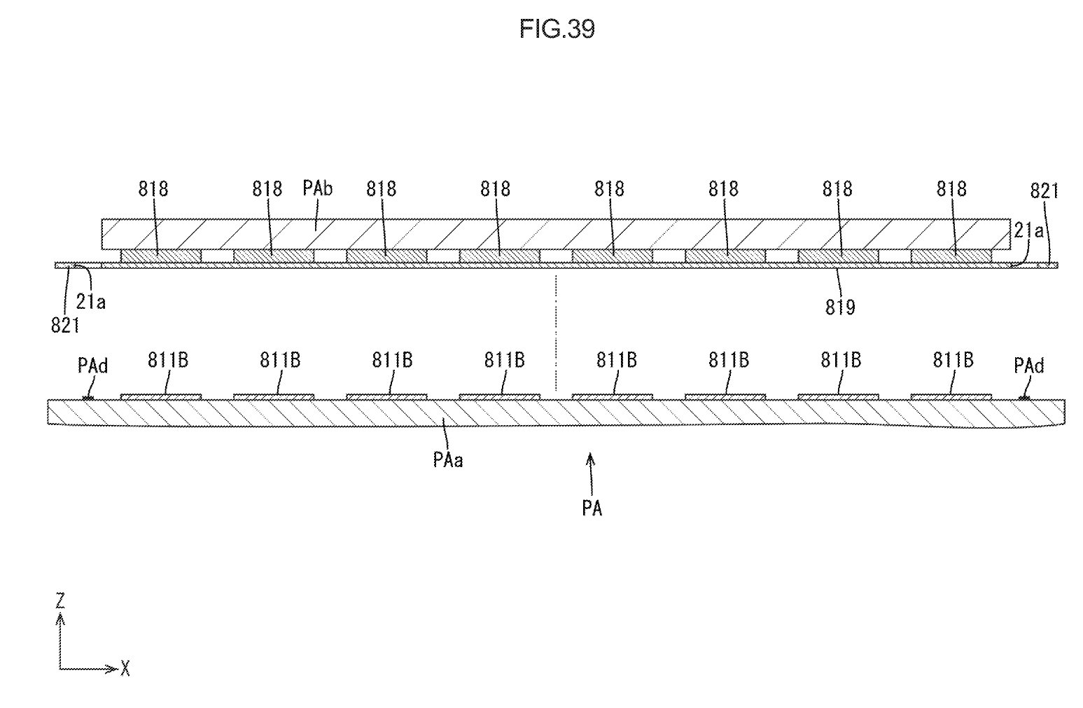

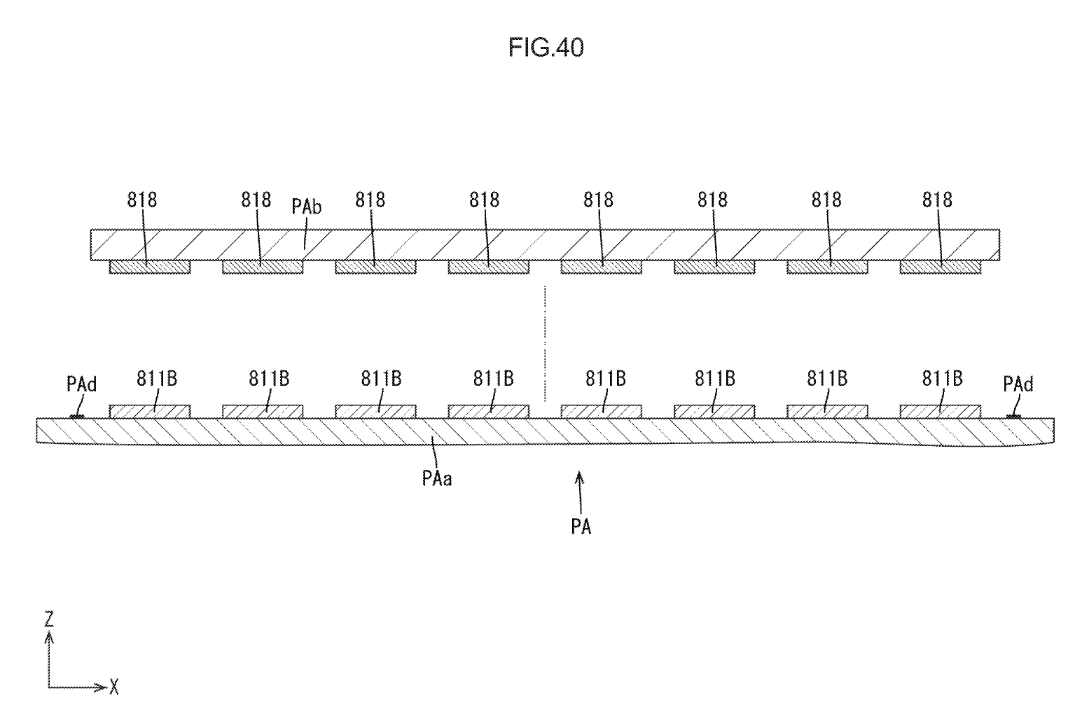

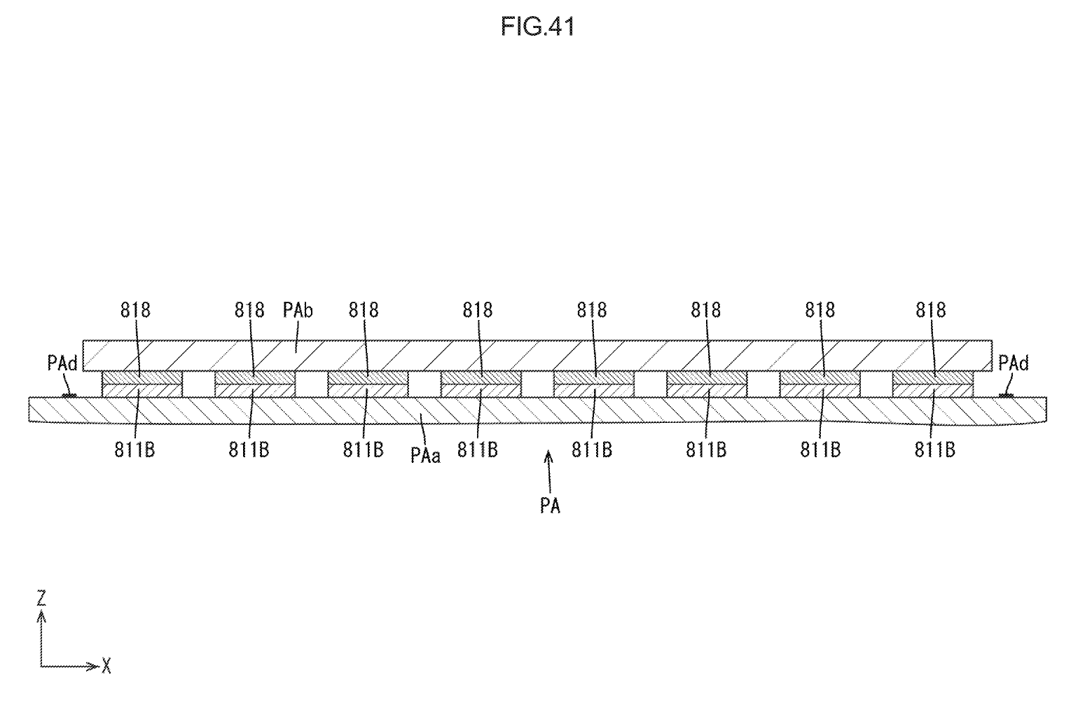

The polarizing plate component 819 from which the end surface protecting portions 23 and the intermediate portions 822 are removed through the end surface protecting portion and intermediate portion removing process is placed on the polarizing plate vacuum stage PAb through the polarizing plate placing process as illustrated in FIG. 39. Liquid crystal panel bodies 811B are placed on the liquid crystal panel vacuum stage PAa through a liquid crystal panel body placing process. After a positioning process performed in the same mariner as the first embodiment is complete, a separator removing process is preformed to remove the separator layer 820 from the polarizing plates 818. When the separator removing process is complete, only the polarizing plates 818 are held with the polarizing plate vacuum stage PAb. A pressure bonding process is performed afterward and the polarizing plates 818 are collectively bonded to the liquid crystal panel bodies 811B as illustrated in FIG. 41. After the polarizing plates 818 are bonded to the liquid crystal panel bodies 811B, the liquid crystal panel bodies 811B with the polarizing plates 818 bonded to outer surfaces on one side are removed from the liquid crystal panel vacuum stage.

As described above, in the polarizing plate component preparing process according to this embodiment, the polarizing plate component 819 including the polarizing plates 818 that are linearly arranged and the end surface protecting portions 23 that cover at least sections of the end surfaces of the polarizing plates 818 along the arrangement direction is prepared. Because the end surface protecting portions 23 cover at least the sections of the end surfaces of the polarizing plates 818 along the arrangement direction, the end surfaces are protected.

In the polarizing plate component preparing process, the polarizing plate component 819 including the end surface protecting portions 23 that cover the entire areas of the end surfaces of the polarizing plates 818 along the arrangement direction is prepared. Because the end surface protecting portions 23 cover the entire areas of the end surfaces of the polarizing plates 818 along the arrangement direction, the end surfaces are further properly protected.

In the polarizing plate component preparing process, the polarizing plate component 819 including the intermediate portions 822 disposed between the adjacent polarizing plates 818 and the end surface protecting portions 23 coupled to the intermediate portions 822 is prepared. Therefore, the end surface protecting portions 23 and the intermediate portions 822 can be collectively removed and thus higher workability can be achieved.

### Tenth Embodiment

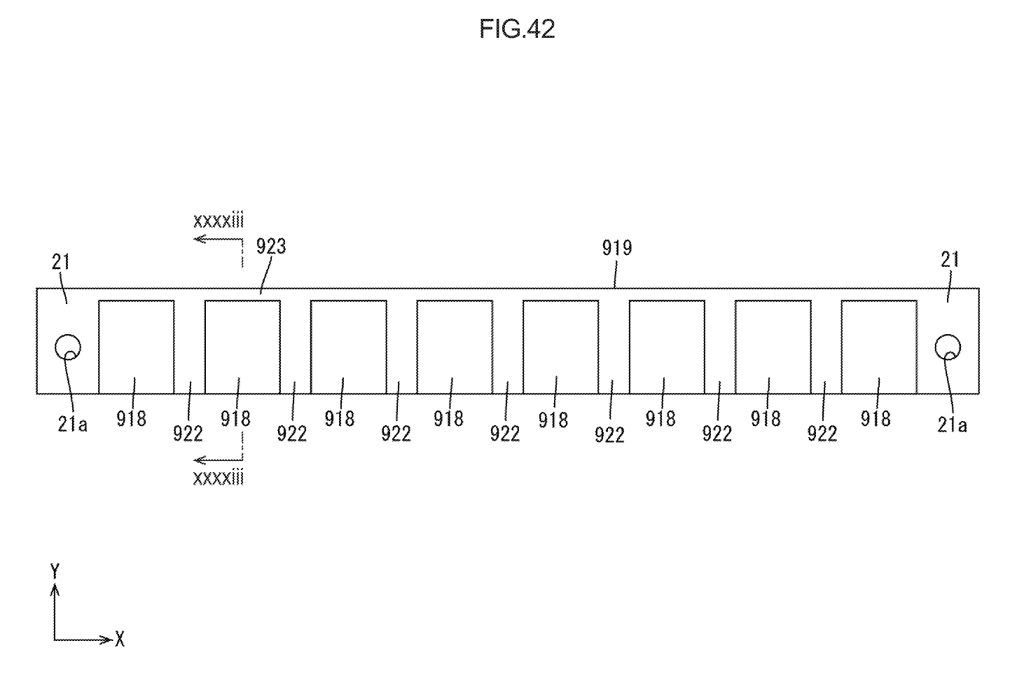

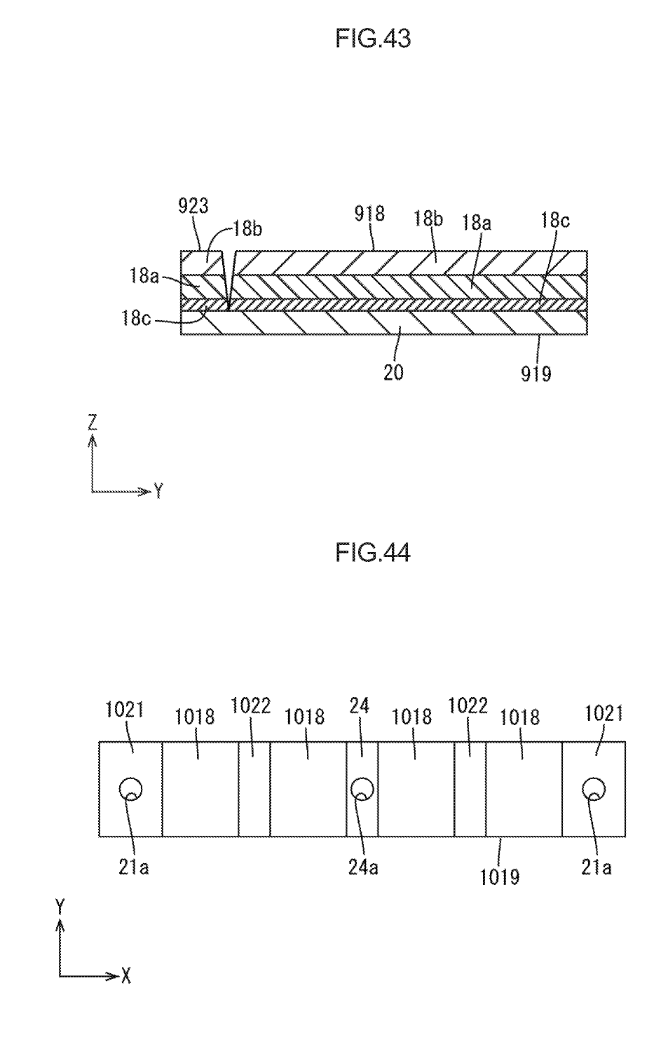

A tenth embodiment of the present invention will be described with reference to FIGS. 42 and 43. The tenth embodiment includes and end surface protecting portions 923 having a configuration different from the ninth embodiment. Configurations, functions, and effects similar to those of the ninth embodiment will not be described.

As illustrated in FIGS. 42 and 43, a polarizing plate component 919 according to this embodiment includes the end surface protecting portion 923 that is disposed over first short end surfaces of polarizing plates 918 among the first short end surfaces and second short end surfaces of the polarizing plates 918. The end surface protecting portion 923 is disposed adjacent to the polarizing plates 918 on the upper side in FIG. 42 and coupled to first short edges of intermediate portions 922. The end surface protecting portions 923 and the intermediate portions 922 are coupled together to form a comb shape as a whole in a plan view. The polarizing plate component 919 having such a configuration is prepared in the polarizing plate component preparing process. Therefore, in an end surface protecting portion and intermediate portion removing process, the end surface protecting portion 923 and the intermediate portions 922 can be collectively removed similar to the ninth embodiment.

### Eleventh Embodiments

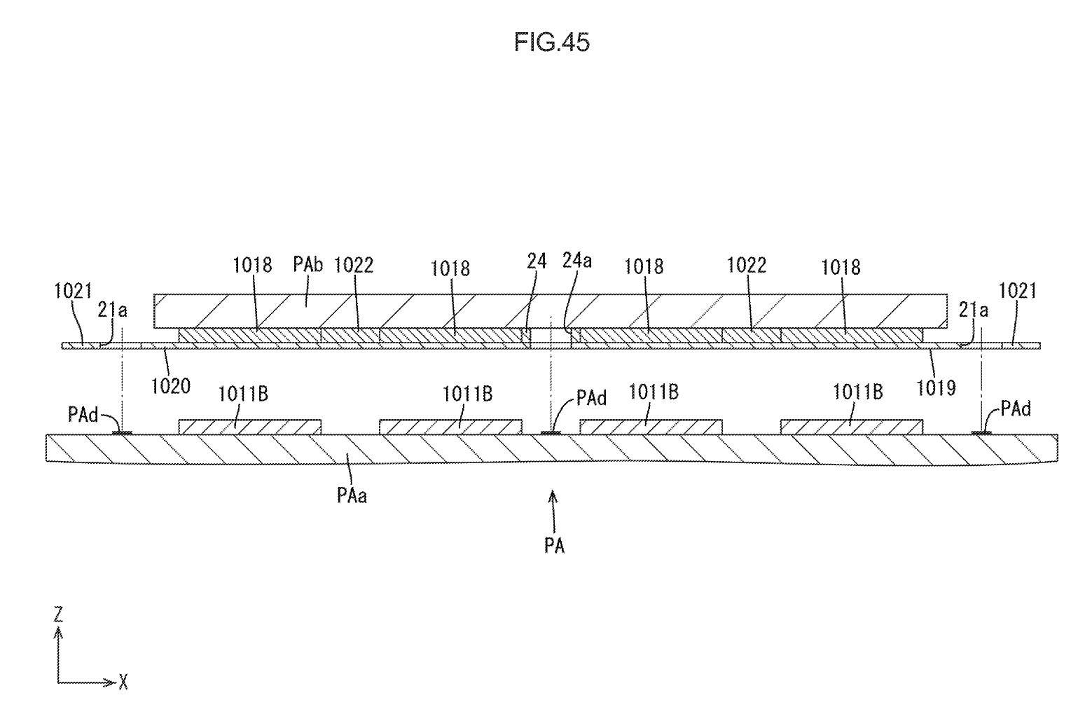

An eleventh embodiment of the present invention will be described with reference to FIGS. 44 and 45. The eleventh embodiment includes a polarizing plate component 1019 having a configuration different from the seventh embodiment. Configurations, functions, and effects similar to those of the seventh embodiment will not be described.

As illustrated in FIG. 44, the polarizing plate component 1019 according to this embodiment is prepared in a polarizing plate component preparing process to include an intermediate positioning portion 24 between adjacent polarizing plates 1018. The intermediate positioning portion 24 is disposed between two polarizing plates 1018 at the middle among four polarizing plates 1918. The intermediate positioning portion 24 is at about the middle of the long dimension of the polarizing plate component 1019 (in an arrangement direction of the polarizing plates 1018). Four polarizing plates 1018 are disposed such that intermediate portions 1022 are provided between the polarizing plates 1018 at ends and the polarizing plates 1018 adjacent to the polarizing plates 1018 at the ends. The intermediate positioning portion 24 has a vertically-long quadrilateral shape in a plan view similar to the polarizing plates 1018. The size of the intermediate positioning portion 24 in the plan view is about equal to that of the intermediate portions 1022. Specifically, the intermediate positioning portion 24 has a long dimension about equal to the long dimension of the polarizing plates 1018 and a short dimension smaller than the short dimension of the polarizing plates 1018 and about equal to the short dimension of the intermediate portions 1022 (e.g., about 5 mm). The intermediate positioning portion 24 includes an intermediate positioning hole 24a that is a through hole at about the middle similar to positioning portions 1021. The intermediate positioning hole 2 4a has a circular shape in the plan view with a diameter of about 2 mm. As illustrated in FIG. 45, the intermediate positioning portion 24 includes a separator layer 1020, a polarizing layer, a laminator layer, and a fixing layer. The intermediate positioning portion 24 has a lamination structure similar to the polarizing plates 1018. The intermediate positioning hole 24a in the intermediate positioning portion 24 runs all the way through the polarizing layer, the laminator layer, the fixing layer, and the separator layer 1020.

A polarizing plate bonding process for the polarizing plate component 1019 having such a configuration and prepared through the polarizing plate component preparing process will be described. As illustrated in FIG. 45, a positioning process for positioning four liquid crystal panel bodies 1011B held with vacuum by the liquid crystal panel vacuum stage PAa through a liquid crystal panel body placing process and the polarizing plate component 1019 held with vacuum by the polarizing plate vacuum stage PAb through a polarizing plate placing process is performed. On the liquid crystal panel vacuum stage PAa, a total of three polarizing plate alignment marks PAa are provided. In the positioning process, the polarizing plate component 1019 is positioned relative to the liquid crystal panel bodies 1011B using the positioning portions 1021 and the intermediate positioning portion 24 of the polarizing plate component 1019 and the polarizing plate alignment marks PAd on the polarizing plate vacuum stage PAb. Therefore, the polarizing plates 1918 in the polarizing plate component 1019 can be collectively bonded to the liquid crystal panel bodies 1011B with higher position accuracy.

As described above, in the polarizing plate component preparing process according to this embodiment, the polarizing plate component 1019 including the intermediate positioning portion 24 disposed between the adjacent polarizing plates 1018 is prepared. In the polarizing plate bonding process, the polarizing plates 1018 are positioned relative to the liquid crystal panel bodies 1011B using two the positioning portions 1021 and the intermediate positioning portion 24. Because the polarizing plates 1018 are positioned relative to the liquid crystal panel bodies 1011B using not only the positioning portions 1021 but also the intermediate positioning portion 24 disposed between the adjacent polarizing plates 1018, the polarizing plates 1018 are collectively bonded with further higher position accuracy in the polarizing plate component preparing process.

### Twelfth Embodiment

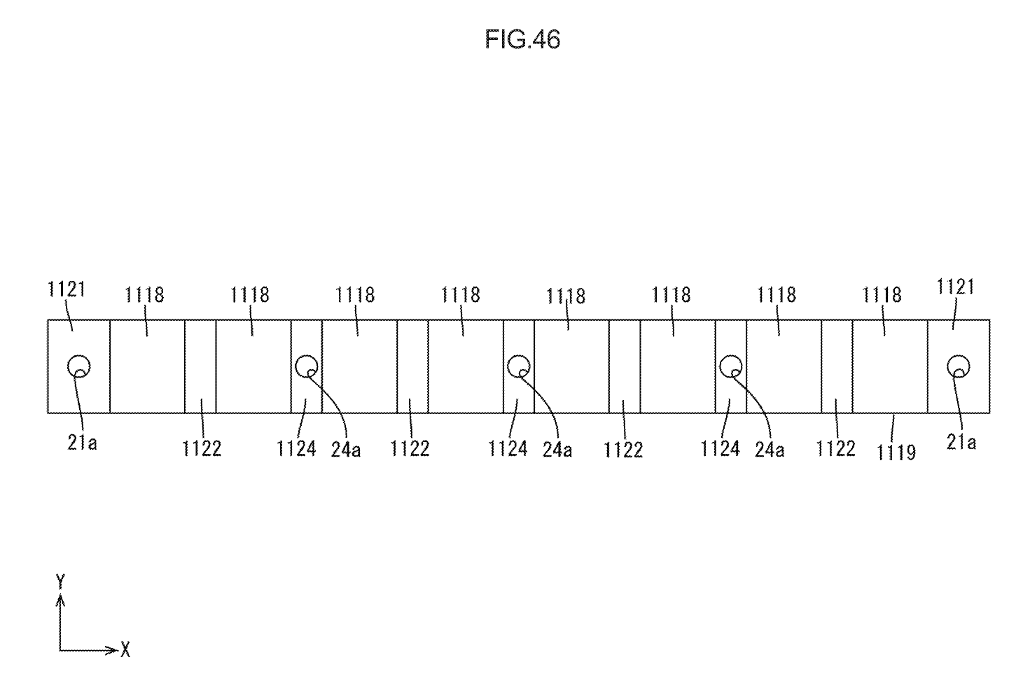

A twelfth embodiment of the present invention will be described with reference to FIG. 46. The twelfth embodiment includes a polarizing plate component 1119 having a configuration different from the eighth embodiment. Configurations, functions, and effects similar to those of the eighth embodiment will not be described.

As illustrated in FIG. 46, the polarizing plate component 1119 according to this embodiment is prepared in a polarizing plate component preparing process to include intermediate positioning portions 1124 disposed between adjacent polarizing plates 1118. Each intermediate positioning portion 1124 has a configuration similar to the eleventh embodiment. One of the intermediate positioning portions 1124 is disposed between two polarizing plates 1118 in the middle. The other two of the intermediate positioning portions 1124 are disposed such that two polarizing plates 1118 are sandwiched between the one of the intermediate positioning portions 1124 at the middle and each of the other two of the intermediate positioning portions 1124. A total of three intermediate positioning portions 1124 are provided. In the polarizing plate component 1119, the intermediate portions 1122 and the intermediate positioning portions 1124 are alternately arranged between the adjacent polarizing plates 1118. The polarizing plate component 1119 that is longer than the eleventh embodiment can be further properly positioned using not only two positioning portions 1121 but also three intermediate positioning portions 1124 that are arranged at equal intervals in the positioning process. Therefore, the polarizing plates 1118 in the polarizing plate component 1119 can be collectively bonded to liquid crystal panel bodies (not illustrated) with further higher position accuracy.

### Thirteenth Embodiment

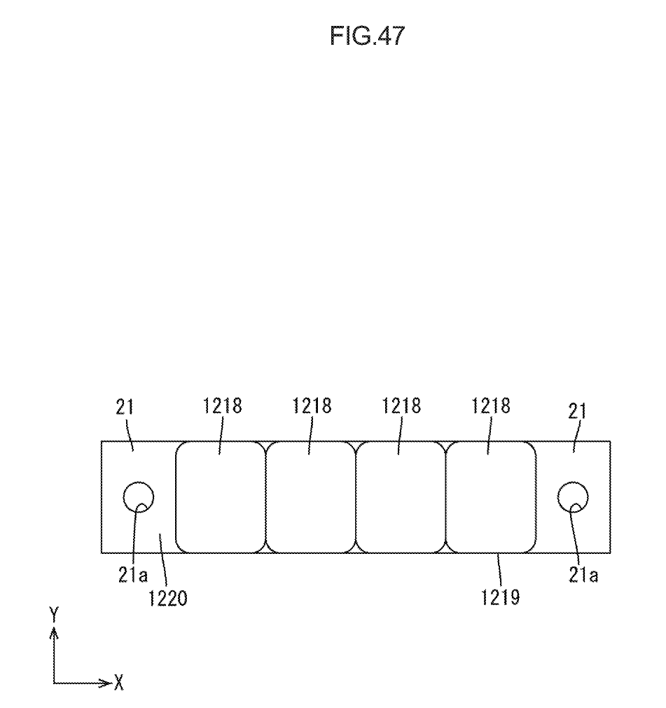

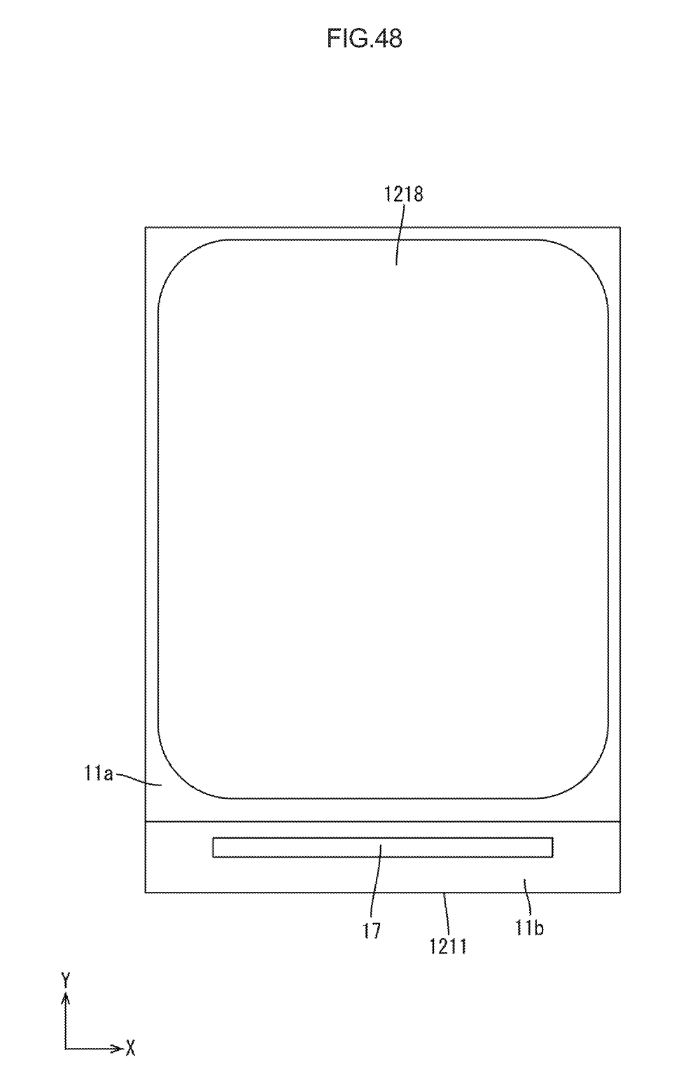

A thirteenth embodiment of the present invention will be described with reference to FIGS. 47 and 48. The thirteenth embodiment includes a polarizing plate component 1219 having a configuration different from the ninth embodiment. Configurations, functions, and effects similar to those of the ninth embodiment will not be described.

As illustrated in FIG. 47, the polarizing plate component 1219 according to this embodiment includes polarizing plates 1218 with rounded corners each having a round shape in a plan view. According to the configuration, in a polarizing plate separating step included in a polarizing plate component preparing process, separation is less likely to occur in the polarizing plates 1218 or air bubbles are less likely to be produced between the polarizing plates 1218 and a separator layer 1220 during cutting a polarizing plate base with a cutter to separate the polarizing plates 1218 from one another. A liquid crystal panel 1211 to which the polarizing plate 1218 having such a configuration is illustrated in FIG. 48.

### Fourteenth Embodiment

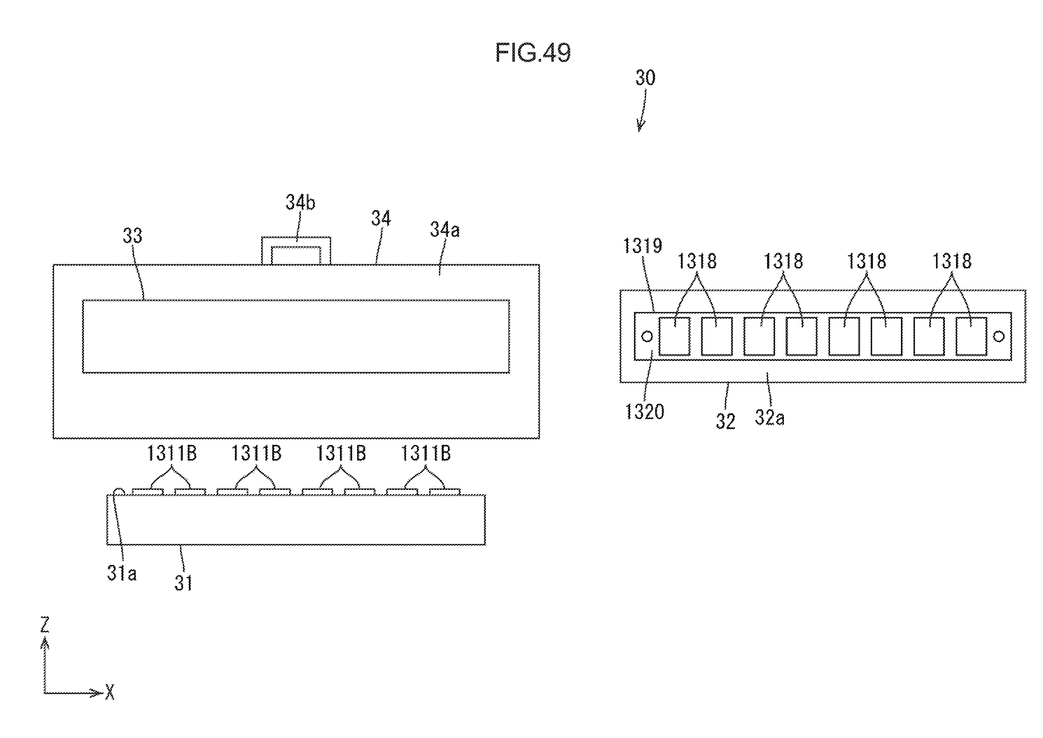

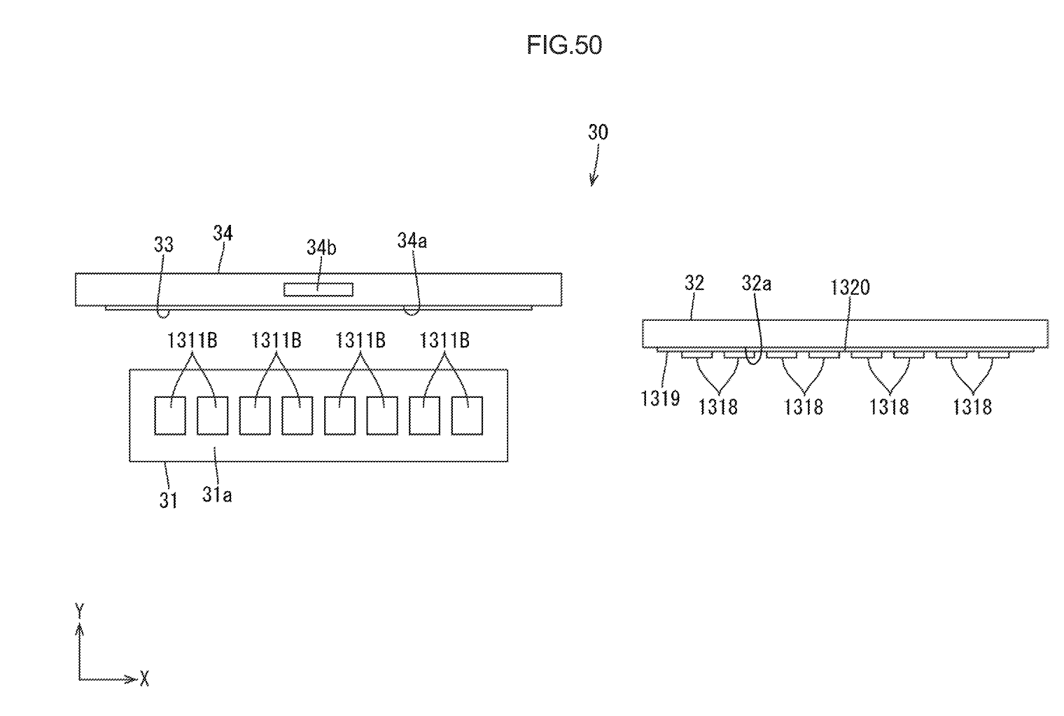

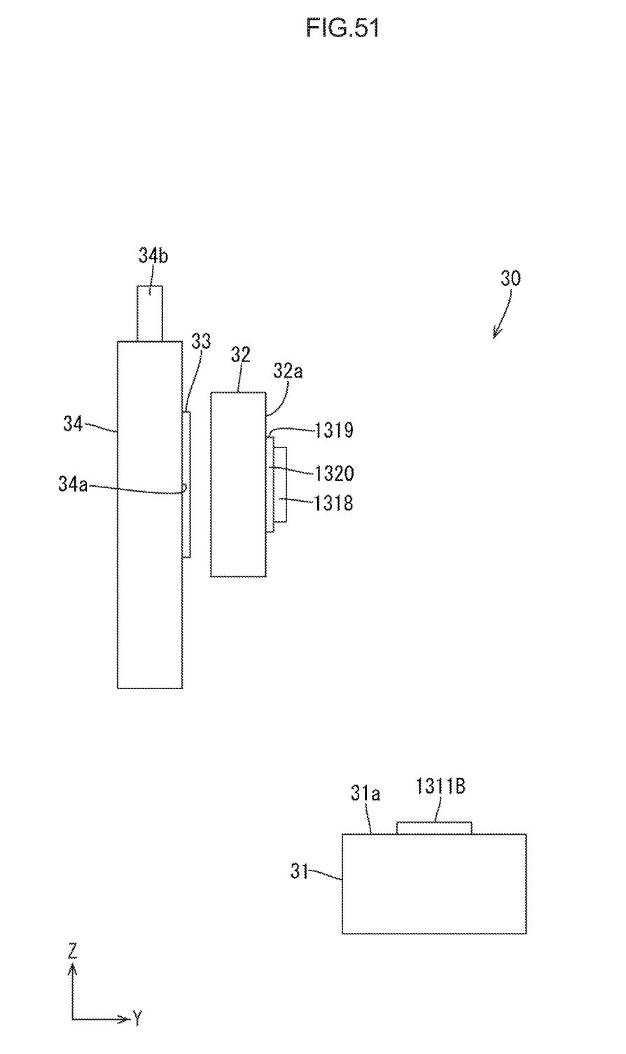

A fourteenth embodiment of the present invention will be described with reference to FIGS. 49 to 55. In the fourteenth embodiment section, a method of producing a liquid crystal panel using a polarizing plate component 1319 similar to the ninth embodiment will be described. Configurations, functions, and effects similar to those of the first and the ninth embodiments will not be described.

A polarizing plate bonding process included in the method of producing a liquid crystal panel according to this embodiment is performed using a polarizing plate bonding device 30 described below. As illustrated in FIGS. 49 to 51, the polarizing plate bonding device 30 includes at least a liquid crystal panel vacuum stage 31, a polarizing plate vacuum stage 32, a transfer sheet 33, and a transfer sheet vacuum stage 34. The liquid crystal panel vacuum stage 31 is configured to hold liquid crystal panel bodies 1311B with vacuum. The polarizing plate vacuum stage 32 is configured to hold the polarizing plate component 1319 with vacuum. The polarizing plate component 1319 includes polarizing plates 1318 fixed to the transfer sheet 33. The transfer sheet vacuum stage 34 is configured to hold the transfer sheet 33 with vacuum. The polarizing plate bonding device 30 is a hand-operated device with which an operator perform various tasks.

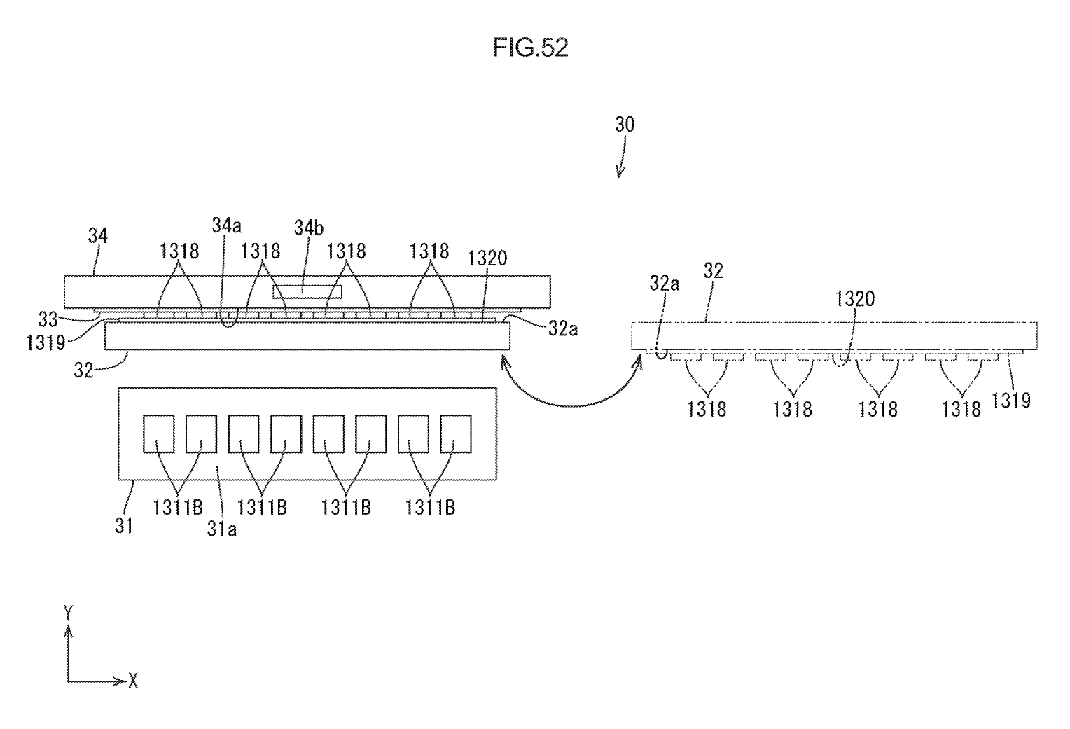

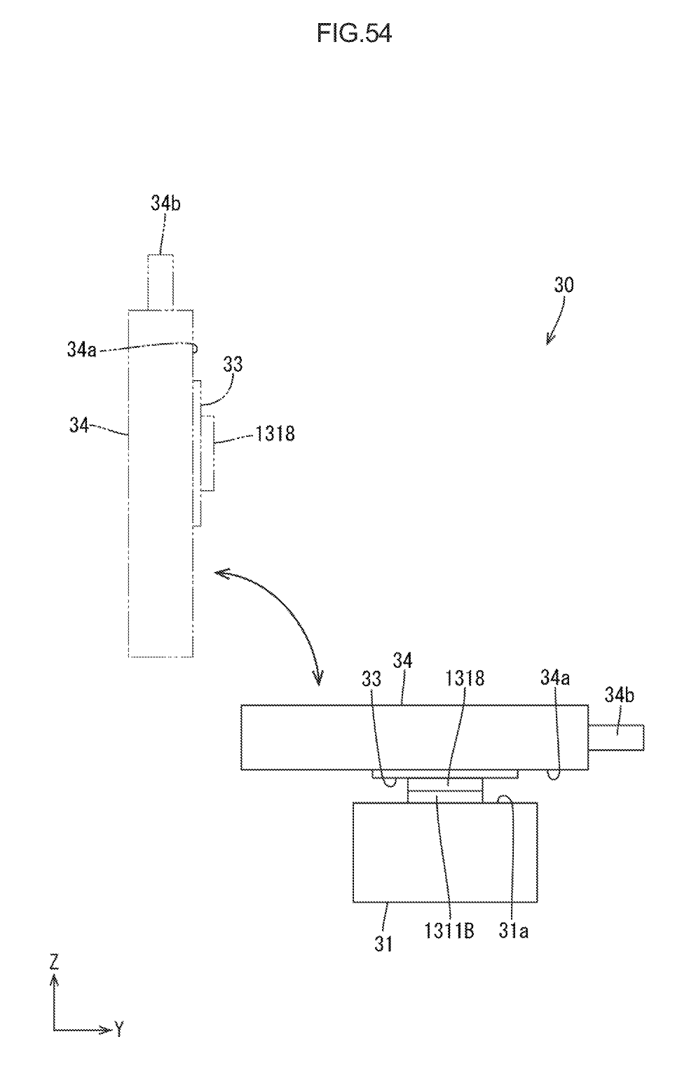

As illustrated in FIGS. 49 to 51, the liquid crystal panel vacuum stage 31 includes a panel vacuum face 31a with which the liquid crystal panel bodies 1311B are vacuum held is parallel to the X-axis direction and the Y-axis direction. On the liquid crystal panel vacuum stage 31, liquid crystal panel alignment marks and polarizing plate alignment marks similar to the first embodiment are provided. The liquid crystal panel alignment marks and the polarizing plate alignment marks are not illustrated. The transfer sheet vacuum stage 34 is supported by a rotary shaft, which is not illustrated, to be rotatable between an initial position and a bonding position (see FIG. 54). The initial position is at which a sheet vacuum face 34a with which the transfer sheet 33 is vacuum held is perpendicular to (crosses) the panel vacuum face 31a with which the liquid crystal panel bodies 1311B are vacuum held. The bonding position is at which the sheet vacuum face 34a is parallel to and opposed to the panel vacuum face 31a. The rotary shaft related to the transfer sheet vacuum stage 34 is disposed with an axis parallel to the X-axis direction. The transfer sheet vacuum stage 34 includes a handle 34b with which the operator performs rotary operation. The transfer sheet 33 held with vacuum by the transfer sheet vacuum stage 34 includes a base and an adhesive applied to a surface of the base on an opposite side from a surface to be attached to the transfer sheet vacuum stage 34. The polarizing plate vacuum stage 32 is supported by a rotary shaft to be rotatable between an initial position and a transfer position (see FIG. 52). The initial position is at which the polarizing plate vacuum stage 32 is adjacent to the liquid crystal panel vacuum stage 31 and the transfer sheet vacuum stage 34 with respect to the X-axis direction. The transfer position is at which the polarizing plate vacuum face 32a that holds the polarizing plate component 1319 with vacuum is parallel to and opposed to the sheet vacuum face 34a of the transfer sheet vacuum stage 34 at the initial position. The rotary shaft related to the polarizing plate vacuum stage 32 is disposed with an axis parallel to the Z-axis direction.

A polarizing plate bonding process according to this embodiment will be described. The polarizing plate bonding process includes at least a liquid panel body placing step similar to the first embodiment, a polarizing plate placing step, a positioning step, an end surface protecting portion and intermediate portion removing step similar to the ninth embodiment, a transfer sheet placing step, a transfer step, a separator removing step, and a bonding step. The transfer sheet placing step is for vacuuming the transfer sheet 33 with the transfer sheet vacuum stage 34. The transfer step is for transferring the polarizing plate component 1319 onto the transfer sheet 33. The separator removing step is for removing a separator layer 1320 of the polarizing plate component 1319. The bonding step is for bonding polarizing plates 1318 to liquid crystal panel bodies 1311B. The liquid crystal panel body placing step, the polarizing plate placing step, the positioning step, and the end surface protecting portion and intermediate portion removing step will not be described in detail.

In the transfer sheet placing step, the transfer sheet 33 is vacuumed and held with the transfer sheet vacuum stage 34. In the transfer step, the polarizing plate vacuum stage 32 holding the polarizing plate component 1319 with vacuum is rotated from the initial position to the transfer position. As illustrated in FIG. 52, the polarizing plate vacuum stage 32 is opposed to the transfer sheet vacuum stage 34 at the initial position and laminator layers (not illustrated) of the polarizing plates 1318 in the polarizing plate component 1319 are fixed to the transfer sheet 33 that is held with vacuum by the transfer sheet vacuum stage 34. When the polarizing plate vacuum stage 32 is returned from the transfer position to the initial position, the polarizing plate component 1319 is transferred onto the transfer sheet 33. In FIG. 52, the polarizing plate component 1319 before being transferred and the polarizing plate vacuum stage 32 are indicated by two-dot chain lines.

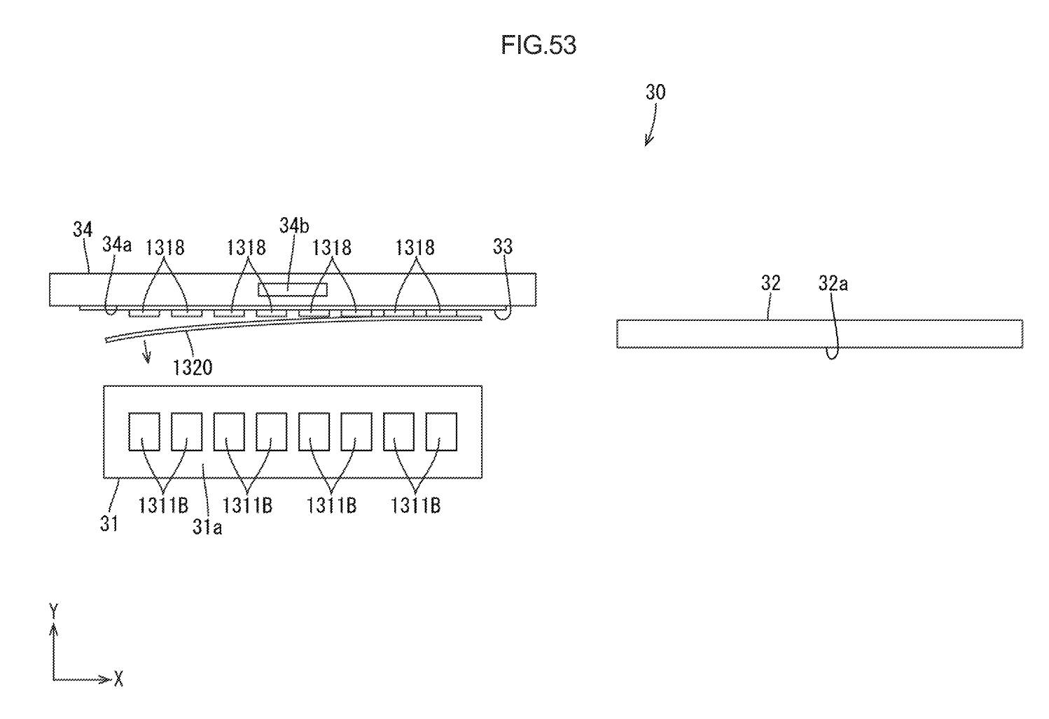

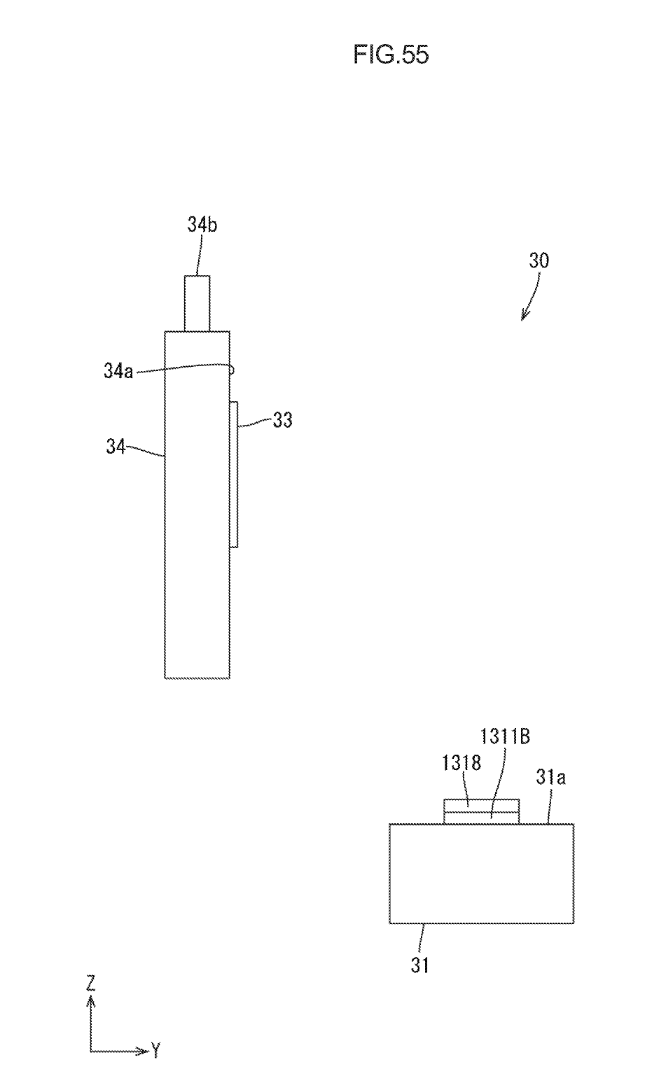

As illustrated in FIG. 53, in the separator removing step, the separator layer 1320 of the polarizing plate component 1319 on the transfer sheet 33 is removed from the polarizing plates 1318. The polarizing plates 1318 from which the separator layer 1320 is removed remain fixed to the transfer sheet 33 and held. In the bonding step, the transfer sheet vacuum stage 34 is rotated from the initial position to the bonding position. As illustrated in FIG. 54, the transfer sheet vacuum stage 34 is opposed to the liquid crystal panel vacuum stage 31 and fixing layers (not illustrated) of the polarizing plates 1318 on the transfer sheet 33 are collectively bonded to the liquid crystal panel bodies 1311B. When the transfer sheet vacuum stage 34 is returned from the bonding position to the initial position, the transfer sheet 33 is removed from the polarizing plates 1318 and the polarizing plates 1318 remain bonded to the liquid crystal panel bodies 1311B as illustrated in FIG. 55.

### Fifteenth Embodiment

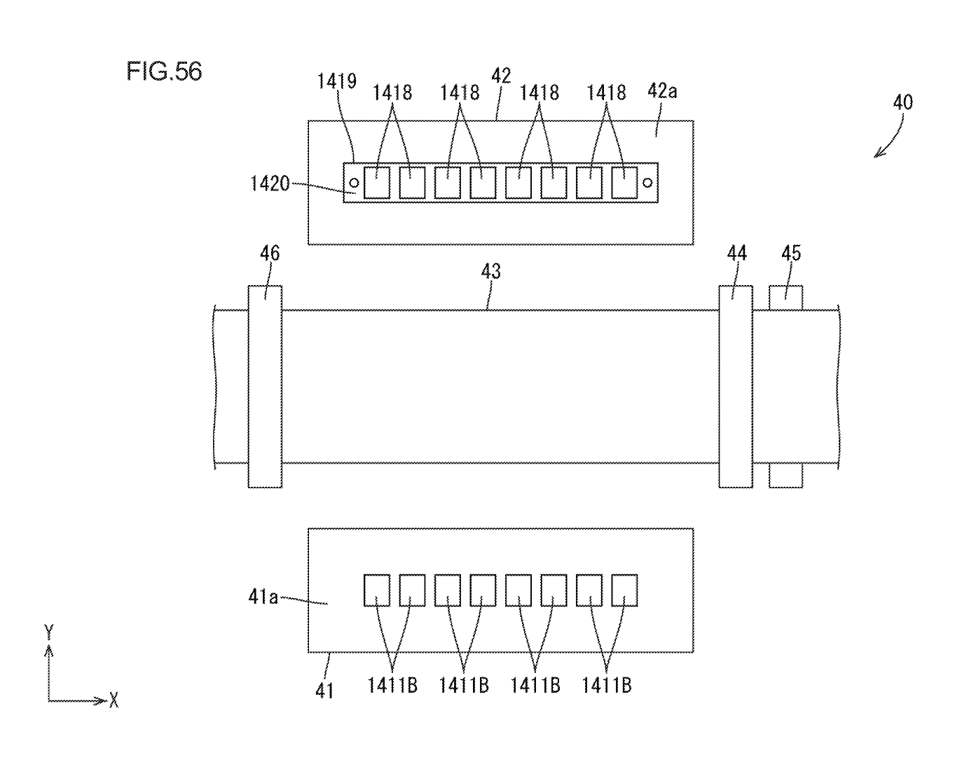

A fifteenth embodiment of the present invention will be described with reference to FIGS. 56 to 64. In the thirteenth embodiment section, a method of producing a liquid crystal panel using a polarizing film component 1419 similar to the ninth embodiment will be described. Configurations, functions, and effects similar to those of the first and the ninth embodiments will not be described.

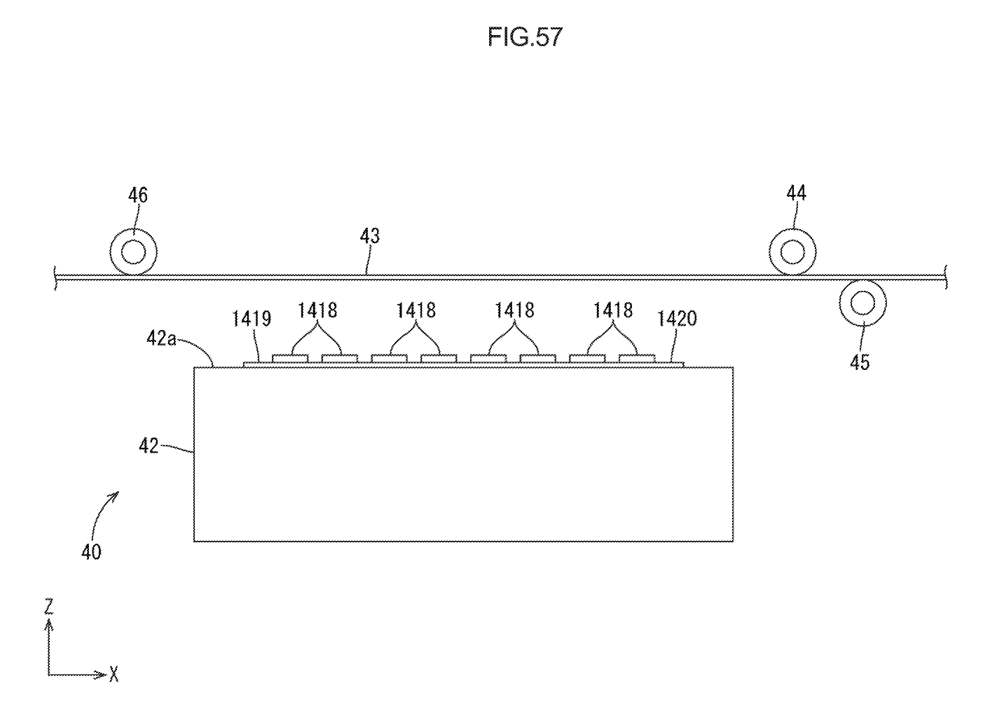

The polarizing plate bonding process includes in the method of producing a liquid crystal panel according to this embodiment is performed using a polarizing plate bonding device 40 described below. As illustrated in FIGS. 56 and 57, the polarizing plate bonding device 40 includes a liquid crystal panel vacuum stage 41, a polarizing plate vacuum stage 42, a transfer sheet 43, a transfer roller 44, a remover roller 45, and a bonding roller 46. The liquid crystal panel vacuum stage 41 is configured to hold liquid crystal panel bodies 1411 with vacuum. The polarizing plate vacuum stage 42 is configured to hold a polarizing plate component 1419 with vacuum. Polarizing plates 1418 included in the polarizing plate component 1419 are fixed to the transfer sheet 43. The transfer roller 44 is for transferring the polarizing plates 1418 onto the transfer sheet 43. The remover roller 45 is for removing a separator 1420 from the polarizing plates 1418. The bonding roller 46 is for bonding the polarizing plates 1418 on the transfer sheet 43 to the liquid crystal panels 1411B. The polarizing plate bonding device 40 is an automated device that is automatically operable with almost no human operation.

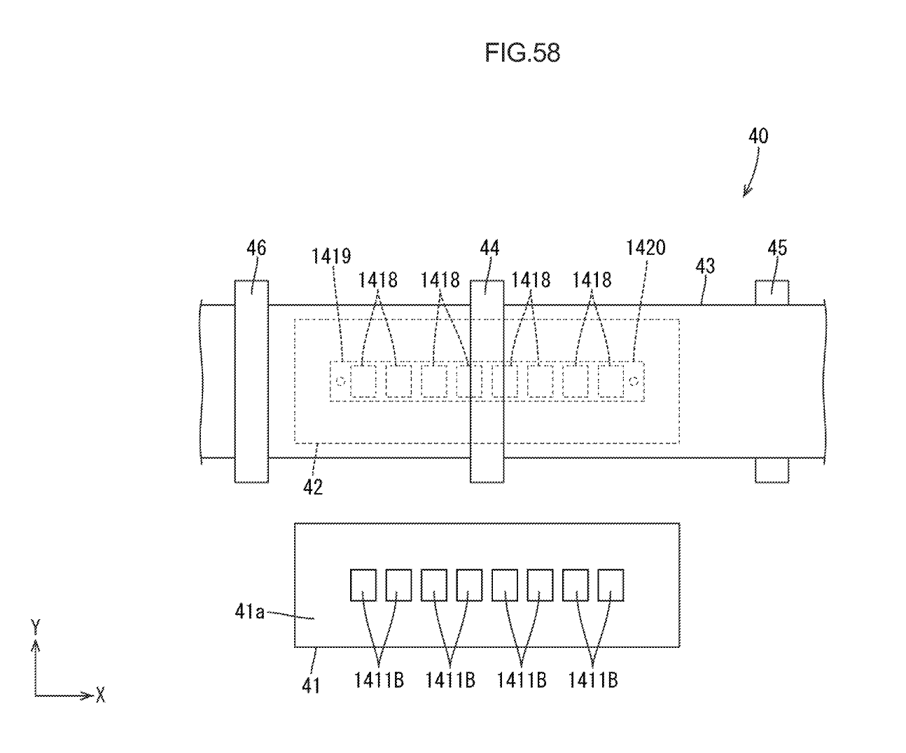

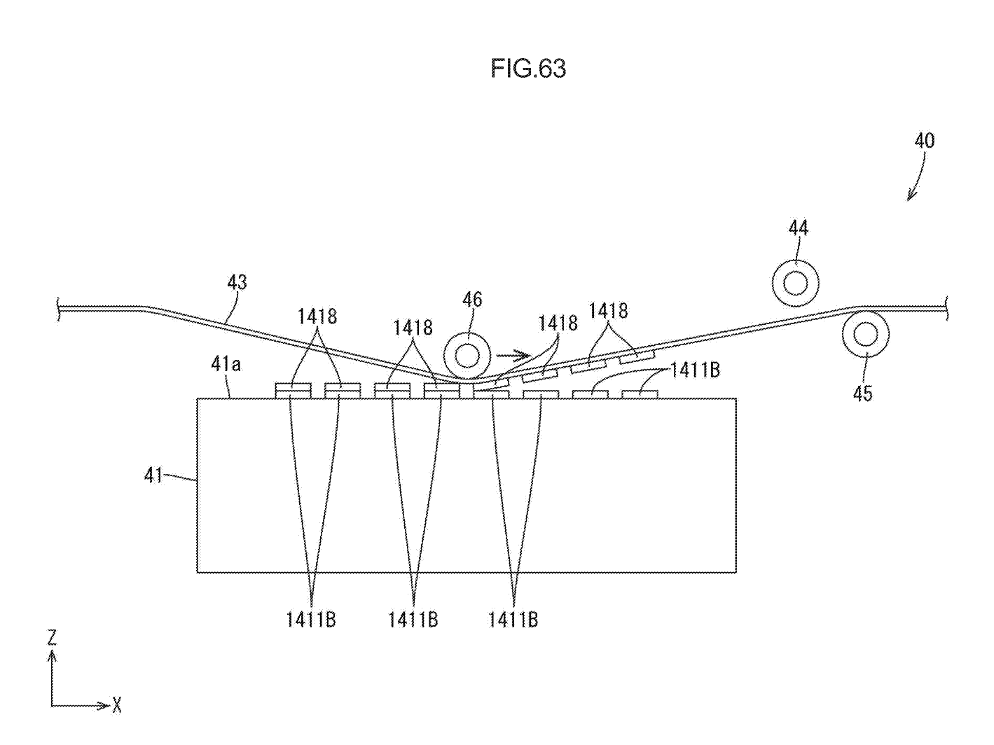

As illustrated in FIGS. 56 and 57, the liquid crystal panel vacuum stage 41 and the polarizing plate vacuum stage 42 are disposed such that a panel vacuum face 41a for holding the liquid crystal panel bodies 1411B with vacuum and a polarizing plate vacuum face 42a for holding the polarizing plate component 1419 with vacuum are parallel to each other with respect to the X-axis direction and the Y-axis direction. The liquid crystal panel vacuum stage 41 and the polarizing plate vacuum stage 42 are movable between a non-overlapping position (an initial position) and an overlapping position (a transfer positon or a bonding position, see FIGS. 58 and 63) along the Y-axis direction. At the non-overlapping position, the liquid crystal panel vacuum stage 41 and the polarizing plate vacuum stage 42 are adjacent to the transfer sheet 43 with respect to the Y-axis direction so as not to overlap. At the overlapping position, the liquid crystal panel vacuum stage 41 and the polarizing plate vacuum stage 42 overlap the transfer sheet 43. In FIG. 56, the liquid crystal panel vacuum stage 41 at the non-overlapping position is located below the transfer sheet 43 and the polarizing plate vacuum stage 42 at the non-overlapping position is located above the transfer sheet 43. Although not illustrated, liquid panel alignment marks and polarizing plate alignment marks similar to the first embodiment are provided on the liquid crystal panel vacuum stage 41. The transfer sheet 43 is held by a holding member, which is not illustrated, to be separated from the liquid crystal panel vacuum stage 41 and the polarizing plate vacuum stage 42 on an upper side with respect to the Z-axis direction. The transfer sheet 43 is held in a position with a sheet surface of the transfer sheet 43 parallel to the X-axis direction and the Y-axis direction (the panel vacuum face 41a and the polarizing plate vacuum face 42a). Similar to the transfer sheet in the fourteenth embodiment, the transfer sheet 43 includes one sheet surface (on a liquid crystal panel vacuum stage 41 side, a polarizing plate vacuum stage 42 side) to which an adhesive is applied. The transfer roller 44 and the bonding roller 46 are disposed on an opposite side from the liquid crystal panel vacuum stage 41 and the polarizing plate vacuum stage 42 relative to the transfer sheet 43 (on the upper side in FIG. 56). The remover roller 45 is disposed on a liquid crystal panel vacuum stage 41 side or a polarizing plate vacuum stage 42 side relative to the transfer sheet 43. The rollers 44 to 46 are rotatable about axes parallel to the Y-axis direction. The rollers 44 to 46 are movable along the X-axis direction from initial positions at which the rollers 44 to 46 are adjacent to the liquid crystal panel vacuum stage 41 and the polarizing plate vacuum stage 42 with respect to the X-axis direction to positions to overlap the liquid crystal panel vacuum stage 41 and the polarizing plate vacuum stage 42. The transfer roller 44 and the bonding roller 46 are movable from the initial positions to approach the liquid crystal panel vacuum stage 41 and the polarizing plate vacuum stage 42 with respect to the Z-axis direction. An adhesive is applied to a surface of the remover roller 45.

A polarizing plate bonding process according to this embodiment will be described. The polarizing plate bonding process includes at least a liquid crystal panel body placing step, a polarizing plate placing step, a positioning step, an end surface protecting portion and intermediate portion removing step, which are similar to those of the fourteenth embodiment (the first and the ninth embodiments), a transfer sheet, placing step, a transfer step, a separator removing step, and a bonding step. The transfer sheet placing step is for placing the transfer sheet 43. The transfer step is for transferring the polarizing plate component 1419 onto the transfer sheet 43. The separator removing step is for removing a separator layer 1420 of the polarizing plate component 1419. The bonding step is for bonding polarizing plates 1418 to liquid crystal panel bodies 1411B. The liquid crystal panel body placing step, the polarizing plate placing step, the positioning step, and the end surface protecting portion and intermediate portion removing step will not be described in detail.

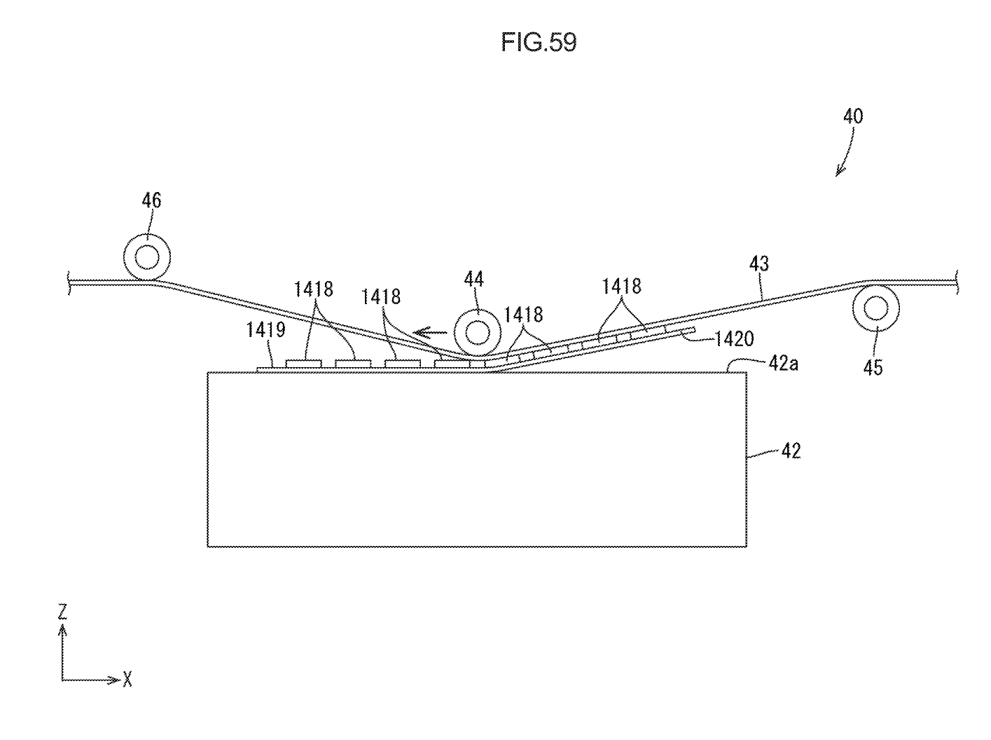

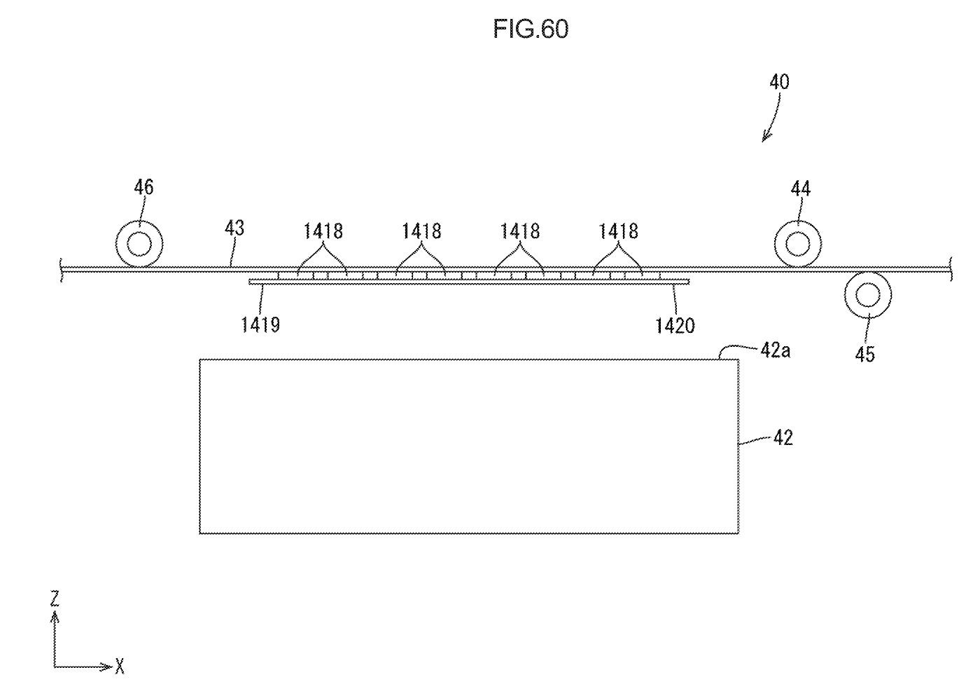

As illustrated in FIGS. 56 and 57, in the transfer sheet placing step, the transfer sheet 43 is held by the holding member, which is not illustrated, at a position away from the liquid crystal panel vacuum stage 41 and the polarizing plate vacuum stage 42 in the Z-axis direction on the upper side. In the transfer step, the polarizing plate vacuum stage 42 that holds the polarizing plate component 1419 with vacuum is moved from the overlapping position to the overlapping position along the Y-axis direction. Then, the transfer roller 44 is moved from the initial position in the X-axis direction and the Z-axis direction with rolling motion. As illustrated in FIGS. 58 and 59, sections of the transfer sheet 43 pressed by the transfer roller 44 are deformed to approach the polarizing plate vacuum stage 42 and a pressure is applied to the polarizing plate component 1419 held with vacuum by the polarizing plate vacuum stage 42. Laminator layers (not illustrated) of the polarizing plates 1418 in the polarizing plate component 1419 are fixed to the pressed sections of the transfer sheet 43. In conjunction with the movement of the transfer roller 44, the polarizing plate component 1419 is gradually released from the polarizing plate vacuum stage 42 and thus sections of the polarizing plate component 1419 fixed to the transfer sheet and released from the polarizing plate vacuum stage 42 are displaced in the Z-axis direction along with the transfer sheet 43. When crossing of the transfer roller 44 across the polarizing plate component 1419 with respect to the X-axis direction is complete, all the polarizing plates 1418 are transferred onto the transfer sheet 43 as illustrated in FIG. 60. When the transfer operation is complete, the transfer roller 43 is returned to the initial position.

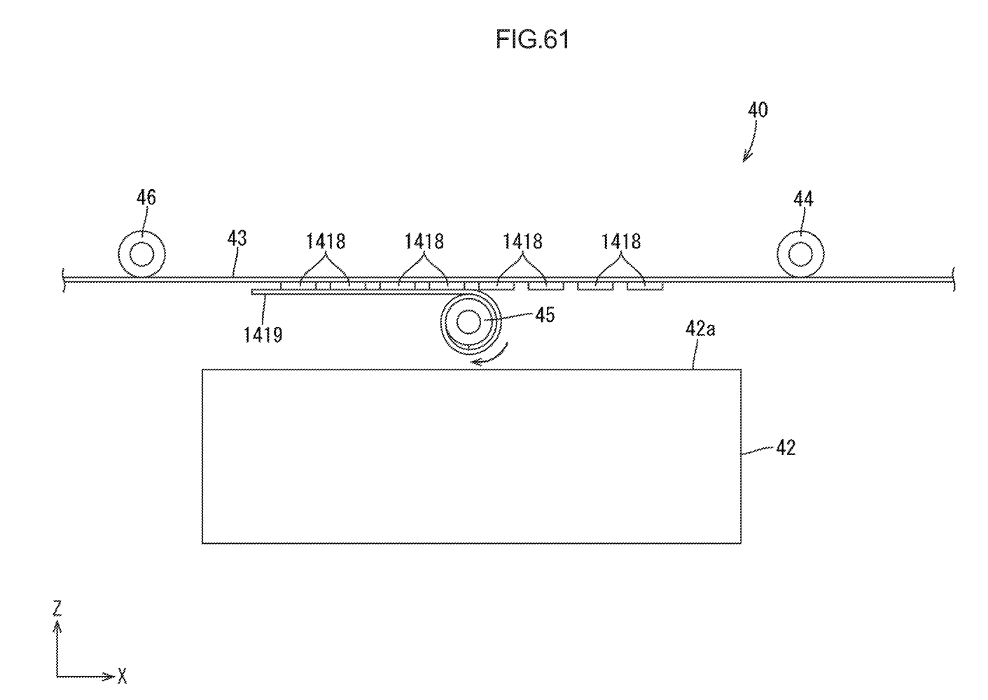

In the separator removing step, the remover roller 45 is moved along the X-axis direction from the initial position with rolling motion. As illustrated in FIG. 61, the adhesive on the surface of the remover roller 45 adheres to the separator layer 1420 of the polarizing plate component 1419 on the transfer sheet 43 and the separator layer 1420 is removed from the polarizing plates 1418 in sequence. The remover roller 45 rolls up the removed separator layer 1420. When movement of the remover roller 45 all the way across the polarizing plate component 1419 in the X-axis direction is complete, the separator layer 1420 is completely removed from the polarizing plates 1419 and the polarizing plates 1419 remain fixed to the transfer sheet 43 and held.

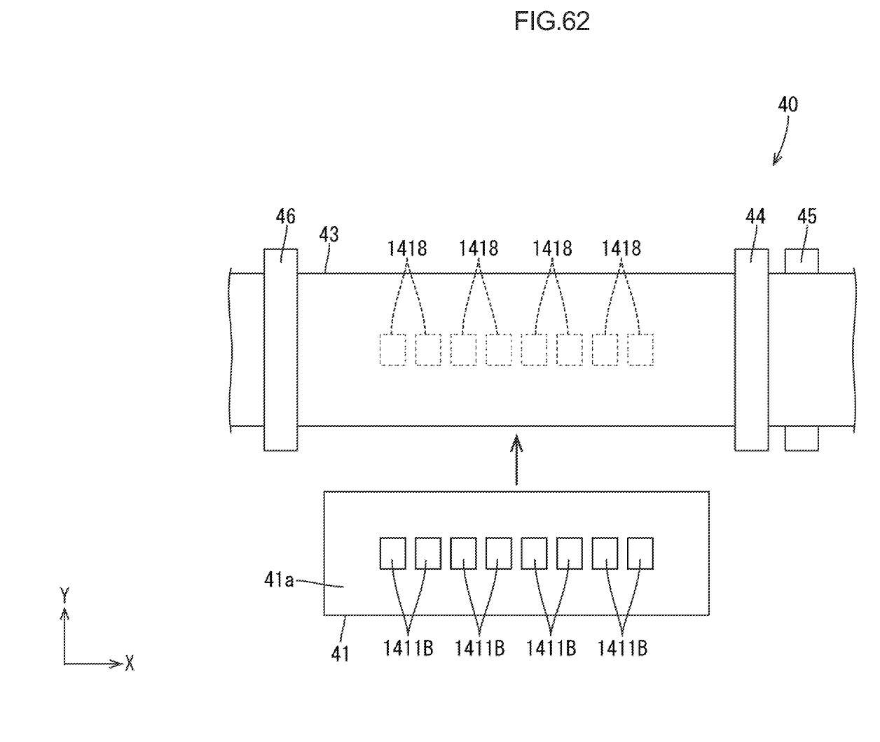

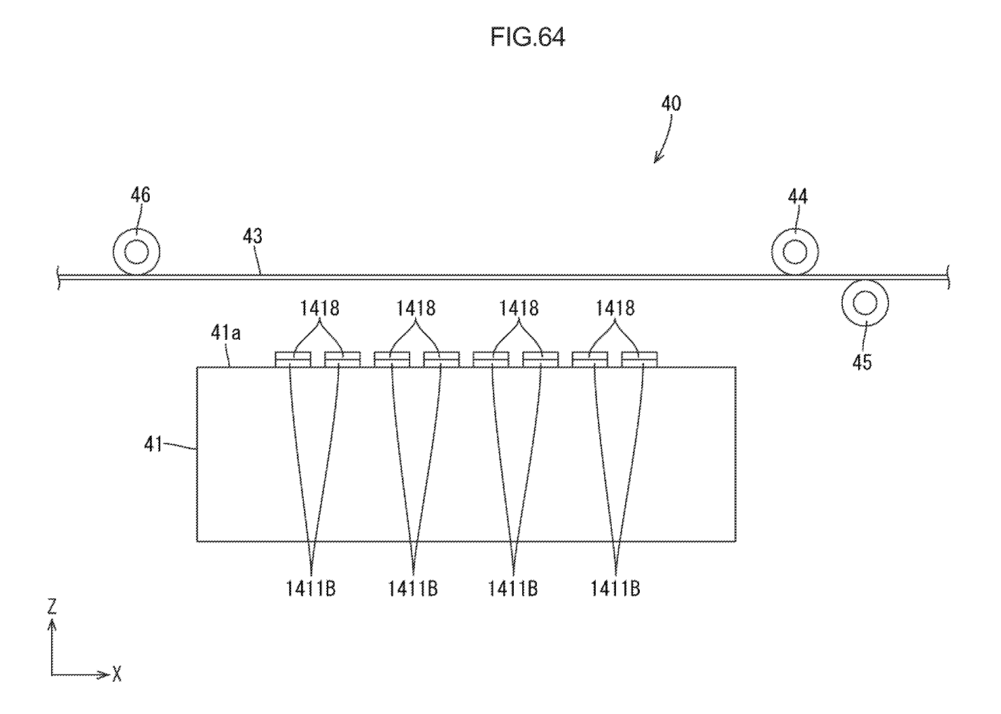

As illustrated in FIG. 62, in the bonding step, the liquid crystal panel vacuum stage 41 is moved from the non-overlapping position to the overlapping position along the Y-axis direction. Prior to the separator removing step, a positioning step may be performed to move the liquid crystal panel vacuum stage 41 to the overlapping position and position the liquid crystal panel bodies 1411B relative to the polarizing plate component 1419. After the liquid crystal panel vacuum stage 41 reaches the overlapping position, the bonding roller 46 is moved from the initial position in the X-axis direction and the Z-axis direction with rolling motion. As illustrated in FIG. 63, sections of the transfer sheet 43 pressed by the bonding roller 46 are deformed to approach the liquid crystal panel vacuum stage 41 and pressures are applied to the liquid crystal panel bodies 1411B held with vacuum by the liquid crystal panel vacuum stage 41. Fixing layers (not illustrated) of the polarizing plates 1419 under pressure are fixed to the liquid crystal panel bodies 1411B. When the deformed sections of the transfer sheet 43 recover from the deformation along the movement of the bonding roller 46, the polarizing plates 1418 are removed from the sections. The polarizing plates 1418 removed from the transfer sheet 43 remain fixed to the liquid crystal panel bodies 1411B. When the movement of the bonding roller 46 all the way across the liquid crystal panel bodies 1411B in the X-axis direction is complete, all the polarizing plates 1418 are bonded to the liquid crystal panel bodies 1411B as illustrated in FIG. 64.

### Other Embodiments

The present invention is not limited to the above embodiments described in the above sections and the drawings. For example, the following embodiments may be included in technical scopes of the present invention.

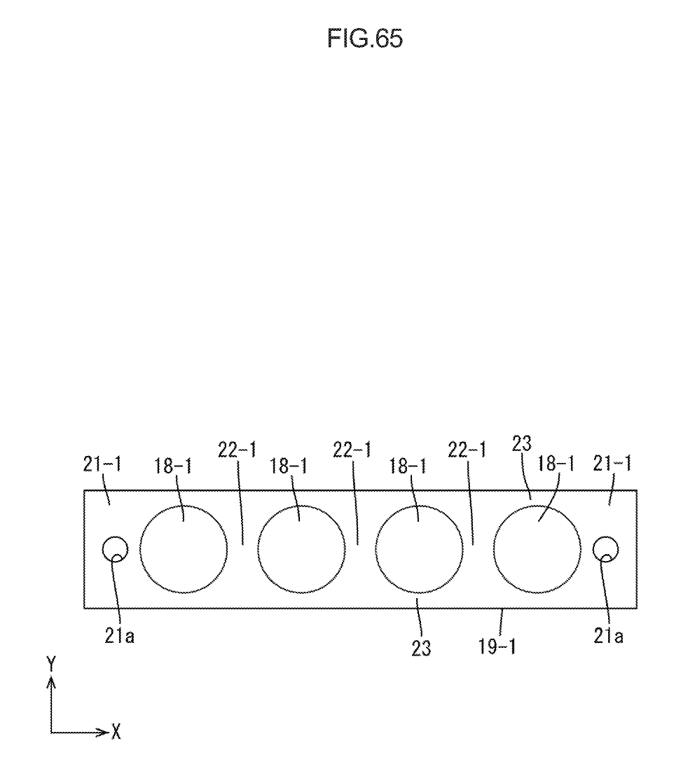

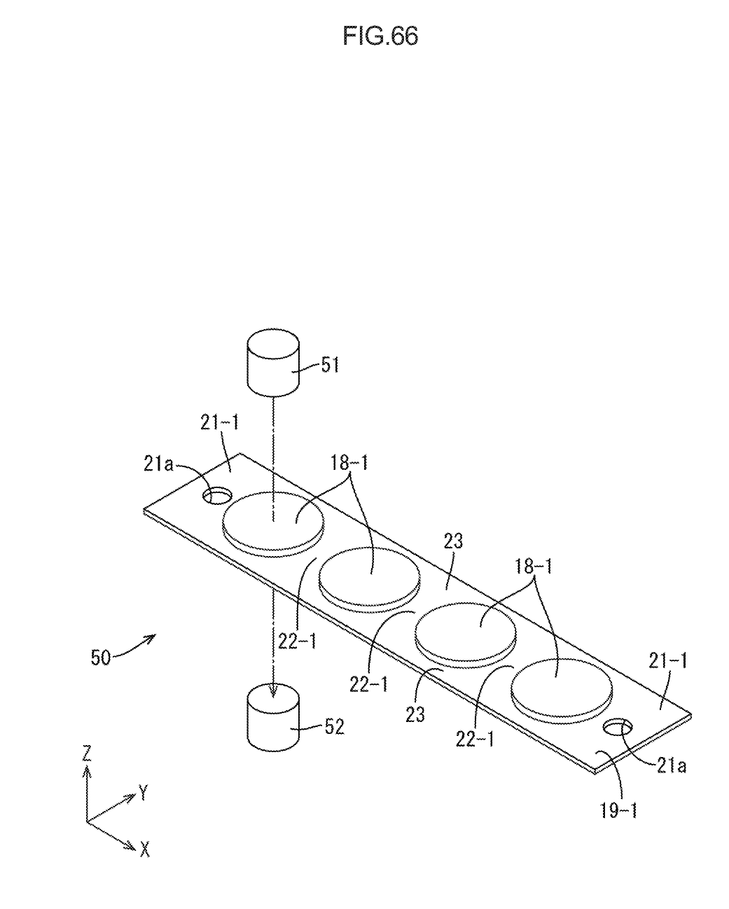

(1) A modification of the ninth embodiment may include a polarizing plate component that may include polarizing plates with a two-dimensional shape different from that of the ninth embodiment. As illustrated in FIG. 65, polarizing plates 18-1 may have a round two-dimensional shape. Because the polarizing plates 18-1 have the different two-dimensional shape, intermediate portions 22-1 have a two-dimensional shape that widens toward ends with respect to the Y-axis direction. In a polarizing plate bonding process of bonding the polarizing plates 18-1 having such a round shape to liquid crystal panel bodies, which are not illustrated, it is preferable to perform positioning with respect to the X-axis direction and the Y-axis direction (along plate surfaces of the polarizing plates 18-1) using two positioning portions 21-1 and positioning with respect to a direction about an axis that extends in a normal direction to the plate surfaces of the polarizing plates 18-1 which corresponds with the Z-axis direction (hereinafter referred to as the θ direction). Specifically, a polarization axis detection device 50 is used to detect polarization axes of the polarizing plates 18-1 as illustrated in FIG. 66. The polarization axis detection device 50 includes at least a light application portion 51 for applying light to the polarizing plates 18-1 and a light receiving portion 52 for receiving light passed through the polarizing plates 18-1. The light application portion 51 and the light receiving portion 52 are disposed to sandwich each polarizing plate 18-1 with respect to the Z-axis direction (the axial direction). Liquid crystal panel bodies to which the polarizing plates 18-1 are bonded are not illustrated in FIG. 66. The polarization axis of each polarizing plate 18-1 is detected based on an amount of light passed through the polarizing plate 18-1 and received by the light receiving portion 52 or a waveform related to the transmitted light. With the detection, positioning of the polarizing plate 18-1 with respect to the θ direction can be optimized. Therefore, the polarizing plate 18-1 that is positioned with respect to the θ direction with high accuracy is bonded to the liquid crystal panel body and thus a liquid crystal panel has sufficiently high contrast in display images. In FIGS. 65 and 66, the polarizing plate component 19-1 including four polarizing plates 18-1 is illustrated.

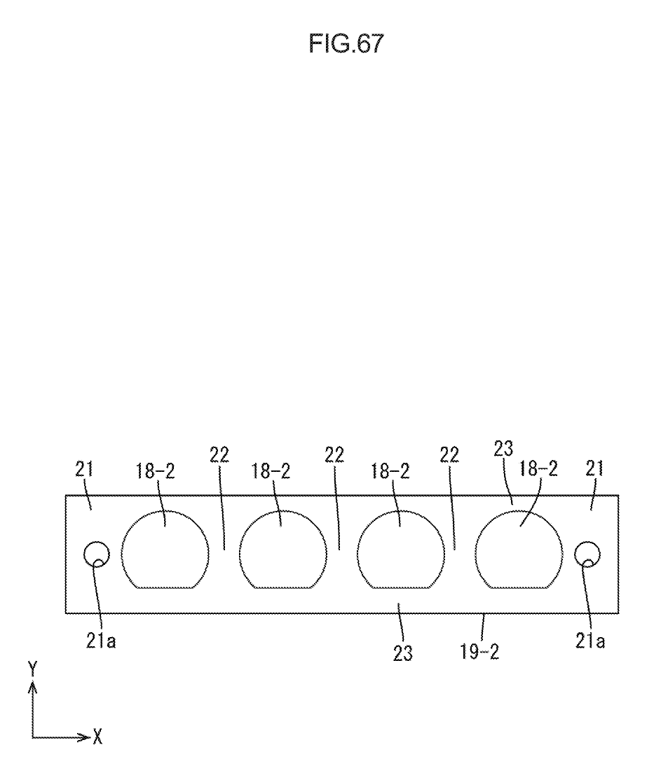

(2) A modification of the ninth embodiment may include a polarizing plate component that may include polarizing plates with a two-dimensional shape different from that of the modification described in (1). As illustrated in FIG. 67, polarizing plates 18-2 may have a round two-dimensional shape with a cutoff. An overall shape of each light polarizing plate 18-2 is circular; however, the polarizing plate 18-2 has an edge at one of ends with respect to the Y-axis direction as if a section of a disk is cut off. Such a polarizing plate 18-2 may be positioned with respect to the θ direction using the polarization axis detection device in the same manner as in (1) described above (see FIG. 66). In FIG. 67, the polarizing plate component 19-2 including four polarizing plates 18-2 is illustrated.

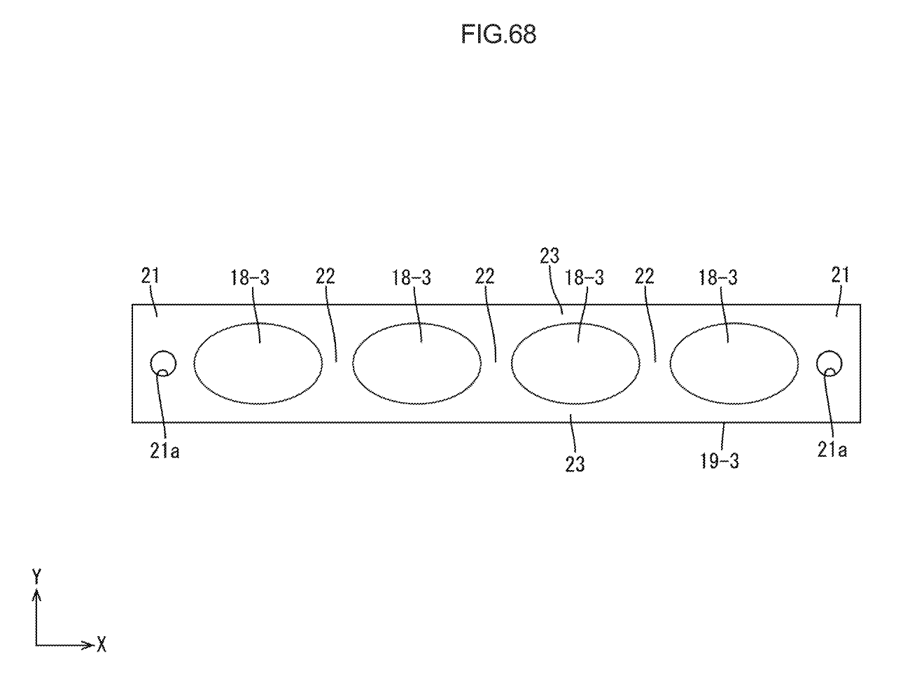

(3) A modification of the ninth embodiment may include a polarizing plate component that may include polarizing plates with a two-dimensional shape different from those of the modifications described in (1) and (2). As illustrated in FIG. 68, polarizing plates 18-3 may have a horizontally-long oval two-dimensional shape. Such a polarizing plate 18-3 may be positioned with respect to the θ direction using the polarization axis detection device in the same manner as in (1) described above (see FIG. 66). In FIG. 68, the polarizing plate component 19-3 including four polarizing plates 18-3 is illustrated.

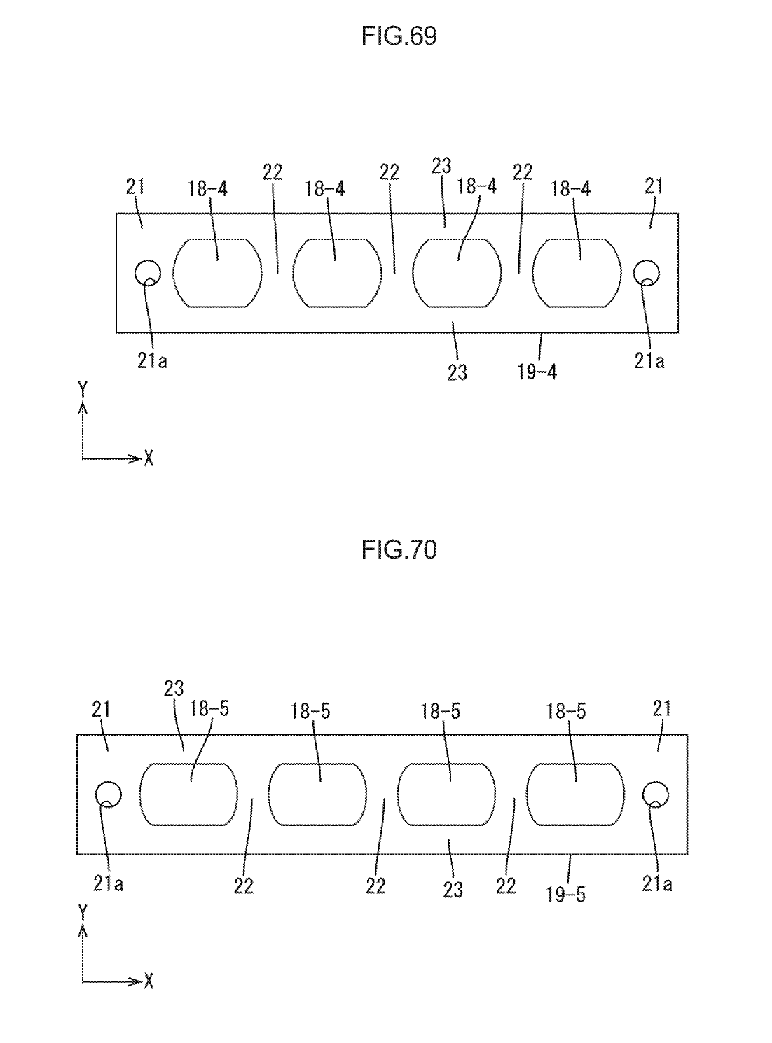

(4) A modification of the ninth embodiment may include a polarizing plate component that may include polarizing plates with a two-dimensional shape different from those of the modifications described in (1) to (3). As illustrated in FIG. 69, polarizing plates 18-4 may have a round two-dimensional shape with cutoffs at ends with respect to the Y-axis direction. Such a polarizing plate 18-4 may be positioned with respect to the θ direction using the polarization axis detection device in the same manner as in (1) described above (see FIG. 66). In FIG. 69, the polarizing plate component 19-4 including four polarizing plates 18-4 is illustrated.

(5) A modification of the ninth embodiment may include a polarizing plate component that may include polarizing plates with a two-dimensional shape different from those of the modifications described in (1) to (4). As illustrated in FIG. 70, polarizing plates 18-5 may have a horizontally-long rectangular two-dimensional shape with curved short edges. Such a polarizing plate 18-5 may be positioned with respect to the θ direction using the polarization axis detection device in the same manner as in (1) described above (see FIG. 66). In FIG. 70, the polarizing plate component 19-5 including four polarizing plates 18-5 is illustrated.

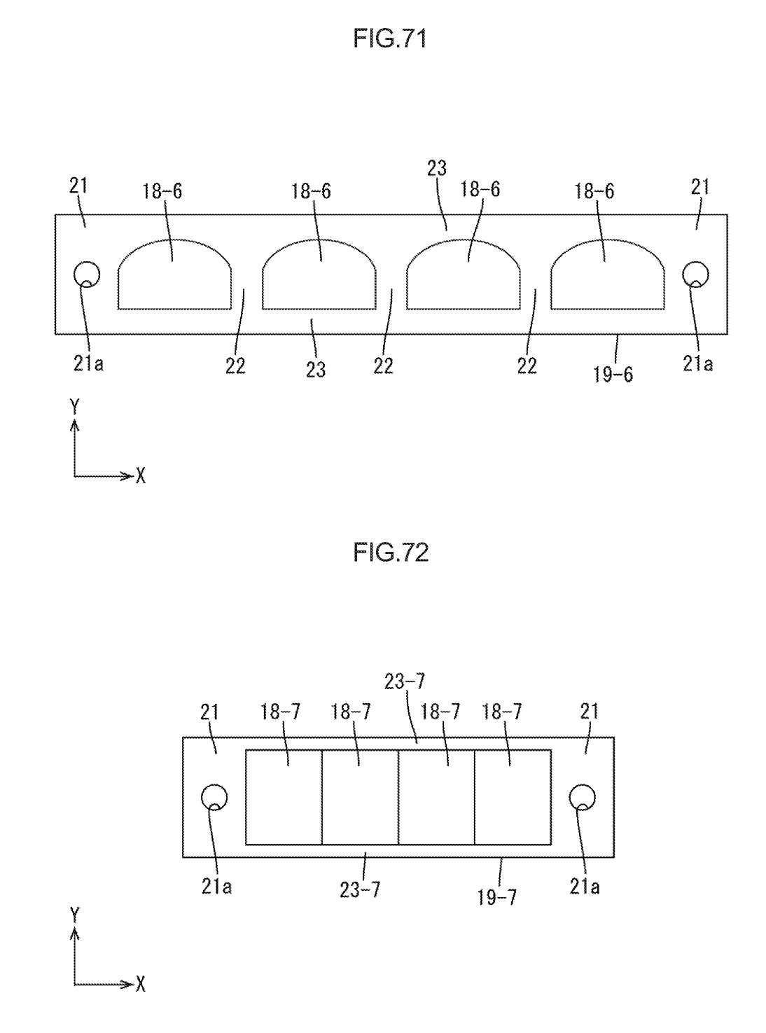

(6) A modification of the ninth embodiment may include a polarizing plate component that may include polarizing plates with a two-dimensional shape different from those of the modifications described in (1) to (5). As illustrated in FIG. 71, polarizing plates 18-6 may have a horizontally-long rectangular two-dimensional shape with one curved long edge. Such a polarizing plate 18-6 may be positioned with respect to the θ direction using the polarization axis detection device in the same manner as in (1) described above (see FIG. 66). In FIG. 71, the polarizing plate component 19-6 including four polarizing plates 18-6 is illustrated.

(7) A modification of the ninth embodiment may include a polarizing plate component that may not include intermediate portions. As illustrated in FIG. 72, polarizing plates 18-7 may be arranged directly next to each other and short end surfaces of the polarizing plates 18-7 are protected by end surface protecting portions 23-7. Such a polarizing plate 18-7 may be positioned with respect to the θ direction using the polarization axis detection device in the same manner as in (1) described above (see FIG. 66). In FIG. 72, the polarizing plate component 19-7 including four polarizing plates 18-7 is illustrated.

(8) A polarizing plate component may include polarizing plates with a two-dimensional shape different from those of the modifications in (1) to (7). Such a polarizing plate may be positioned with respect to the θ direction using the polarization axis detection device in the same manner as in (1) described above (see FIG. 66).

(9) Two or more methods described in (1) to (7) may be combined where appropriate.

(10) The numbers of the polarizing plates includes in the polarizing plate components may be altered from those of the above embodiments where appropriate. The numbers of the intermediate portions, the number of intermediate positioning portions, the arrangement of the intermediate portions, and the arrangement of the intermediate positioning portions in the polarizing plate components may be altered from those of the above embodiments where appropriate.

(11) The dimensions of the polarizing plate components and the dimensions of the polarizing plates in the polarizing plate components may be altered from those of the above embodiments where appropriate.

(12) In each of the above embodiments, the polarizing plate component that includes the polarizing plates that are linearly arranged is used. However, a polarizing plate component that includes polarizing plates that are arranged in a matrix may be used. In this case, liquid crystal panel bodies may be arranged in a matrix on the liquid crystal panel vacuum stage and polarizing plates may be collectively bonded to the liquid crystal panel bodies in a polarizing plate bonding process.

(13) The two-dimensional shapes of the positioning portions and the positioning holes may be altered from those of the above embodiments where appropriate. The arrangements and the number of the positioning portions and the positioning holes may be altered where appropriate.

(14) In each of the above embodiments, the positioning holes in the positioning portions are through holes. However, transparent positioning portions may be provided with marks (reference portions) which may be references in positioning relative to the polarizing plate alignment marks.

(15) In each of the above embodiments, the polarizing plate base attached to the separator layer is cut to separate the polarizing plates from one another in the polarizing plate component preparing process. However, the polarizing plates may be separately prepared in advance and attached to the separator layer in a polarizing plate component preparing process.

(16) In each of the above embodiments, the liquid crystal layer is formed between the board bases with the drop injection method in the board base bonding step. However, the vacuum injection method may be used. In this case, a liquid crystal vacuum injection step may be performed between the first cutting step and the second cutting step after the board base bonding step. Specifically, liquid crystal layers are collectively formed in liquid crystal panel bodies using a liquid crystal panel body component prepared through the first cutting step.

(17) In each of the above embodiments, the driver is COG-mounted on the array board of the liquid crystal panel. However, the driver may be chip-on-film (COF) mounted on the liquid crystal panel flexible circuit board.

(18) In each of the above embodiments, the color filters of the liquid crystal panel have the three-color configuration of red, green, and blue. However, the present invention may be applied to color filters have a four-color configuration including yellow color portions in addition to the red, the green, and the blue color portions.

(19) In each of the above embodiment sections, the liquid display panel having the screen size of one inch or less, which is categorized into the ultracompact size. However, the present invention may be applied to liquid crystal panels having screen sizes greater than one inch, which are categorized into a small size, a medium size, a large size, and a very large size. Such liquid crystal panels may be used for portable electronic devices such as smartphones and tablet personal computers and for electronic devices such as television devices, electronic signboards (digital signage), and electronic blackboards.

(20) In each of the above embodiment sections, the liquid crystal panel that includes the liquid crystal layer sandwiched between the boards. However, the present invention may be applied to a display panel that includes functional organic molecules other than the liquid crystal material sandwiched between the boards.

(21) In each of the above embodiments, the TFTs are used as the switching components of the liquid crystal panel. However, the present invention may be applied to a liquid crystal panel that includes switching components other than TFTs (e.g., thin film diodes (TFD)). The present invention may be applied to a liquid crystal panel that is configured to display black-and-white images other than the liquid crystal panel that is configured to display color images.

(22) In each of the above embodiment sections, the liquid crystal panel is described as an example of a display panel. However, the present invention may be applied to other types of display panels (e.g., organic EL panels, electrophoretic display panels (EPDs)).

(23) The transfer sheet vacuum stage in the fourteenth embodiment may be tilted relative to the Z-axis direction at the initial position. In this case, the polarizing plate vacuum stage may be tilted relative to the Z-axis direction with about the same angle.

(24) In each of the fourteenth and the fifteenth embodiment sections, the method of producing a liquid crystal panel using the polarizing plate component described in the ninth embodiment section. However, any of the polarizing plate components described in the first to the eighth embodiment sections, the tenth to the thirteenth embodiment sections, and other embodiment sections of (1) to (7) may be used.

(25) The configuration and the arrangement of the polarizing plate bonding device described in each of the fourteenth and the fifteenth embodiment sections may be altered where appropriate.

(26) In each of other embodiment sections of (1) to (7), the positioning of the polarizing plate having the non-rectangular two-dimensional shape relative to the θ direction using the polarization axis detection device (see FIG. 66) is described. However, positioning of a polarization plate having a rectangular two-dimensional shape relative to the θ direction may be performed using the polarization axis detection device.

### EXPLANATION OF SYMBOLS

10: Liquid crystal display device (Display device)

11, 1211: Liquid crystal panel (Display panel)

11B, 311B, 411B, 811B, 1011B, 1311B, 1411B: Liquid crystal panel body (Display panel body)

11BM: Liquid crystal panel body component (Display panel body component)

14: Backlight unit (Lighting device)

18, 18-1, 18-2, 18-3, 18-4, 18-5, 18-6, 18-7, 118, 218, 318, 418, 518, 718, 918, 1018, 1118, 1218, 1318, 1418: Polarizing plate

18M: Polarizing plate base

19, 19-1, 19-2, 19-3, 19-4, 19-5, 19-6, 19-7, 119, 219, 319, 519, 619, 719, 819, 919, 1019, 1119, 1219, 1319, 1419: Polarizing plate component

20, 120, 320, 820, 1020, 1220, 1320, 1420: Separator layer (Polarizing plate carrier)

21, 22-1, 522, 622, 722, 822, 922, 1022, 1122: Intermediate portion

23, 23-7, 923: End surface protecting portion

24, 1124: Intermediate positioning portion

1. A method of producing a display panel comprising:
a display panel body component preparing process of preparing a display panel body component including display panel bodies coupled to one another;
a separating process of separating the display panel body component into the display panel bodies;
a cleaning process of cleaning the display panel bodies;
a polarizing plate component preparing process of preparing a polarizing plate component including polarizing plates coupled to one another; and
a polarizing plate bonding process of collectively bonding the polarizing plate included in the polarizing plate component to the display panel bodies.

2. The method of producing a display panel according to claim 1, wherein the polarizing plate component preparing process includes preparing the polarizing plate component including the polarizing plates held by a polarizing plate carrier to be removable from the polarizing plate carrier and detachable from one another.

3. The method of producing a display panel according to claim 2, wherein the polarizing plate component preparing process includes at least:
a base attaching step of attaching a polarizing plate base to the polarizing plate carrier; and
a polarizing plate separating process of cutting the polarizing plate base attached to the polarizing plate carrier to set the polarizing plates detachable from one another.

4. The method of producing a display panel according to claim 1, wherein
the polarizing plate component preparing process includes preparing the polarizing plate component including the polarizing plates linearly arranged and two positioning portions disposed to sandwich the polarizing plates from ends with respect to an arrangement direction of the polarizing plates, and
the polarizing plate bonding process includes positioning the polarizing plates relative to the display panel bodies using the positioning portions.

5. The method of producing a display panel according to claim 4, wherein
the polarizing plate component preparing process includes preparing the polarizing plate component including an intermediate positioning portion disposed between the polarizing plates adjacent to each other, and
the polarizing plate bonding process includes positioning the polarizing plates relative to the display panel bodies using the positioning portions and the intermediate positioning portions.

6. The method of producing a display panel according to claim 1, wherein the polarizing plate component preparing process includes preparing the polarizing plate component including the polarizing plates that are directly next to one another and coupled to one another.

7. The method of producing a display panel according to claim 1, wherein the polarizing plate component preparing process includes preparing the polarizing plate component including an intermediate portion between the polarizing plates adjacent to each other.

8. The method of producing a display panel according to claim 1, wherein the polarizing plate component preparing process includes preparing the polarizing plate component linearly arranged and an end surface protecting portion covering at least sections of end surfaces of the polarizing plates along an arrangement direction of the polarizing plates.

9. The method of producing a display panel according to claim 8, wherein the polarizing plate component preparing process includes preparing the polarizing plate component including the end surface protecting portion coving entire areas of the end surfaces of the polarizing plates along the arrangement direction.

10. The method of producing a display panel according to claim 8, wherein the polarizing plate component preparing process includes preparing the polarizing plate component including an intermediate portion between the polarizing plate adjacent to each other and the end surface protecting portion coupled to the intermediate portion.

11. The method of producing a display panel according to claim 1, wherein the polarizing plate bonding process includes transmitting light through each of the polarizing plates and detecting a polarization axis of the each of the polarizing plates based on an amount of transmitted light or a waveform related to the transmitted light.

12. A method of producing a display device comprising:
a lighting device preparing process of preparing a lighting device for supplying light to the display panel produced by the method of producing a display device according to claim 1; and
an assembly process of assembling the display panel and the lighting device together.
